(19) United States
(12) Patent Application Publication
(10) Pub. No.: US 2025/0388485 A1
(43) Pub. Date: Dec. 25, 2025

(54) METHOD FOR MANUFACTURING POSITIVE ELECTRODE ACTIVE MATERIAL AND POSITIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Kazuya SHIMADA, Atsugi, Kanagawa (JP); Kousuke SASAKI, Atsugi, Kanagawa (JP); Yohei MOMMA, Isehara, Kanagawa (JP)

(21) Appl. No.: 18/879,579

(22) PCT Filed: Jul. 4, 2023
(86) PCT No.: PCT/IB2023/056915

§ 371 Date: Dec. 27, 2024

(30) Foreign Application Priority Data
Jul. 15, 2022 (JP) 2022-113771
Jul. 15, 2022 (JP) 2022-113867

(51) Int. Cl. C01G 53/42; H01M 4/02; H01M 4/62; H01M 10/0525

(52) U.S. Cl. CPC C01G 53/42; H01M 4/623; H01M 10/0525; H01M 2004/028

(57) ABSTRACT

A positive electrode active material having both higher capacity and safety is provided. Provided is a method for manufacturing a positive electrode active material, including forming a mixed solution containing a cobalt compound and a nickel compound dissolved; making the mixed solution react with an alkaline aqueous solution to obtain a suspension in which a cobalt nickel hydroxide is precipitated; performing first suction filtration of the suspension with use of water; and after the first suction filtration, performing second suction filtration with use of an organic solvent. In the cobalt nickel hydroxide, an atomic ratio of nickel in the sum of an atomic ratio of cobalt and the atomic ratio of nickel is greater than 0 and less than or equal to 0.01.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material for a lithium-ion secondary battery and a manufacturing method thereof.

### BACKGROUND ART

In recent years, demand for lithium-ion secondary batteries (also referred to as lithium-ion batteries) with high output and high capacity has rapidly grown and the lithium-ion secondary batteries are essential as repeatedly-usable energy sources in modern society.

It is said that lithium-ion secondary batteries can hardly be safe when having high capacity. A positive electrode active material with a layered rock-salt crystal structure, where lithium ions move two-dimensionally in the crystal structure, for example, is expected to enable high capacity. However, the positive electrode active material having a layered rock-salt crystal structure has been disadvantageous in terms of safety because the crystal structure will be collapsed by excessive extraction of lithium ions at the time of charging, easily resulting in thermal runaway.

Lithium cobalt oxide (LiCoO₂), lithium nickel oxide (LiNiO₂), and the like are known as positive electrode active materials having a layered rock-salt crystal structure. In lithium cobalt oxide, which has a layered rock-salt crystal structure, lithium ions can move two-dimensionally between layers composed of CoO₆ octahedrons, leading to favorable cycle performance. However, lithium cobalt oxide has a problem of a phase change due to charging and discharging. For example, a phase change from the hexagonal phase to the monoclinic phase occurs in lithium cobalt oxide when lithium ions are extracted to some extent at the time of charging. Thus, to use lithium cobalt oxide such that it enables favorable cycle performance, the amount of lithium ions to be extracted has been limited. Patent Document 1 proposes a structure for solving these problems, in which an additive element is added to lithium cobalt oxide.

Lithium nickel oxide also has a layered rock-salt crystal structure, and thus is expected to achieve cycle performance similar to that achieved with lithium cobalt oxide. Moreover, nickel is cheaper than cobalt and energy density can be increased in proportion to the nickel content, so that lithium nickel oxide has been studied as an alternative material to lithium cobalt oxide. However, lithium nickel oxide has a problem in thermal stability and is less safe than lithium cobalt oxide, and thus has not been put into practical use.

Furthermore, there is a problem derived from a change in the valence of nickel. Specifically, reduction of nickel to the divalent state easily occurs in manufacture, and the ion radius of a nickel ion is close to the ion radius of a lithium ion; thus, nickel (divalent) substitutes for a site where a lithium ion exists. This is referred to as cation mixing. Due to the cation mixing, the lithium content is reduced in lithium nickel oxide, leading to low discharge capacity. In view of the above, Patent Document 2 proposes LiCo_{0.8}Ni_{0.1}Mn_{0.1}O₂ or the like, which is obtained by a solid phase method, in order to achieve high energy density and improvement in a cycle lifetime. Furthermore, as disclosed in Non-Patent Document 1, LiNi_{1/2}Co_{1/2}O₂ has also been studied.

In addition, X-ray diffraction (XRD) is one of methods used for analysis of the crystal structure of a positive electrode active material. With the use of ICSD (Inorganic Crystal Structure Database) described in Non-Patent Document 2, XRD data can be analyzed. For example, the ICSD can be referred to for the lattice constant of the lithium cobalt oxide described in Non-Patent Document 3. For Rietveld analysis, the analysis program RIETAN-FP (Non-Patent Document 4) can be used, for example. As software for drawing crystal structures, VESTA (Non-Patent Document 5) can be used.

### REFERENCES

### Patent Documents

[Patent Document 1] International Publication WO 2020/026078
[Patent Document 2] Japanese Published Patent Application No. 2006-344509

### Non-Patent Documents

[Non-Patent Document 1]W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36[1]12-17 (1953).
[Non-Patent Document 2] Belsky, A. et al., “New developments in the Inorganic Crystal Structure Database (ICSD): accessibility in support of materials research and design”, Acta Cryst., (2002) B58 364-369.
[Non-Patent Document 3]J. Akimoto, Y. Gotoh, Y. Oosawa, “Synthesis and structure refinement of LiCoO₂ single crystals”, Journal of Solid State Chemistry (1998) 141, pp. 298-302.
[Non-Patent Document 4]F. Izumi and K. Momma, Solid State Phenom., 130, 15-20 (2007)
[Non-Patent Document 5]K. Momma and F. Izumi, J. Appl. Cryst. (2011). 44, 1272-1276

### SUMMARY OF THE INVENTION

### Problems to be Solved by the Invention

Positive electrode active materials can be obtained in accordance with Patent Document 1, Patent Document 2, and the like described above; however, there is room for improvement in terms of charge and discharge capacity, cycle performance, reliability, safety, cost, and other various aspects.

In view of the above description, an object of one embodiment of the present invention is to provide a positive electrode active material that is stable in a high potential state and/or a high temperature state and a method for manufacturing the positive electrode active material. Another object of one embodiment of the present invention is to provide a positive electrode active material in which a crystal structure is not easily broken even when charging and discharging are repeated and a method for manufacturing the positive electrode active material.

Note that the description of the above objects does not preclude the existence of other objects. Moreover, objects other than the above objects can be derived from the description of the specification, the drawings, and the claims. One embodiment of the present invention does not necessarily achieve all the above objects, and achieves at least any one of all the above objects.

### Means for Solving the Problems

An embodiment of the present invention is a method for manufacturing a positive electrode active material, including forming a mixed solution containing a cobalt compound and a nickel compound dissolved; making the mixed solution react with an alkaline aqueous solution to obtain a suspension in which a cobalt nickel hydroxide is precipitated; performing first suction filtration of the suspension with use of water; and after the first suction filtration, performing second suction filtration with use of an organic solvent. In the cobalt nickel hydroxide, an atomic ratio of nickel in the sum of an atomic ratio of cobalt and the atomic ratio of nickel is greater than 0 and less than or equal to 0.01.

Another embodiment of the present invention is a method for manufacturing a positive electrode active material, including forming a mixed solution containing a cobalt compound and a nickel compound dissolved; making the mixed solution react with an alkaline aqueous solution to obtain a suspension in which a cobalt nickel hydroxide is precipitated; performing first suction filtration of the suspension with use of water; after the first suction filtration, performing second suction filtration with use of an organic solvent to collect the cobalt nickel hydroxide; after mixing the cobalt nickel hydroxide and a lithium compound, performing first heat treatment to form a first composite oxide; and after mixing the first composite oxide and a compound including an additive element, performing second heat treatment. In the cobalt nickel hydroxide, an atomic ratio of nickel in the sum of an atomic ratio of cobalt and the atomic ratio of nickel is greater than 0 and less than or equal to 0.01. In the first composite oxide, an atomic ratio of lithium to the atomic ratio of cobalt is greater than or equal to 1.0 and less than or equal to 1.2.

In another embodiment of the present invention, the additive element is preferably one or two or more selected from magnesium, fluorine, calcium, aluminum, silicon, vanadium, copper, and gallium.

In another embodiment of the present invention, a temperature of the second heat treatment is preferably lower than a temperature of the first heat treatment.

In another embodiment of the present invention, it is preferable to subject the cobalt nickel hydroxide to a drying step for longer than or equal to 0.5 hours and shorter than or equal to 20 hours.

In another embodiment of the present invention, it is preferable to subject the cobalt nickel hydroxide to a drying step for longer than or equal to 12 hours and shorter than or equal to 20 hours.

Another embodiment of the present invention is a positive electrode active material in which an atomic ratio of nickel in a sum of an atomic ratio of cobalt and the atomic ratio of nickel is greater than 0 and less than or equal to 0.01 and an atomic ratio of lithium to the atomic ratio of cobalt is greater than or equal to 1.0 and less than or equal to 1.2, and a mapping image of the positive electrode active material by a surface SEM-EDX method includes a region where nickel is not confirmed.

Another embodiment of the present invention is a positive electrode active material in which an atomic ratio of nickel in a sum of an atomic ratio of cobalt and the atomic ratio of nickel is greater than 0 and less than or equal to 0.01 and an atomic ratio of lithium to the atomic ratio of cobalt is greater than or equal to 1.0 and less than or equal to 1.2, and the positive electrode active material includes a crystallite and a size of the crystallite is greater than or equal to 200 nm and less than or equal to 600 nm.

In another embodiment of the present invention, the atomic ratio of lithium to the atomic ratio of cobalt is preferably greater than or equal to 1.06 and less than or equal to 1.2.

### Effect of the Invention

According to one embodiment of the present invention, a positive electrode active material that is stable in a high potential state and/or a high temperature state and a method for manufacturing the positive electrode active material can be provided. According to one embodiment of the present invention, a positive electrode active material in which a crystal structure is not easily broken even when charging and discharging are repeated and a method for manufacturing the positive electrode active material can be provided.

Note that the description of these effects does not preclude the existence of other effects. One embodiment of the present invention does not need to have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A is a diagram illustrating a positive electrode active material, and FIG. 1B and FIG. 1C are diagrams illustrating additive element distributions.

FIG. 2 is an example of a TEM image showing crystal orientations substantially aligned with each other.

FIG. 3A and FIG. 3B are diagrams illustrating a positive electrode active material.

FIG. 4A to FIG. 4C are diagrams illustrating a positive electrode active material.

FIG. 5 is a diagram illustrating crystal structures of a positive electrode active material of one embodiment of the present invention.

FIG. 6A to FIG. 6C are lattice constants calculated by XRD.

FIG. 7 is a flow chart showing a manufacturing process of a positive electrode active material of one embodiment of the present invention.

FIG. 8 is a flow chart showing a manufacturing process of a positive electrode active material of one embodiment of the present invention.

FIG. 9A and FIG. 9B are cross-sectional views illustrating a positive electrode active material layer.

FIG. 10A and FIG. 10B are diagrams illustrating a solid electrolyte secondary battery.

FIG. 11A is an exploded perspective view of a coin-type secondary battery, FIG. 11B is a perspective view of the coin-type secondary battery, and FIG. 11C is a cross-sectional perspective view thereof.

FIG. 12A is a diagram showing an example of a cylindrical secondary battery. FIG. 12B is a diagram showing an example of the cylindrical secondary battery. FIG. 12C is a diagram showing an example of a plurality of cylindrical secondary batteries. FIG. 12D is a diagram showing an example of a power storage system including a plurality of cylindrical secondary batteries.

FIG. 13A and FIG. 13B are diagrams illustrating examples of a secondary battery, and FIG. 13C is a diagram showing the internal state of the secondary battery.

FIG. 14A to FIG. 14C are diagrams illustrating examples of a secondary battery.

FIG. 15A and FIG. 15B are diagrams showing external views of a secondary battery.

FIG. 16A to FIG. 16C are diagrams illustrating a method for manufacturing a secondary battery.

FIG. 17A to FIG. 17D are diagrams illustrating examples of transport vehicles. FIG. 17E is a diagram illustrating an example of an artificial satellite.

FIG. 18A is a diagram illustrating an electric bicycle, FIG. 18B is a diagram illustrating a secondary battery of the electric bicycle, and FIG. 18C is a diagram illustrating a motor scooter.

FIG. 19A to FIG. 19E are diagrams illustrating examples of electronic devices.

FIG. 20 shows SEM images in Example 1.

FIG. 21 shows XRD measurement results in Example 1.

FIG. 22A to FIG. 22C show the results of charge and discharge cycle tests in Example 1.

FIG. 23A to FIG. 23C show the results of charge and discharge cycle tests in Example 1.

FIG. 24A to FIG. 24C show the results of charge and discharge cycle tests in Example 1.

FIG. 25A to FIG. 25C show the results of charge and discharge cycle tests in Example 1.

FIG. 26A to FIG. 26C each show rate performance in Example 1.

FIG. 27A to FIG. 27C each show rate performance in Example 1.

FIG. 28 shows SEM images of samples.

FIG. 29 shows SEM images of samples.

FIG. 30A to FIG. 30E show a SEM image of a sample and mapping images.

FIG. 31 is a diagram showing an energy spectrum by EDX.

FIG. 32 is a diagram showing an energy spectrum by EDX.

FIG. 33 is a diagram showing an energy spectrum by EDX.

FIG. 34 shows an energy spectrum obtained by EDX.

FIG. 35 is a diagram showing an energy spectrum by EDX.

FIG. 36 is a diagram showing an energy spectrum by EDX.

FIG. 37A to FIG. 37E show a SEM image of a sample and mapping images.

FIG. 38 is a diagram showing an energy spectrum by EDX.

FIG. 39 is a diagram showing an energy spectrum by EDX.

FIG. 40 is a diagram showing an energy spectrum by EDX.

FIG. 41 is a diagram showing an energy spectrum by EDX.

FIG. 42 is a diagram showing an energy spectrum by EDX.

FIG. 43 is a diagram showing an energy spectrum by EDX.

FIG. 44 shows XRD measurement results of samples.

FIG. 45A and FIG. 45B are diagrams showing crystallite sizes of samples.

FIG. 46 is a diagram showing measurement results of particle size distributions of samples.

FIG. 47A to FIG. 47C are diagrams showing changes in discharge capacity of samples at 25° C.

FIG. 48A to FIG. 48C are diagrams showing changes in discharge capacity of samples at 45° C.

FIG. 49A to FIG. 49C are diagrams showing changes in discharge capacity retention rates of samples at 25° C.

FIG. 50A to FIG. 50C are diagrams showing changes in discharge capacity retention rates of samples at 45° C.

FIG. 51A to FIG. 51C are diagrams showing changes in rate performance of samples at 25° C.

FIG. 52A to FIG. 52C are diagrams showing changes in rate performance of samples at 25° C.

FIG. 53 shows SEM images of samples.

FIG. 54 shows SEM images of samples.

FIG. 55 shows XRD measurement results of samples.

FIG. 56 is a diagram showing crystallite sizes of samples.

FIG. 57 is a diagram showing measurement results of particle size distributions of samples.

FIG. 58A to FIG. 58C are diagrams showing changes in discharge capacity of samples at 25° C.

FIG. 59A to FIG. 59C are diagrams showing changes in discharge capacity of samples at 45° C.

FIG. 60A to FIG. 60C are diagrams showing changes in discharge capacity retention rates of samples at 25° C.

FIG. 61A to FIG. 61C are diagrams showing changes in discharge capacity retention rates of samples at 45° C.

FIG. 62A to FIG. 62C are diagrams showing changes in rate performance of samples at 25° C.

FIG. 63A to FIG. 63C are diagrams showing changes in rate performance of samples at 25° C.

FIG. 64 is a diagram showing XRD measurement results of a sample at the time of charging.

### MODE FOR CARRYING OUT THE INVENTION

Embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

In this specification and the like, a positive electrode active material is sometimes referred to as a composite oxide, a positive electrode member, a positive electrode material, a lithium-ion secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, a space group is represented using the short notation of the international notation (or the Hermann-Mauguin notation). In addition, the Miller indices are used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure, and the space group R-3m is also represented by a composite hexagonal lattice in this specification and the like unless otherwise specified. In some cases, not only (hkl) but also (hkil) is used as the Miller index. Here, i is −(h+k).

The space group of a lithium-ion secondary battery is identified by XRD (X-ray Diffraction), electron diffraction, neutron diffraction, or the like. Thus, in this specification and the like, belonging to a space group, being attributed to a space group, or being a space group can be rephrased as being identified as a space group.

A structure is referred to as a cubic close-packed structure when three layers of anions are shifted and stacked like “ABCABC”. Accordingly, anions do not necessarily form a cubic lattice structure. At the same time, actual crystals always have a defect and thus, analysis results are not necessarily consistent with the theory. For example, in an electron diffraction pattern or an FFT (fast Fourier transform) pattern of a TEM (Transmission Electron Microscope) image or the like, a spot may appear in a position slightly different from a theoretical position. For example, anions can be regarded as forming a cubic close-packed structure when a difference in orientation from a theoretical position is 5° or less or 2.5° or less.

Note that in this specification and the like, a layered rock-salt crystal structure refers to a crystal structure in which a rock-salt ion arrangement where cations and anions are alternately arranged is included and a transition metal M and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

The theoretical capacity of a positive electrode active material refers to the amount of electricity obtained when all lithium ions that can be inserted and extracted and are contained in the positive electrode active material are extracted. For example, the theoretical capacity of LiCoO₂ is 274 mAh/g per weight of the positive electrode active material, the theoretical capacity of LiNiO₂ is 274 mAh/g per weight of the positive electrode active material, and the theoretical capacity of LiMn₂O₄ is 148 mAh/g per weight of the positive electrode active material.

The remaining amount of lithium that can be inserted into and extracted from a positive electrode active material is represented by x in a composition formula, e.g., x in LiₓMO₂. As M, which is a transition metal, typically cobalt, a plurality of transition metals can be contained. In the case of a positive electrode active material in a secondary battery, x=(theoretical capacity−charge capacity)/theoretical capacity can be satisfied. For example, in the case where a secondary battery using LiMO₂ as a positive electrode active material is charged to 219.2 mAh/g, it can be said that the positive electrode active material is represented by Li_{0.2}MO₂ or x=0.2. Note that “x in LiₓMO₂ is small” means, for example, 0.1<x≤0.24. In some cases, a charge depth indicates the amount of lithium extracted from a positive electrode active material, relative to the theoretical capacity. In this specification and the like, the charge depth corresponds to 1-x.

Charge capacity and/or discharge capacity used for calculation of x in LiₓMO₂ is preferably measured under the condition of no influence or small influence of a short circuit and/or decomposition of an electrolyte solution or the like. For example, data of a secondary battery, suffering from a sudden change of capacity that seems to result from a short circuit, should not be used for calculation of x.

Lithium cobalt oxide to be used for a positive electrode, which has been appropriately synthesized and almost satisfies the stoichiometric proportion, is LiCoO₂ with x=1. In a secondary battery after its discharging ends, it can be said that contained lithium cobalt oxide is also LiCoO₂ and x=1. Here, “discharging ends” means that a voltage becomes 3.0 V or 2.5 V or lower at a current of 100 mA/g or lower per weight of the positive electrode active material, for example.

In this specification and the like, the element distribution indicates the region where the element is successively detected by a successive analysis method to the extent that the detection value is no longer on the noise level.

In the case where the features of a positive electrode active material are described in this specification and the like, not all the positive electrode active materials included in a lithium-ion secondary battery necessarily have the features. For example, in description of features of a coating film of a positive electrode active material, when 50% or more, preferably 70% or more, further preferably 90% or more of three or more randomly selected positive electrode active materials have a feature of the coating film (specifically, a feature of the coating film being formed on 50% or more, preferably 70% or more, further preferably 90% or more of the surface of the active material), for example, it can be said that an effect of improving the characteristics of the positive electrode active material and a lithium-ion secondary battery including the positive electrode active material is sufficiently obtained.

A short circuit of a lithium-ion secondary battery might cause not only malfunction in charge operation and/or discharge operation of the lithium-ion secondary battery but also thermal runaway, heat generation, and firing. An internal short circuit and an external short circuit are kinds of the short circuit. In this specification and the like, an internal short circuit of a lithium-ion secondary battery refers to contact between a positive electrode and a negative electrode in the battery. An external short circuit of a lithium-ion secondary battery refers to contact between a positive electrode and a negative electrode outside the battery on the assumption that the battery is misused.

Note that the description is made on the assumption that materials (such as a positive electrode active material, a negative electrode active material, an electrolyte solution, and a separator) of a lithium-ion secondary battery have not deteriorated unless otherwise specified. A decrease in discharge capacity due to aging treatment and burn-in treatment during the manufacturing process of a lithium-ion secondary battery is not regarded as deterioration. For example, the case where discharge capacity is higher than or equal to 97% of the rated capacity of a lithium-ion secondary battery composed of a cell or an assembled battery can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In this specification and the like, a lithium-ion secondary battery is sometimes called a lithium-ion battery and refers to a battery in which lithium ions are used as carrier ions; however, carrier ions in the present invention are not limited to lithium ions. For example, as the carrier ion in the present invention, alkali metal ions or alkaline earth metal ions can be used; specifically, sodium ions or the like can be used. In that case, the present invention can be understood by replacing lithium ions with sodium ions or the like. Furthermore, in the case where there is no limitation by carrier ions, the term “secondary battery” is sometimes used.

In this specification and the like, an active material is expressed as an active material particle in some cases; note that the active material can have a variety of shapes and the shape is not limited to a particle form. For example, the shape of the active material (active material particle) in one cross section may be an ellipse, a rectangle, a trapezoid, a triangle, a quadrilateral with rounded corners, or an asymmetrical shape, as well as a circle.

It can be said that when surface unevenness information in one cross section of an active material is converted into numbers with measurement data, a smooth surface of the active material has a surface roughness of at least less than or equal to 10 nm, in this specification and the like. The one cross section in this specification and the like is, for example, a cross section obtained in observation using a STEM (Scanning Transmission Electron Microscope) image.

In this specification and the like, the phrase “A and/or B” is an example of an expression that encompasses only A, only B, and A and B.

In this specification and the like, a secondary particle refers to a particle formed by aggregation of primary particles. In this specification and the like, a single particle refers to a single crystal particle and refers to a particle with no grain boundary in its appearance.

### Embodiment 1

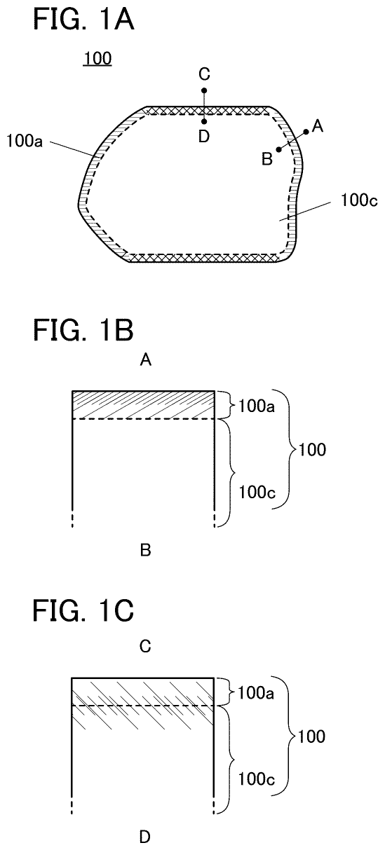

In this embodiment, a positive electrode active material 100 of one embodiment of the present invention is described with reference to FIG. 1 to FIG. 6.

FIG. 1A shows a cross-sectional view of the positive electrode active material 100 of one embodiment of the present invention. As illustrated in FIG. 1A, the positive electrode active material 100 has a surface portion 100a and an inner portion 100c. In FIG. 1A and the like, a dashed line denotes a boundary between the surface portion 100a and the inner portion 100c.

### <Single Particle>

The positive electrode active material 100 preferably has high crystallinity. The positive electrode active material 100 is preferably a single crystal (also referred to as a single particle) rather than a secondary particle. When the positive electrode active material 100 of one embodiment of the present invention includes a single particle, it is expected that a crack will be inhibited even if the volume of the positive electrode material changes due to charging and discharging.

### <Surface Portion>

In this specification and the like, the surface portion 100a of the positive electrode active material 100 refers to a region within 200 nm, preferably within 100 nm, further preferably within 50 nm, still further preferably within 20 nm in depth from the surface toward the inner portion. A plane generated by a crack may also be referred to as a surface. The surface portion can be rephrased as the neighborhood of a surface, a shell, or a region in the neighborhood of a surface.

### <Surface>

The positive electrode active material 100 is a composite oxide into and from which lithium ions can be inserted and extracted, and thus does not include a carbonate, a hydroxy group, or the like which is chemically adsorbed after formation of the positive electrode active material 100. Furthermore, an electrolyte, a binder, a conductive material, and a compound originating from any of these that are attached to the positive electrode active material 100 are not included either. Thus, the surface of the positive electrode active material 100 is a surface of a composite oxide into and from which lithium ions can be inserted and extracted, and the above-described member that cannot be referred to as a composite oxide does not form the surface of the positive electrode active material 100.

### <Inner Portion>

The inner portion 100c refers to a region in a position deeper than the surface portion 100a of the positive electrode active material 100. The inner portion 100c can be rephrased as an inner region or a core.

### <Contained Element>

The positive electrode active material 100 needs to contain a transition metal which can undertake an oxidation-reduction reaction in order to maintain a neutrally charged state even when typically lithium ions are inserted and extracted. It is preferable that the positive electrode active material 100 of one embodiment of the present invention use cobalt as the transition metal M taking part in an oxidation-reduction reaction. A plurality of transition metals M may be used, in which case cobalt is preferably used as the main component of the transition metals M. Note that in this specification and the like, the main component of the transition metals M refers to the component having the highest atomic ratio among the plurality of transition metals M contained in the positive electrode active material. The positive electrode active material 100 preferably contains nickel in addition to cobalt. A composite oxide containing both cobalt and nickel as the transition metals is sometimes referred to as lithium cobalt nickel oxide, and its composition formula can be represented by LiCo_{1-y}Ni_{y}O₂. Note that the crystal structure of LiCo_{1-y}Ni_{y}O₂ belongs to the space group R-3m.

In the positive electrode active material 100, y in LiCo_{1-y}Ni_{y}O₂ is preferably greater than 0 and less than or equal to 0.1, further preferably greater than 0 and less than or equal to 0.05, still further preferably greater than 0 and less than or equal to 0.01.

When represented by the ratio of the atomic ratios of the transition metals in the positive electrode active material 100, for example, y being 0.01 in LiCo_{1-y}Ni_{y}O₂ can be represented by Co:Ni=99:1. Thus, the positive electrode active material 100 preferably satisfies Co:Ni=99:1 or a neighboring value, Co:Ni=99.5:0.5 or a neighboring value, or Co:Ni=99.9:0.1 or a neighboring value. Note that the neighborhood used for the ratio of the atomic ratios includes 0.9 times or more and 1.1 times or less the value.

It is considered that when nickel is contained in the positive electrode active material 100 of one embodiment of the present invention, a shift in a layered structure is inhibited or the crystal structure becomes stable and a secondary battery including the positive electrode active material is much less likely to ignite and inhibited from deteriorating after charging and discharging. Although described later in an embodiment and the like, a coprecipitation method or the like is preferably used to obtain the above-described positive electrode active material 100.

In the positive electrode active material 100 of one embodiment of the present invention, nickel is preferably dissolved in the positive electrode active material 100. Therefore, for example, nickel is preferably positioned in the inner portion 100c of the positive electrode active material 100 in STEM-EDX (Scanning Transmission Electron Microscope-Energy Dispersive X-ray spectroscopy) line analysis. Specifically, a position where the amount of detected nickel increases is preferably at a deeper level than a position where the amount of detected cobalt increases.

In the positive electrode active material 100 of one embodiment of the present invention, the atomic ratio of mixed lithium may exceed 1 as described later; in view of this, the atomic ratio of lithium is not limited at all. In other words, the composition in the case where cobalt and/or nickel is M is not strictly limited to Li:M:O=1:1:2 in the positive electrode active material 100.

Further preferably, the positive electrode active material 100 of one embodiment of the present invention has a unique crystal structure in charging, as described later.

### <Additive Element>

Further preferably, the positive electrode active material 100 of one embodiment of the present invention preferably contains an additive element. In other words, the positive electrode active material 100 contains lithium, cobalt, nickel, oxygen, and the additive element; that is, lithium cobalt nickel oxide (LiCo_{1-y}Ni_{y}O₂) to which the additive element is added is preferable. As the additive element, one or two or more selected from magnesium, fluorine, calcium, aluminum, silicon, vanadium, copper, and gallium can be used.

When the amount of the additive element is too small, the effect of chemically stabilizing the positive electrode active material 100 cannot be sufficiently exhibited; however, when the amount of the additive element is too large, discharge capacity or the like might be adversely affected. Therefore, for example, in the case where the positive electrode active material 100 containing an additive element A is represented by LiCo_{1-y-z}Ni_{y}O₂A_{z}, z is preferably greater than 0 and less than or equal to 0.3. Note that z is further preferably greater than 0 and less than or equal to 0.1, still further preferably greater than 0 and less than or equal to 0.05.

The additive element preferably forms a solid solution in the positive electrode active material 100. Alternatively, the additive element preferably substitutes for any of the sites of the transition metal, oxygen, and lithium contained in the positive electrode active material 100. In STEM-EDX line analysis of the positive electrode active material 100, the additive element existing in such a state is determined to be positioned on the inner portion side of the positive electrode active material 100. That is, a position where the amount of the detected additive element increases is preferably at a deeper level than a position where the amount of the detected transition metal M and the like increases.

In STEM-EDX line analysis of the positive electrode active material 100, the detected amount of magnesium among the additive elements is preferably larger in the surface portion 100a than in the inner portion 100c. It is further preferable that a peak of the detected amount be observed in a region of the surface portion 100a that is closer to the surface. In this specification and the like, the detected amount in a STEM-EDX line analysis includes a result output in a count ratio or a result output in an atomic ratio, and a peak of the detected amount may be rephrased as a position indicating the highest atomic ratio.

In STEM-EDX line analysis of the positive electrode active material 100, the detected amount of fluorine among the additive elements is preferably larger in the surface portion 100a than in the inner portion 100c. It is further preferable that a peak of the detected amount of fluorine be observed in a region of the surface portion 100a that is closer to the surface. The fluorine distribution may overlap with the magnesium distribution. The distribution and the overlap include a state where peak positions of the detected amounts are aligned with each other. The fluorine distribution does not necessarily overlap with the magnesium distribution.

In STEM-EDX line analysis of the positive electrode active material 100, the detected amount of calcium among the additive elements is preferably larger in the surface portion 100a than in the inner portion 100c. It is further preferable that a peak of the detected amount of calcium be observed in a region of the surface portion 100a that is closer to the surface. The calcium distribution may overlap with the magnesium distribution. The calcium distribution does not necessarily overlap with the magnesium distribution.

In STEM-EDX line analysis of the positive electrode active material 100, a peak of the detected amount of distributed aluminum among the additive elements is preferably observed in a region that is located inward from a region in which a peak of the detected amount of magnesium is observed. Aluminum is distributed more inwardly than magnesium presumably because aluminum diffuses more easily than magnesium. Meanwhile, the detected amount of aluminum is small in the region that is the closest to the surface, which is presumably because aluminum can exist more stably in a region other than a region where magnesium or the like at a high concentration forms a solid solution.

The aluminum distribution and the magnesium distribution may overlap with each other; alternatively, there may be almost no overlap between the aluminum distribution and the magnesium distribution. A peak of the detected amount of aluminum may exist in the surface portion 100a or exist in a position deeper than the surface portion 100a. For example, the peak of the detected amount is preferably observed in a region extending, toward the inner portion, from a depth from the surface of 5 nm to a depth from the surface of 30 nm.

As described above, the additive element does not necessarily have similar concentration gradients and similar distributions throughout the surface portion 100a of the positive electrode active material 100.

The above-described additive element can further stabilize the crystal structure of the positive electrode active material 100 in charging as described later. Needless to say, the additive element is not necessarily contained as long as the crystal structure of the positive electrode active material 100 can be further stabilized in charging. That is, as the additive element, magnesium, fluorine, calcium, aluminum, silicon, vanadium, copper, or gallium is not necessarily contained.

The positive electrode active material 100 of one embodiment of the present invention may contain nickel as the additive element. As described above, the effect of nickel is inhibition of a shift in the layered structure, stabilization of the crystal structure, or the like, and to obtain the effect, nickel may be contained in either the inner portion 100c or the surface portion 100a. The nickel concentration may differ between the inner portion 100c and the surface portion 100a. When the nickel concentration is higher in the inner portion 100c than in the surface portion 100a, the effect is efficiently exhibited in the inner portion 100c accounting for the majority of the positive electrode active material 100, which is preferable. When the nickel concentration is higher in the surface portion 100a than in the inner portion 100c, the above effect is efficiently exhibited in the surface portion 100a where deterioration of the positive electrode active material 100 starts, which is preferable. One means of increasing the nickel concentration in the surface portion 100a is a method in which nickel is added as the additive element after a composite oxide is formed.

As for the additive element other than nickel, the atomic ratio of the additive element is preferably less than 30 at %, further preferably less than 10 at %, still further preferably less than 5 at % of the atomic ratio of the transition metal contained in the positive electrode active material 100 (the sum of the atomic ratios in the case where a plurality of transition metals are contained). Since the additive element is desirably positioned in the surface portion 100a as described above, it can be said that the atomic ratio of the above-described additive element other than nickel needs to be satisfied at least in the surface portion 100a.

Besides EDX line analysis, for example, XPS (Energy Dispersive X-ray photoelectron spectroscopy) linear analysis or EPMA (electron probe micro analysis) can be employed for specifying the atomic ratio of the additive element.

As described above, when the additive element is contained, the crystal structure of the positive electrode active material is stable particularly in high-voltage charging. The crystal structure is considered to be stable even when exposed to a higher-temperature environment, for example, even in a higher-voltage charged state at 45° C., for example. A secondary battery using the positive electrode active material is less likely to ignite, which is preferable.

### <Crystal Plane>

The positive electrode active material 100 illustrated in FIG. 1A is a composite oxide in which the inner portion 100c has a layered rock-salt crystal structure, and both the surface portion 100a and the inner portion 100c have a plane parallel to the (001) plane. In this specification and the like, the (001) plane, the (003) plane, and the like are sometimes collectively referred to as the (001) plane. In this specification and the like, the (001) plane is sometimes referred to as the C-plane, the basal plane, or the like. In addition, it can be said that a diffusion path of lithium ions exists along the basal plane in the positive electrode active material 100. In this specification and the like, a plane where a diffusion path of lithium ions is exposed, i.e., a plane other than a plane where lithium is inserted and extracted, specifically, the (001) plane, is sometimes referred to as an edge plane.

### <Difference in Additive Element Distribution Between Crystal Planes>

As described above, the additive element does not necessarily have similar distributions throughout the surface portion 100a of the positive electrode active material 100. A plane of a region denoted by A-B in FIG. 1A includes a surface having a plane other than the (001) plane. A plane of a region denoted by C-D in FIG. 1A includes a surface having the (001) plane.

In the positive electrode active material 100, the additive element distribution at the (001) plane and the plane parallel thereto may be different from that at a plane other than the (001) plane and a plane parallel thereto even in the case of the same additive element. For example, as illustrated in FIG. 1B, the surface portion 100a and the inner portion 100c in the region denoted by A-B have a distribution in which an additive element concentration increases toward the surface. Even when the same additive element as above is used, the surface portion 100a and the inner portion 100c in the region denoted by C-D may have a distribution in which the additive element concentration increases toward the boundary between the surface portion 100a and the inner portion 100c, as illustrated in FIG. 1C. In a layered rock-salt crystal structure, different additive elements are likely to be added to different planes in some cases. For example, magnesium is likely to be added to a plane other than the (001) plane.

There may be an additive element A having the distribution shown in FIG. 1B and an additive element B having the distribution shown in FIG. 1C when they are different additive elements. Depending on the additive element, the amount of detected additive element, which is not illustrated, at the surface of the (001) plane denoted by C-D, the surface portion 100a including the plane, and the inner portion 100c may be lower than or equal to the lower detection limit.

In the positive electrode active material 100, the concentration of the additive element in the surface of the plane other than the (001) plane denoted by A-B and the surface portion 100a including the plane in FIG. 1B is preferably higher than the concentration of the additive element in the surface of the (001) plane denoted by C-D and the surface portion 100a including the plane in FIG. 1C. An example of the additive element in this case is magnesium.

In a layered rock-salt crystal structure belonging to R-3m, cations are arranged parallel to the (001) plane. This crystal structure can be regarded as a structure in which MO₂ layers (M is cobalt and/or nickel) and lithium layers are alternately stacked parallel to the (001) plane. Accordingly, a diffusion path of lithium ions also exists in a plane parallel to the (001) plane. In addition, a main diffusion path of lithium ions in charging and discharging is not exposed at the (001) plane. Since the MO₂ layer is relatively stable, the surface including the (001) plane and the surface portion including the surface are stable.

By contrast, a diffusion path of lithium ions is exposed at a plane other than the (001) plane. Thus, the surface including a plane other than the (001) plane and the surface portion 100a including the plane easily lose stability because they are regions where extraction of lithium ions starts as well as important regions for maintaining a diffusion path of lithium ions. It is thus important to reinforce the surface portion 100a including a plane other than the (001) plane for maintaining the crystal structure of the whole positive electrode active material 100.

For example, the additive element is preferably added to the surface portion 100a including a plane other than the (001) plane, utilizing a diffusion path of lithium ions. The additive element is preferably added after formation of the composite oxide so as to be efficiently added to the surface portion 100a including a plane other than the (001) plane. As the above additive element, magnesium substituted for lithium sites is preferably used.

As described in the following embodiment, the positive electrode active material 100 is obtained through a coprecipitation method; thus, the additive element may be added to a hydroxide, which is a precursor of the composite oxide. This is because a diffusion path of lithium ions is sometimes formed also in the hydroxide. Note that in this specification and the like, a hydroxide at the stage before a composite oxide is generated is referred to as a precursor.

In order to maintain the crystal structure of the whole positive electrode active material 100, the additive element is preferably positioned in the surface portion 100a where deterioration is likely to start; thus, regardless of the timing when the additive element is added, the additive element is preferably positioned in the surface portion 100a to stabilize the crystal structure.

### <Substantial Alignment>

Owing to the above-described additive element concentration gradient, in some cases, the inner portion 100c has a layered rock-salt crystal structure, and the surface and the surface portion 100a each have a rock-salt crystal structure or a crystal structure having features of both a rock-salt crystal structure and a layered rock-salt crystal structure, for example. It is preferable that the crystal structure continuously change from the inner portion 100c toward the surface portion 100a. Alternatively, the crystal orientations of the surface portion 100a and the inner portion 100c are preferably substantially aligned with each other.

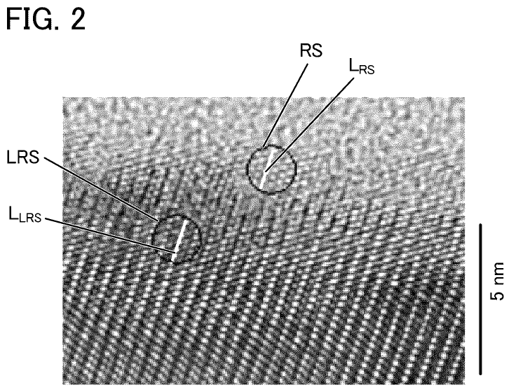

FIG. 2 shows an example of a TEM image in which orientations of a layered rock-salt crystal LRS of the inner portion 100c and a rock-salt crystal RS of the surface portion 100a are substantially aligned with each other. For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} shown in FIG. 2) is 5° or less or 2.5° or less in the TEM image, it can be judged that the crystal planes are substantially aligned with each other, that is, crystal orientations are substantially aligned with each other. Similarly, when the angle between the dark lines is 5° or less or 2.5° or less, it can be judged that crystal orientations are substantially aligned with each other.

An image reflecting a crystal structure is obtained not only in a TEM image but also in a HAADF-STEM image, an ABF-STEM image, and the like.

In a HAADF-STEM image, a contrast proportional to the atomic number is obtained, and an element having a larger atomic number is observed to be brighter. For example, in the case of lithium cobalt nickel oxide that has a layered rock-salt structure belonging to the space group R-3m, cobalt (atomic number: 27) and nickel (atomic number: 28) each have the large atomic number; hence, an electron beam is strongly scattered at the positions of a cobalt atom and a nickel atom, and arrangement of the cobalt atoms and the nickel atoms is observed as bright lines or arrangement of high-luminance dots. Thus, when the lithium cobalt nickel oxide having a layered rock-salt crystal structure is observed in the direction perpendicular to the c-axis, arrangement of the cobalt atoms and the nickel atoms is observed as bright lines or arrangement of high-luminance dots, and arrangement of lithium atoms and oxygen atoms is observed as dark lines or a low-luminance region in the direction perpendicular to the c-axis. Also in the case where fluorine (atomic number: 9) and magnesium (atomic number: 12) are contained as the additive elements of the lithium cobalt nickel oxide, arrangement of fluorine atoms and magnesium atoms is observed as dark lines or a low-luminance region.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, crystal orientations are substantially aligned with each other. Similarly, when the angle between the dark lines is 5° or less or 2.5° or less, it can be judged that crystal orientations are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

It can be judged that the surface portion 100a or the like has features of both a layered rock-salt crystal structure and a rock-salt crystal structure by electron diffraction, a TEM image, a cross-sectional STEM image, and the like.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). Thus, when a layered rock-salt crystal and a rock-salt crystal are in contact with each other, there is a crystal plane where orientations of cubic closest packed structures composed of anions are aligned with each other. In this specification, a state where the orientations of the cubic close-packed structures composed of anions in the layered rock-salt crystal and the rock-salt crystal are aligned with each other is referred to as a state where crystal orientations are substantially aligned with each other in some cases. In addition, topotaxy refers to having similarity in a three-dimensional structure such that crystal orientations are substantially aligned with each other, or to having the same orientations crystallographically.

### <Smooth Surface>

The positive electrode active material 100 illustrated in FIG. 1A preferably has a smooth surface with little unevenness. A smooth surface of the positive electrode active material 100 refers to a state where the positive electrode active material 100 has little unevenness and is rounded as a whole, and its corner portion is rounded. In addition, a smooth surface also refers to a surface to which few foreign matters are attached. Foreign matters are deemed to cause unevenness and are preferably not attached to a surface.

<Secondary Particle with Large Crystallite Size>

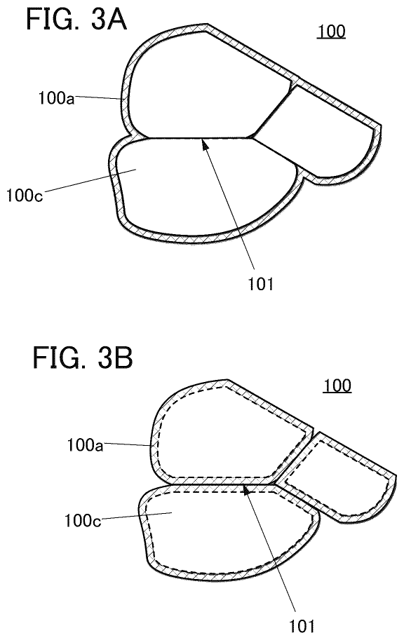

The positive electrode active material 100 of one embodiment of the present invention may be a secondary particle as long as a crystallite size is large. FIG. 3A and FIG. 3B each show a cross-sectional view of the positive electrode active material 100 that is a secondary particle including a primary particle with a large crystallite size. FIG. 3A and FIG. 3B each include a grain boundary 101. The grain boundary 101 is referred to as a crystal grain boundary. The surface portion 100a does not necessarily exist around the grain boundary 101, as illustrated in FIG. 3A or may exist around the grain boundary 101 or along the grain boundary 101 as illustrated in FIG. 3B.

In the positive electrode active material 100, a large crystallite size refers to a large crystallite size calculated using the half width of the XRD diffraction pattern, which correlates with the large size of the primary particle. In the case of the calculation using the half width, the Scherrer equation can be used, for example. A secondary particle does not need to be formed as long as the size of the primary particle is large. In other words, the positive electrode active material 100 of one embodiment of the present invention can include a secondary particle with a large crystallite size, and such a positive electrode active material 100 includes no grain boundary or few grain boundaries possibly generated between primary particles. In addition, although a crack might be generated due to the grain boundary, generation of a crack is expected to be inhibited in the positive electrode active material 100 of one embodiment of the present invention even when the volume of the positive electrode active material 100 is changed by charging and discharging. That is, the secondary particle with a large crystallite size can have an effect equivalent to that of the above-described single particle.

The lower limit of the crystallite size of the positive electrode active material 100 calculated from the half width of the XRD diffraction pattern is preferably greater than or equal to 200 nm, further preferably greater than or equal to 210 nm, still further preferably greater than or equal to 220 nm, for example.

To obtain a large crystallite size, excess lithium is added and then heating is performed. However, excess lithium might cause gelling of a binder when an electrode such as a positive electrode is formed. The upper limit of the crystallite size is preferably set while avoiding the above problem. For example, when the crystallite size calculated from the XRD diffraction pattern is less than or equal to 800 nm, preferably less than or equal to 750 nm, the above problem can be avoided. This upper limit value can be freely combined with the above-described lower limit of the crystallite size.

Although an XRD diffraction pattern for calculation of the half width is preferably obtained in a state of the positive electrode active material alone, the XRD diffraction pattern may be obtained in a state of a positive electrode including a current collector, a binder, a conductive material, and the like in addition to the positive electrode active material. Note that the positive electrode active material may have orientation in the positive electrode owing to, for example, pressure application in a manufacturing process. With high orientation, the crystallite size might fail to be calculated accurately; thus, it is further preferable to obtain an XRD diffraction pattern in the following manner: a positive electrode active material layer is extracted from the positive electrode, the binder and the like in the positive electrode active material layer are removed to some extent using a solvent or the like, and a sample holder is filled with the resultant positive electrode active material, for example.

### <XRD>

The XRD measurement conditions in the case of crystallite size calculation are described. The conditions employ ICSD coll. code. 172909 as literature data of lithium cobalt oxide and a diffraction pattern that is obtained with Bruker D8 ADVANCE as an XRD apparatus, a CuK_{α} source as an X-ray source, 2θ greater than or equal to 15° and less than or equal to 90°, an increment set to 0.010, and LYNX EYE as a detector, for example. Analysis can be conducted using DIFFRAC.TOPAS ver. 3 as crystal structure analysis software. A value of Cry Size Lorentzian calculated by the above method is preferably employed as a crystallite size.

The apparatus and conditions of the XRD measurement are not particularly limited as long as appropriate adjustment and calibration are performed. As a standard sample used for the adjustment and calibration, a standard sintered alumina plate SRM 1976 from National Institute of Standards and Technology (NIST) can be used, for example.

In the case where the measurement sample is a powder of a positive electrode active material or the like, the sample is set by, for example, being placed on a glass sample holder or being sprinkled on a reflection-free silicon plate to which grease is applied. In the case where the measurement sample is a positive electrode, the sample is set in such a manner that the positive electrode is attached to a substrate with a double-sided adhesive tape and the position of the positive electrode active material layer of the positive electrode is adjusted to the measurement plane required by the apparatus.

Characteristic X-rays may be monochromatized with the use of a filter or the like or may be monochromatized with XRD data analysis software after an XRD diffraction pattern is obtained. For example, a peak due to CuKα₂ radiation can be eliminated and only a peak due to CuKα₁ radiation can be extracted by using DEFFRAC.EVA (XRD data analysis software produced by Bruker Corporation). This software can also be used to eliminate the background, for example.

### <Grain Boundary>

The grain boundary 101 illustrated in FIG. 3A and FIG. 3B corresponds to, for example, an interface between primary particles adhere to each other or a plane where a crystal orientation changes inside the positive electrode active material 100, i.e., a plane where repetition of bright lines and dark lines is discontinuous in a STEM image or the like, a plane including a large number of crystal defects, a plane with a disordered crystal structure, or the like. Examples of a crystal defect include a defect that can be observed in cross-sectional TEM (transmission electron microscope), a cross-sectional STEM image, or the like, i.e., a structure containing another element between lattices, and a cavity. The vicinity of the grain boundary 101 refers to a region of a primary particle within 10 nm from the grain boundary 101.

The crystal structure of the surface portion 100a, the grain boundary 101, or the like can be analyzed by electron diffraction of a cross section of the positive electrode active material 100, for example.

The grain boundary 101 is a plane defect. Thus, like the surface portion 100a, the grain boundary 101 is likely to be unstable and a change in the crystal structure is likely to start. Thus, when the additive element concentration at the grain boundary 101 and its vicinity is high, a change in the crystal structure can be further effectively inhibited as described later. Therefore, the additive element is preferably positioned in the surface portion 100a as illustrated in FIG. 3B.

When the additive element concentration is high at the grain boundary 101 and the vicinity thereof, the additive element concentration at a surface newly generated by a crack or the vicinity thereof is high even when the crack is generated due to the grain boundary 101 in the positive electrode active material 100 of one embodiment of the present invention. Thus, even the crystal structure of a surface portion generated by a crack can be stabilized owing to the additive element.

For example, the additive element concentration, typically, the magnesium concentration at the grain boundary 101 and the vicinity thereof in the positive electrode active material 100 is preferably higher than that in the other regions in the inner portion 100c. In addition, the nickel concentration at the grain boundary 101 and the vicinity thereof is preferably higher than that in the other regions in the inner portion 100c.

In the case of using fluorine as the additive element, the fluorine concentration at the grain boundary 101 and in the vicinity thereof is also preferably higher than that in the other regions of the inner portion 100c. Accordingly, the positive electrode active material including a crack can also have an increased corrosion resistance to hydrofluoric acid.

### <Coating Film>

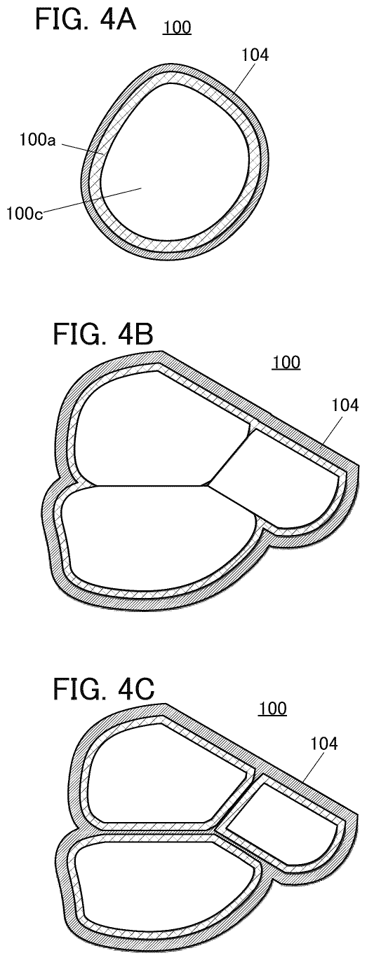

The positive electrode active material 100 may include a coating film on at least part of its surface. FIG. 4A shows an example in which a coating film 104 is provided for the positive electrode active material 100 illustrated in FIG. 1A. FIG. 4B and FIG. 4C show examples in which the coating film 104 is provided for the positive electrode active material 100 illustrated in FIG. 3A and FIG. 3B, respectively.

The coating film 104 is preferably formed by deposition of a decomposition product of an electrolyte solution due to charging and discharging, for example. A coating film originating from an electrolyte solution, which is formed on the surface of the positive electrode active material 100, is expected to improve charge and discharge cycle performance. This is because an increase in impedance of the surface of the positive electrode active material is inhibited or dissolution of cobalt is inhibited, for example. The coating film 104 preferably contains carbon, oxygen, and fluorine, for example. The coating film can have high quality easily when part of the electrolyte solution contains LiBOB and/or SUN (suberonitrile), for example. Accordingly, the coating film 104 containing one or more selected from boron, nitrogen, sulfur, and fluorine is preferable because of having high quality in some cases. The coating film 104 does not necessarily cover the positive electrode active material 100 entirely.

### <Crystal Structure>

The positive electrode active material 100 of one embodiment of the present invention has a unique crystal structure. The crystal structure is described, being compared with that of conventional lithium cobalt oxide. In the description of the crystal structure, the amount of lithium ions to be extracted is denoted by x, the positive electrode active material 100 is denoted by LiₓCo_{(1-y)}Ni_{y}O₂, and the description is made focusing on x. Note that the amount x to be extracted is different from the addition amount of lithium.

<<x in LiₓCo_{(1-y)}Ni_{y}O₂ being 1>>

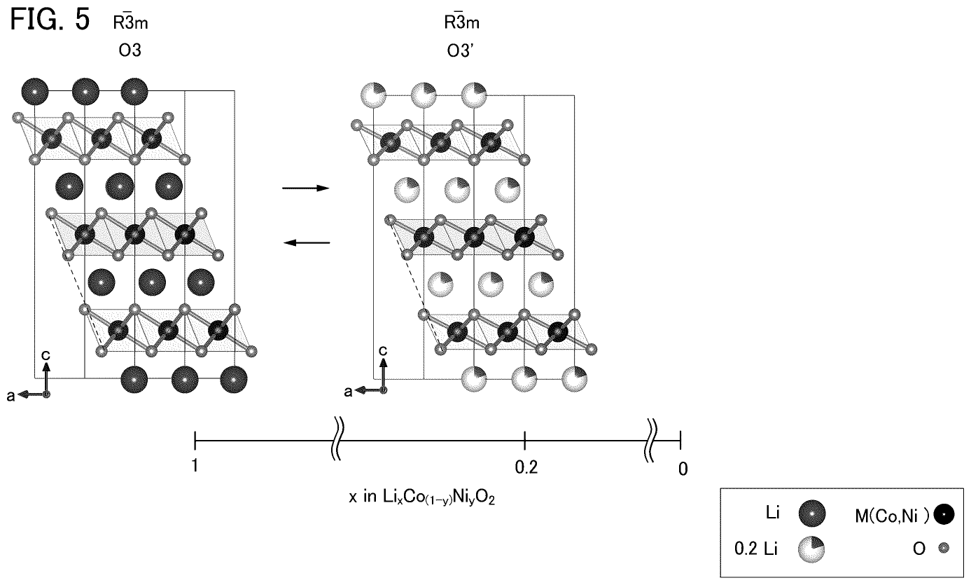

FIG. 5 shows crystal structures of the positive electrode active material 100 of one embodiment of the present invention. The positive electrode active material 100 of one embodiment of the present invention preferably has a layered rock-salt crystal structure in a discharged state, i.e., a state where x in LiₓCo_{(1-y)}Ni_{y}O₂ is 1. It is particularly preferable that the inner portion 100c, which accounts for the majority of the volume of the positive electrode active material 100, have a layered rock-salt crystal structure belonging to the space group R-3m.

In FIG. 5, the layered rock-salt crystal structure is denoted by R-3m O3. In FIG. 5, “O3” is next to the space group. In this crystal structure, lithium occupies octahedral sites and a unit cell includes three layers each composed of octahedrons of the transition metal M (M is cobalt and/or nickel) and oxygen (hereinafter such layer is referred to as an MO₂ layer); thus, this crystal structure is sometimes referred to as an O3 type crystal structure. Note that the MO₂ layer refers to a structure in which an octahedral structure with the transition metal M coordinated to six oxygen atoms continues on a plane in an edge-shared state. Although lithium ions are at all the lithium sites in FIG. 5, the additive element, e.g., a magnesium ion, may be positioned at a lithium site as described above.

The surface portion 100a of the positive electrode active material 100 of one embodiment of the present invention can have a function of reinforcing the layered structure, which is formed of the MO₂ layers, of the inner portion 100c so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100c of the positive electrode active material 100 such as extraction of oxygen and/or a shift in the layered structure formed of the MO₂ layers, and/or inhibition of decomposition of an organic electrolyte solution or the like on the surface of the positive electrode active material 100. Since magnesium can inhibit extraction of oxygen therearound, the above-described reinforcement can be achieved when at least magnesium is contained as the additive element.

The surface portion 100a may have a crystal structure different from that of the inner portion 100c, for example. The surface portion 100a preferably has a more stable crystal structure than that of the inner portion 100c at room temperature (25° C.), in which case the above-described reinforcing effect can be exhibited. For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charging, and is a region that tends to have a lower lithium concentration than the inner portion 100c. Bonds between atoms are regarded as being partly cut on the surface of the particle of the positive electrode active material 100 included in the surface portion 100a. Thus, the surface portion 100a is regarded as a region which is likely to be unstable and in which deterioration of the crystal structure is likely to start. For example, it is considered that a shift in the crystal structure of the layered structure, which is formed of the MO₂ layers, in the surface portion 100a has an influence on the inner portion 100c to cause a shift in the crystal structure of the layered structure in the inner portion 100c, leading to deterioration of the crystal structure in the whole positive electrode active material 100. Meanwhile, when the surface portion 100a can be made sufficiently stable, the layered structure, which is formed of the MO₂ layers, of the inner portion 100c is less likely to be broken even with small x in LiₓCo_{(1-y)}Ni_{y}O₂. Furthermore, a shift in the MO₂ layers of the inner portion 100c can be inhibited.

As described above, the additive element distribution at the (001) plane of the positive electrode active material 100 may be different from that at a plane other than the (001) plane. This is probably because the MO₂ layer is relatively stable in a layered rock-salt crystal structure, and thus the surface of the positive electrode active material 100 is more stable when the surface is the (001) plane but a diffusion path of lithium ions is exposed at the plane other than the (001) plane. A main diffusion path of lithium ions in charging and discharging is not exposed at the (001) plane; meanwhile, the plane other than the (001) plane, at which a diffusion path of lithium ions is exposed, is an important region for maintaining a diffusion path of lithium ions. Moreover, the plane other than the (001) plane is a region from which lithium ions are extracted initially, and thus is likely to be unstable. Thus, it is preferable to reinforce the plane other than the (001) plane so that the crystal structure of the whole positive electrode active material 100 is maintained.

Therefore, in the case of magnesium, the half width of the magnesium distribution at the (001) plane and the surface portion 100a having the plane is preferably greater than or equal to 5 nm and less than or equal to 150 nm, further preferably greater than or equal to 10 nm and less than or equal to 100 nm, still further preferably greater than or equal to 20 nm and less than or equal to 80 nm. The half width of the magnesium distribution at the plane other than the (001) plane and the surface portion 100a having the plane is preferably greater than 150 nm and less than or equal to 280 nm, further preferably greater than 180 nm and less than or equal to 250 nm, still further preferably greater than or equal to 200 nm and less than or equal to 230 nm. In the case where the half width is regarded as the distribution width, the distribution width at the (001) plane and the surface portion 100a having the plane is preferably greater than or equal to 10 nm and less than or equal to 300 nm in the profile of magnesium. The distribution width of magnesium at the plane other than the (001) plane and the surface portion 100a having the plane is preferably greater than 300 nm and less than or equal to 500 nm. Since magnesium might increase the resistance value of the surface portion 100a, magnesium preferably has a narrow distribution width as described above.

As described in the following embodiment, in the manufacturing method in which heating is performed after the additive element is mixed, the additive element may spread mainly through a diffusion path of lithium ions. Thus, in order to make the additive element distribution fall within a preferred range at the plane other than the (001) plane and the surface portion 100a having the plane, it is preferable to employ a method in which the additive element is mixed after the formation of a composite oxide containing lithium cobalt nickel oxide or the additive element is mixed with a hydroxide that is a precursor of the composite oxide. Note that it is preferable to use magnesium, which has a large ion radius and thus is likely to remain in the surface portion 100a regardless of the step in which magnesium is added.

### [Magnesium]

Since the ion radius of magnesium is close to the ion radius of a lithium ion, magnesium ions easily enter lithium sites in a layered rock-salt crystal structure. An appropriate magnesium concentration in the lithium sites of the surface portion 100a can facilitate maintenance of the crystal structure of the inner portion 100c. This is presumably because magnesium in the lithium sites serves as a column supporting the MO₂ layers. Moreover, magnesium can inhibit release of oxygen therearound and can inhibit a thermal decomposition reaction even in a state where x in LiₓCo_{(1-y)}Ni_{y}O₂ is small. In addition, a high magnesium concentration in the surface portion 100a presumably increases the corrosion resistance to hydrofluoric acid generated by the decomposition of the organic electrolyte solution or the like.

### [Fluorine]

A fluorine ion is an anion, and may be substituted for part of oxygen which is also an anion. That is, fluorine may be substituted for part of oxygen in the surface portion 100a at an appropriate concentration. The oxidation-reduction potential of cobalt ions associated with lithium extraction differs depending on the presence or absence of fluorine. That is, when fluorine is not contained, cobalt ions change from a trivalent state to a tetravalent state owing to lithium extraction. Meanwhile, when fluorine is contained, cobalt ions change from a divalent state to a trivalent state owing to lithium extraction. The oxidation-reduction potential of cobalt ions differs between these cases; in the case where fluorine is contained, the energy for lithium extraction from the positive electrode active material 100 is lower. Thus, lithium ions near fluorine are likely to be inserted and extracted smoothly. Accordingly, fluorine preferably exists at the surface or the surface portion 100a of the positive electrode active material 100. A secondary battery including the positive electrode active material 100 containing fluorine can have improved charge and discharge characteristics, improved large current characteristics, or the like.

When fluorine exists at the surface or surface portion, which is a portion to be in contact with an electrolyte solution, or when a fluoride is adsorbed onto or attached to the surface, an overreaction between the positive electrode active material 100 and the electrolyte solution can be inhibited. In addition, when fluorine exists at the surface or surface portion, which is a portion to be in contact with an electrolyte solution, the corrosion resistance to hydrofluoric acid generated by the decomposition of the organic electrolyte solution or the like is presumably increased. The above adsorption may be chemical adsorption or physical adsorption. Chemical adsorption refers to formation of a chemical bond due to a chemical reaction between fluorine and the surface of the positive electrode active material 100, and physical adsorption refers to adsorption due to intermolecular force (van der Waals force) exerted between fluorine and the surface of the positive electrode active material 100.

The melting point of a fluorine compound (sometimes also referred to as fluoride) such as lithium fluoride considered as a fluorine source is sometimes lower than the melting point of another additive element source. That is, a fluorine compound or the like can serve as a fusing agent (also referred to as a flux) for lowering the melting point of the another additive element source. In the case of a fluorine compound containing LiF and MgF₂, the eutectic point P of LiF and MgF₂ is around 742° C.; thus, the heating temperature in the heating step following the mixing of the additive element is preferably set around 742° C.

### [Nickel]

Nickel has a lower oxidation-reduction potential than cobalt, and thus facilitates release of lithium during charging, for example. Therefore, the positive electrode active material 100 with a high atomic ratio of nickel is expected to increase the charge and discharge speed.

Ionization tendency is the highest in magnesium and lower in the order of aluminum, cobalt, and nickel. Therefore, it is considered that in charging, nickel is less likely to be dissolved into an electrolyte solution than the other elements described above. Accordingly, nickel has a high effect of stabilizing the crystal structure of the surface portion in a charged state, and nickel preferably exists in both the inner portion 100c and the surface portion 100a.

### [Aluminum]

Aluminum can exist in the cobalt site in a layered rock-salt crystal structure. Since aluminum is a trivalent representative element and its valence does not change, lithium around aluminum is less likely to move even in charging and discharging. Thus, aluminum and lithium therearound can maintain the distance between adjacent MO₂ layers, so that a change in the crystal structure can be inhibited. This can inhibit deterioration of the positive electrode active material 100 if force of expansion and contraction of the positive electrode active material 100 in the c-axis direction operates owing to insertion and extraction of lithium ions, i.e., force of expansion and contraction in the c-axis direction operates owing to a change in charge depth or charge rate.

Furthermore, aluminum has effects of inhibiting dissolution of cobalt therearound and improving continuous charge tolerance. Moreover, an Al—O bond is stronger than an MO bond, specifically, a CoO bond, and thus extraction of oxygen around aluminum can be inhibited. These effects improve thermal stability. Thus, a secondary battery that includes the positive electrode active material 100 containing aluminum as the additive element can have higher level of safety. Furthermore, the positive electrode active material 100 can have a crystal structure that is less likely to be broken even with repeated charging and discharging.

### [Synergistic Effect Between a Plurality of Elements]

When the surface portion 100a contains both magnesium and nickel, nickel can exist more stably in the vicinity of magnesium. Thus, even with small x in LiₓCo_{(1-y)}Ni_{y}O₂, dissolution of magnesium might be inhibited when the surface portion 100a contains both magnesium and nickel. This can contribute to stabilization of the surface portion 100a.

When a plurality of additive elements are contained as described above, the effects of the additive elements contribute synergistically to further stabilization of the surface portion 100a. In particular, magnesium, nickel, and aluminum are preferably contained because a high effect of stabilizing the composition and crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only a structure in which MgO forms a solid solution. Thus, the surface portion 100a needs to contain at least cobalt, also contain lithium in a discharged state, and have the path through which lithium is inserted and extracted. To ensure the sufficient path through which lithium is inserted and extracted, the concentration of cobalt is preferably higher than that of magnesium in the surface portion 100a. It is acceptable that the concentration of nickel is higher than that of magnesium in the surface portion 100a.

It is preferable that magnesium, which is one of the additive elements, have a higher concentration in the surface portion 100a than in the inner portion 100c and exist randomly also in the inner portion 100c to have a low concentration. When magnesium exists in the lithium sites of the inner portion 100c at an appropriate concentration, an effect of facilitating maintenance of the layered rock-salt crystal structure can be obtained in a manner similar to the above.

It is preferable that aluminum, which is one of the additive elements, have a higher concentration in the surface portion 100a than in the inner portion 100c and exist randomly also in the inner portion 100c to have a low concentration. When aluminum exists in the lithium sites of the inner portion 100c at an appropriate concentration, an effect of facilitating maintenance of the layered rock-salt crystal structure can be obtained in a manner similar to the above.

When nickel exists in the inner portion 100c, a shift in the layered structure formed of the MO₂ layers can be inhibited in a manner similar to the above. In addition, when nickel exists in the surface portion 100a, a shift in the layered structure formed of the MO₂ layers can be inhibited in a manner similar to the above.

<<x in LiₓCo_{(1-y)}Ni_{y}O₂ Being Small>>

Since the positive electrode active material 100 of one embodiment of the present invention has the above-described additive element distribution and/or crystal structure, the positive electrode active material 100 is different from conventional lithium cobalt oxide in the crystal structure in a state where x in LiₓCo_{(1-y)}Ni_{y}O₂ is small, i.e., a high-voltage charged state. Here, “x is small” means, for example, 0.1<x≤0.24. A high voltage in a charged state means a voltage higher than or equal to 4.5 V, higher than or equal to 4.6 V, preferably higher than or equal to 4.7 V, further preferably higher than or equal to 4.8 V.

Conventional lithium cobalt oxide and the positive electrode active material 100 of one embodiment of the present invention are compared, and changes in the crystal structures owing to a change in x in LiₓCo_{(1-y)}Ni_{y}O₂ will be described with reference to FIG. 5.

First, conventional lithium cobalt oxide is described. Conventional lithium cobalt oxide with x=approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

Conventional lithium cobalt oxide with x=0 has the trigonal crystal structure belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x=approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that insertion and extraction of lithium do not necessarily uniformly occur in the positive electrode active material in reality; thus, a change in the crystal structure does not strictly correspond to the amount of lithium to be extracted, and the value of the amount of lithium to be extracted may be obtained at the timing when a crystal change starts.

When charging that makes x be 0.24 or less and discharging are repeated, the crystal structure of conventional lithium cobalt oxide repeatedly changes between the R-3m O3 structure in a discharged state and the H1-3 type crystal structure (i.e., an unbalanced phase change).

There is a large shift in the CoO₂ layers between these two crystal structures. The CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers deterioration of the cycle performance. This is because the broken crystal structure has a smaller number of sites where lithium can exist stably and makes it difficult to insert and extract lithium.

Next, the positive electrode active material 100 of one embodiment of the present invention is described. In the positive electrode active material 100 of one embodiment of the present invention illustrated in FIG. 5, a change in the crystal structure in a state where x in LiₓCo_{(1-y)}Ni_{y}O₂ is small, e.g., x=approximately 0.2, is different from that in conventional lithium cobalt oxide. FIG. 5 illustrates a trigonal crystal structure belonging to the space group R-3m of the positive electrode active material 100 of one embodiment of the present invention with x=approximately 0.2. The symmetry of the MO₂ layers of this structure is the same as that of O3. Thus, this crystal structure is called an O3′ type crystal structure. In FIG. 5, this crystal structure is denoted by R-3m O3′. An XRD pattern of this crystal structure is sometimes similar to a pattern of a spinel structure, so that this crystal structure may be referred to as a pseudo-spinel structure.

As denoted by dotted lines in FIG. 5, in the positive electrode active material 100 of one embodiment of the present invention, the MO₂ layers hardly shift between the R-3m O3 in a discharged state and the O3′ type crystal structure. That is, in the positive electrode active material 100 of one embodiment of the present invention, the shift in the MoO₂ layers is small between the state with x of 1 and the state with small x. Furthermore, in the positive electrode active material 100 of one embodiment of the present invention, a change in the volume per the same number of atoms of the transition metal can be small. Thus, in the positive electrode active material 100 of one embodiment of the present invention, the crystal structure is less likely to be shifted, i.e., broken, and the site at which lithium can be stable is maintained even when charging that makes x be approximately 0.2, specifically, 0.24 or less, and discharging are repeated; accordingly, excellent cycle performance can be achieved.

The positive electrode active material 100 of one embodiment of the present invention can stably use a larger amount of lithium than conventional lithium cobalt oxide, and thus the positive electrode active material 100 enables high discharge capacity per weight and per volume. Thus, with use of the positive electrode active material 100, a secondary battery with high discharge capacity per weight and per volume can be fabricated.

The positive electrode active material 100 of one embodiment of the present invention can have a more stable crystal structure than conventional lithium cobalt oxide in a state where x in LiₓCo_{(1-y)}Ni_{y}O₂ is 0.24 or less. Thus, in the positive electrode active material 100 of one embodiment of the present invention, oxygen is not easily released even when the state where x in LiₓCo_{(1-y)}Ni_{y}O₂ is 0.24 or less is maintained, which can inhibit a thermal decomposition reaction. A lithium-ion secondary battery including the positive electrode active material 100 presumably does not ignite when the battery undergoes a nail penetration test. In other words, a secondary battery preferably includes the positive electrode active material 100 of one embodiment of the present invention to have improved safety.

In this specification and the like, “ignition does not occur in a nail penetration test” refers to a state where fire is not observed outside an exterior body or a state where thermal runaway of a secondary battery does not occur. That is, a state where a spark and/or smoke that are/is observed but do/does not spread is equivalent to a state where ignition does not occur.

In the unit cell of the O3′ type crystal structure of the positive electrode active material 100, the typical coordinates of cobalt and oxygen can be represented as follows: Co (0, 0, 0.5) and O (0, 0, x) within the range of 0.20≤x≤0.25. In the unit cell of the O3′ type crystal structure, the lattice constant of the a-axis is preferably 2.797×10⁻¹⁰≤a≤2.837×10⁻¹⁰ (m), further preferably 2.807×10⁻¹⁰≤a≤2.827×10⁻¹⁰ (m), typically a=2.817×10⁻¹⁰ (m). The lattice constant of the c-axis is preferably 13.681×10⁻¹⁰≤c≤13.881×10⁻¹⁰ (m), further preferably 13.751×10⁻¹⁰≤c≤13.811×10⁻¹⁰ (m), typically c=13.781×10⁻¹⁰ (m).

In order to make x in LiₓCo_{(1-y)}Ni_{y}O₂ small, charging with a high charge voltage is necessary in general. Thus, the state where x in LiₓCo_{(1-y)}Ni_{y}O₂ is small can be rephrased as a state where charging with a high charge voltage has been performed. For example, when constant current (CC) charging is performed and then constant voltage (CV) charging is performed (this is referred to as CCCV charging) at a voltage higher than or equal to 4.6 V at 25° C. using the potential of a lithium metal as a reference, the H1-3 type crystal structure starts to appear in conventional lithium cobalt oxide. Meanwhile, the positive electrode active material 100 of one embodiment of the present invention is preferable because the crystal structure with the symmetry of R-3m O3 can be maintained even when CCCV charging is performed at a high charge voltage, for example, at a voltage higher than or equal to 4.6 V at 25° C.

In this specification and the like, unless otherwise specified, a charge voltage is shown using the potential of a lithium metal as a reference. Note that when a material other than the lithium metal is used for the counter electrode, the potential of a secondary battery differs from the potential of the positive electrode. As for the potential of the positive electrode, for example, charging at 4.5 V using a graphite counter electrode substantially corresponds to charging at 4.6 V using a lithium counter electrode.

Although a chance of the existence of lithium is the same in all lithium sites in the O3′ type crystal structure in FIG. 5, one embodiment of the present invention is not limited thereto. Lithium may exist unevenly in only some of the lithium sites. The lithium distribution can be analyzed by neutron diffraction, for example.

As described above, the crystal structure of the positive electrode active material 100 of one embodiment of the present invention preferably changes in accordance with a change in x in LiₓCo_{(1-y)}Ni_{y}O₂, and this change is preferably unique and different from that of conventional lithium cobalt oxide. Note that the change in x in LiₓCo_{(1-y)}Ni_{y}O₂ is equivalent to a change in a charge depth, and a charge depth in the case where x=0.2 corresponds to 1-0.2=0.8.

### <Particle Diameter>

In a particle size distribution curve in which the horizontal axis represents cumulative %, the particle diameter intersecting with a point where the horizontal axis is 10% is referred to as a 10% diameter or D10, the particle diameter intersecting with a point where the horizontal axis is 50% is referred to as a 50% diameter or D50, and the particle diameter intersecting with a point where the horizontal axis is 90% is referred to as a 90% diameter or D90; in some cases, D50 is referred to as a median diameter. In the case of representing the particle diameter, D50 is often used. When the particle diameter of the positive electrode active material 100 of one embodiment of the present invention is too large, there are problems such as difficulty in lithium diffusion and large surface roughness of an active material layer at the time when the material is applied to a current collector. In contrast, when the particle diameter is too small, a problem occurs such as over-reaction with an electrolyte solution. Accordingly, D50 of the positive electrode active material 100 is preferably greater than or equal to 1 μm and less than or equal to 100 μm, further preferably greater than or equal to 15 μm and less than or equal to 40 μm, still further preferably greater than or equal to 15 μm and less than or equal to 35 μm.

Particles having different particle diameters are preferably mixed and then used for a positive electrode, in which case the electrode density can be increased and a secondary battery with a high energy density can be fabricated. The positive electrode active material 100 with a relatively small particle diameter is expected to achieve favorable charge and discharge rate performance. The positive electrode active material 100 having a relatively large particle diameter is expected to have high charge and discharge cycle performance and maintain high discharge capacity.

### <<Analysis Method>>

Whether or not a given positive electrode active material has the O3′ type crystal structure in charging can be judged by analyzing a positive electrode including the positive electrode active material with small x in LiₓCo_{(1-y)}Ni_{y}O₂ by XRD, electron diffraction, neutron diffraction, electron spin resonance (ESR), nuclear magnetic resonance (NMR), or the like. For example, x can be 0.2.

Note that a positive electrode active material with small x sometimes causes a change in the crystal structure when exposed to the air. For that reason, all samples subjected to analysis of crystal structures are preferably handled in an inert atmosphere such as an argon atmosphere.

XRD is particularly preferable because the symmetry of a transition metal contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100c of the positive electrode active material 100, which accounts for the majority of the volume of the positive electrode active material 100, can be obtained through XRD, in particular, powder XRD.

### <<Charge Method>>

Charging for determining whether or not a positive electrode active material is the positive electrode active material 100 of one embodiment of the present invention can be performed using a coin-type cell (also referred to as a coin cell; CR2032 type with a diameter of 20 mm and a height of 3.2 mm) that is formed using a lithium metal for a counter electrode, for example.

More specifically, a positive electrode can be formed by application of slurry in which the positive electrode active material, a conductive material, and a binder are mixed onto a positive electrode current collector made of aluminum foil.

A lithium metal can be used for the counter electrode as described above, but a material other than a lithium metal may be alternatively used. When a material other than the lithium metal is used, the potential of a secondary battery differs from the potential of the positive electrode. Unless otherwise specified, the voltage and the potential in this specification and the like refer to a potential of a positive electrode.

As a lithium salt contained in the electrolyte solution, 1 mol/L of lithium hexafluorophosphate (LiPF₆) is used, and as the electrolyte solution, a solution in which ethylene carbonate (EC) and diethyl carbonate (DEC) are mixed at EC:DEC=3:7 (volume ratio) can be used. In the electrolyte solution, vinylene carbonate (VC) may be mixed at 2 wt %.

As a separator, a 25-μm-thick polypropylene porous film can be used.

A can formed with stainless steel (SUS) can be used as each of a positive electrode can and a negative electrode can.

The coin cell fabricated under the above-described conditions is charged at a freely selected voltage (e.g., 4.6 V, 4.65 V, 4.7 V, 4.75 V, or 4.8 V). For example, in the case of CCCV charging, a current in the CC charging can be higher than or equal to 20 mA/g and lower than or equal to 100 mA/g. The CV charging can be terminated at a current higher than or equal to 2 mA/g and lower than or equal to 10 mA/g. To observe a phase change of the positive electrode active material, charging with such a small current value is desirably performed. The XRD measurement temperature is preferably set to 25° C. After charging is performed under the above conditions, the coin cell is disassembled in a glove box with an argon atmosphere to take out the positive electrode, whereby the positive electrode active material that enables a predetermined charge capacity, i.e., a predetermined charge depth can be obtained. In order to inhibit a reaction with components in the external environment, the positive electrode is preferably enclosed in an argon atmosphere in performing various analyses later. For example, XRD can be performed on the positive electrode active material enclosed in an airtight container with an argon atmosphere. After charging is completed, the positive electrode is preferably taken out immediately and subjected to the analysis. Specifically, the positive electrode is preferably subjected to the analysis within an hour after the completion of charging, further preferably within 30 minutes after the completion of charging.

In the case where the crystal structure in a charged state after performing charging and discharging multiple times is analyzed, the conditions of the multiple times of charging and discharging may be different from the above-described charge conditions. For example, as the charging, CC charging can be performed to a freely selected voltage (e.g., 4.6 V, 4.65 V, 4.7 V, 4.75 V, or 4.8 V) at a current value higher than or equal to 20 mA/g and lower than or equal to 100 mA/g, and then CV charging can be performed until the current value becomes higher than or equal to 2 mA/g and lower than or equal to 10 mA/g. As the discharging, CC discharging can be performed at a current value higher than or equal to 20 mA/g and lower than or equal to 100 mA/g until the discharge voltage reaches 2.5 V.

Also in the case where the crystal structure in a discharged state after the charging and discharging are performed multiple times is analyzed, CC discharging can be performed at a current value higher than or equal to 20 mA/g and lower than or equal to 100 mA/g until the discharge voltage reaches 2.5 V, for example.

Data processing for a 2θ value of a diffraction peak in this specification and the like is described. First, a calculation model is fitted for an XRD pattern with the use of crystal structure analysis software to obtain a pattern after calculation. Then, the 2θ value at which a peak top of the diffraction peak appears in the pattern after the calculation is defined as the 2θ value of the diffraction peak. There is no particular limitation on the crystal structure analysis software used for the fitting; for example, it is possible to use TOPAS ver. 3 (crystal structure analysis software produced by Bruker Corporation).

The range of 2θ in the positive electrode active material 100 of one embodiment of the present invention in the case of using a CuK_{α1} source is described. When the positive electrode active material 100 has the O3′ type crystal structure, diffraction peaks are exhibited at 2θ of 19.30±0.20° (greater than or equal to 19.10° and less than 19.50°) and 2θ of 45.55±0.10° (greater than or equal to 45.45° and less than 45.65°).

In the state where x in LiₓCo_{(1-y)}Ni_{y}O₂ is small, e.g., x is 0.24 or less, the diffraction peaks are exhibited at least 2θ of 19.30±0.20° and 2θ of 45.55±0.10°, which can be regarded as the features of the positive electrode active material 100 of one embodiment of the present invention.

It can be said that the positions of the XRD diffraction peaks exhibited by the crystal structure with x=1 and the crystal structure with x≤0.24 are close to each other. More specifically, it can be said that in the 2θ range of 42° to 46°, a difference in 2θ between the main diffraction peak exhibited by the crystal structure with x=1 and the main diffraction peak exhibited by the crystal structure with x≤0.24 is 0.7° or less, preferably 0.5° or less.

Although the positive electrode active material 100 of one embodiment of the present invention has the O3′ type crystal structure when x in LiCo_{(1-y)}Ni_{y}O₂ is small, not all particles necessarily has the O3′ type crystal structure. The positive electrode active material 100 may have another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. There is no particular limitation on the crystal structure analysis software used for Rietveld analysis; for example, it is possible to use TOPAS ver. 3 (crystal structure analysis software produced by Bruker Corporation). Preferably, GOF (Goodness of fit) is less than or equal to 1.3, which means that adequate fitting is performed.

The H1-3 type crystal structure and the O1 type crystal structure preferably account for less than or equal to 40% when the Rietveld analysis is performed in a manner similar to the above.

Sharpness of a diffraction peak in an XRD pattern indicates the degree of crystallinity. It is thus preferable that the diffraction peaks after charging be sharp, in other words, have a small half width, e.g., a small full width at half maximum. Even peaks that are derived from the same crystal phase have different half widths depending on the XRD measurement conditions and the 2θ value.

As described above, the influence of the Jahn-Teller effect is preferably small in the positive electrode active material 100 of one embodiment of the present invention. The proportion of nickel and the range of the lattice constants in each of which the influence of the Jahn-Teller effect is presumed to be small in the positive electrode active material are examined by XRD analysis.

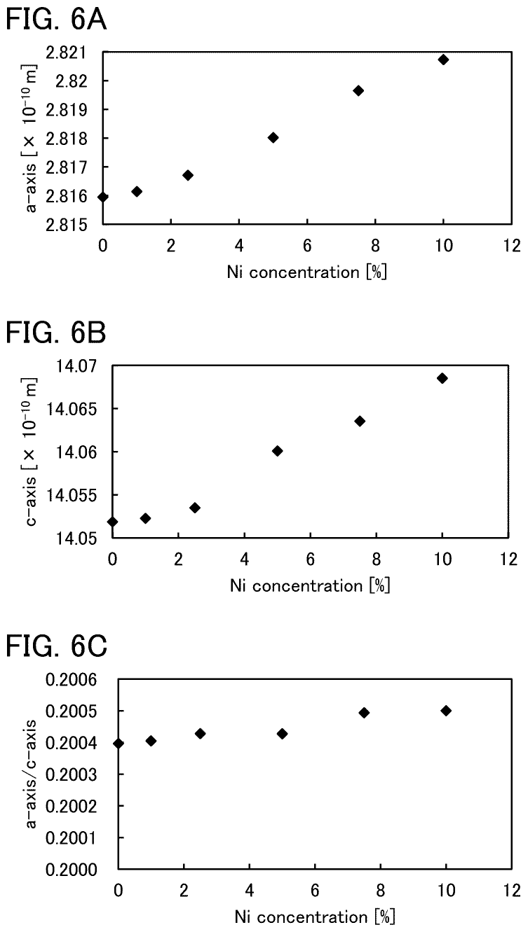

FIG. 6 shows the calculation results of the lattice constants of the a-axis and the c-axis by XRD in the case where the positive electrode active material 100 of one embodiment of the present invention has a layered rock-salt crystal structure and contains cobalt and nickel. FIG. 6A shows the results of the a-axis, and FIG. 6B shows the results of the c-axis. Note that the XRD patterns of a powder after the synthesis of the positive electrode active material before incorporation into a positive electrode are used for the calculation. The nickel concentration on the horizontal axis is equal to the atomic ratio of nickel with the sum of the atomic ratios of cobalt and nickel assumed as 100%.

FIG. 6C shows values obtained by dividing the lattice constants of the a-axis by the lattice constants of the c-axis (a-axis/c-axis) in the positive electrode active material, whose results of the lattice constants are shown in FIG. 6A and FIG. 6B.

As shown in FIG. 6C, the value of a-axis/c-axis tends to significantly change when the nickel concentration increases from 5 at % to 7.5 at %, and as shown in FIG. 6A, the distortion of the a-axis is large at a nickel concentration of 7.5 at %. This distortion may be derived from the Jahn-Teller distortion of trivalent nickel. It is suggested that an excellent positive electrode active material with small Jahn-Teller distortion can be obtained at a nickel concentration of lower than 7.5 at %. It is thus considered that a positive electrode active material with small Jahn-Teller distortion can be obtained when z is greater than 0 and less than or equal to 0.3 in the case of using LiCo_{1-y-z}Ni_{y}O₂A_{z} as the positive electrode active material 100.

Such a composite oxide with small Jahn-Teller distortion is preferably included in the inner portion 100c of the positive electrode active material 100. That is, the nickel concentration in the surface portion 100a of the positive electrode active material 100 is not limited to the above range. In other words, the nickel concentration in the surface portion 100a may be higher than the above concentrations.

Preferable ranges of the lattice constants of the positive electrode active material 100 of one embodiment of the present invention are examined above. In the layered rock-salt crystal structure of the positive electrode active material 100 in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be, for example, the state of a powder before the formation of a positive electrode of a secondary battery.

It can be said that in the positive electrode active material 100 in the discharged state or the state where charging and discharging are not performed, the value obtained by dividing the lattice constant of the a-axis by the lattice constant of the c-axis (a-axis/c-axis) is preferably greater than 0.20000 and less than 0.20049.

When the positive electrode active material 100 in the discharged state or the state where charging and discharging are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### <<XPS>>

In an inorganic oxide, a region that extends from the surface to a depth of approximately 2 to 8 nm (normally, 5 nm or less) can be analyzed by X-ray photoelectron spectroscopy (XPS) using monochromated aluminum Kα radiation as an X-ray source; thus, the concentrations of elements in a region extending to approximately half the depth of the surface portion 100a of the positive electrode active material 100 can be quantitatively analyzed. The bonding states of the elements can be analyzed by narrow scanning. Note that in many cases, the quantitative accuracy of XPS is approximately ±1 at %, and the lower detection limit is approximately 1 at % but depends on the element.

In the positive electrode active material 100 of one embodiment of the present invention, the concentration of one or more selected from the additive elements is preferably higher in the surface portion 100a than in the inner portion 100c. This means that the concentration of one or more selected from the additive elements in the surface portion 100a is preferably higher than the average concentration in the entire positive electrode active material 100. For this reason, for example, it can be said that the concentration of one or more additive elements selected from the surface portion 100a, which is measured by XPS or the like, is preferably higher than the average additive element concentration in the entire positive electrode active material 100, which is measured by ICP-MS (inductively coupled plasma-mass spectrometry), GD-MS (glow discharge mass spectrometry), or the like. For example, the magnesium concentration in at least part of the surface portion 100a, which is measured by XPS or the like, is preferably higher than the average magnesium concentration in the entire positive electrode active material 100. The nickel concentration in at least part of the surface portion 100a is preferably higher than the average nickel concentration in the entire positive electrode active material 100. The aluminum concentration in at least part of the surface portion 100a is preferably higher than the average aluminum concentration in the entire positive electrode active material 100. The fluorine concentration in at least part of the surface portion 100a is preferably higher than the average fluorine concentration in the entire positive electrode active material 100.

The additive element concentration may be compared using the ratio of the additive element to cobalt. The use of the ratio of the additive element to cobalt is preferable because it enables comparison while reducing the influence of a carbonate or the like which is chemically adsorbed after formation of the positive electrode active material. For example, in the XPS analysis, the atomic ratio of magnesium to cobalt Mg/Co is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than the concentration of one or more selected from the additive elements contained in the surface portion 100a, which is measured by XPS or the like.

Furthermore, when XPS analysis is performed on the positive electrode active material 100 of one embodiment of the present invention, the atomic ratio of magnesium is preferably greater than or equal to 0.4 times and less than or equal to 1.2 times, further preferably greater than or equal to 0.65 times and less than or equal to 1.0 times the atomic ratio of cobalt. The atomic ratio of aluminum is preferably less than or equal to 0.12 times, further preferably less than or equal to 0.09 times the atomic ratio of cobalt. When the ratio is within the above range, it can be said that the additive element is widely distributed at a preferable concentration in the surface portion 100a of the positive electrode active material 100.

In the XPS analysis, monochromatic aluminum Kα radiation can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μmϕ
Detection depth: approximately 4 to 5 nm (extraction angle 45°)

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the value of the bonding energy of magnesium oxide.

### <<EDX>>

The one or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated, for example, by exposing a cross section of the positive electrode active material 100 using FIB (Focused Ion Beam) or the like and analyzing the cross section using EDX, EPMA, or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the additive element concentrations in the surface portion 100a, the inner portion 100c, the vicinity of the grain boundary 101, and the like of the positive electrode active material 100 can be quantitatively analyzed. By EDX line analysis, the concentration distribution and the highest additive element concentration can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of each additive element, in particular, the additive element in the surface portion 100a is higher than that in the inner portion 100c.

EDX line analysis, EDX area analysis, or EDX point analysis of the positive electrode active material 100 preferably reveals that the ratio of the atomic ratio of magnesium Mg to the atomic ratio of cobalt Co (Mg/Co) at a peak of the magnesium concentration is preferably greater than or equal to 0.05 and less than or equal to 0.6, further preferably greater than or equal to 0.1 and less than or equal to 0.4. The ratio of the atomic ratio of aluminum Al to the atomic ratio of cobalt Co (Al/Co) at a peak of the aluminum concentration is preferably greater than or equal to 0.05 and less than or equal to 0.6, further preferably greater than or equal to 0.1 and less than or equal to 0.45.

According to results of the EDX line analysis, where the surface of the positive electrode active material 100 is can be estimated in the following manner, for example. A point where the detected amount of an element which uniformly exists in the inner portion 100c of the positive electrode active material 100, e.g., oxygen or cobalt, is ½ of the detected amount thereof in the inner portion 100c is used as the surface of the positive electrode active material 100.

Since the positive electrode active material 100 is a composite oxide, the detected amount of oxygen can be used to estimate where the surface is. Specifically, an average value Oₐᵥₑ of the oxygen concentration in a region of the inner portion 100c where the detected amount of oxygen is stable is calculated first. At this time, in the case where oxygen O_{bg} which is presumably led from chemical adsorption or the background is detected in a region that is obviously outside the surface, O_{bg} can be subtracted from the measurement value to obtain the average value Oₐᵥₑ of the oxygen concentration. The measurement point where the measurement value which is closest to ½ of the average value Oₐᵥₑ, i.e., Oₐᵥₑ₂, is obtained can be estimated to be the surface of the positive electrode active material 100.

The detected amount of cobalt can also be used to estimate where the surface of the positive electrode active material 100 is as in the above description. Alternatively, the sum of the detected amounts of the transition metals can be used for the estimation in a similar manner. The detected amount of the transition metal such as cobalt is less likely to be affected by chemical adsorption and thus is suitable for estimating where the surface is.

This embodiment can be used in combination with any of the other embodiments or an example.

### Embodiment 2

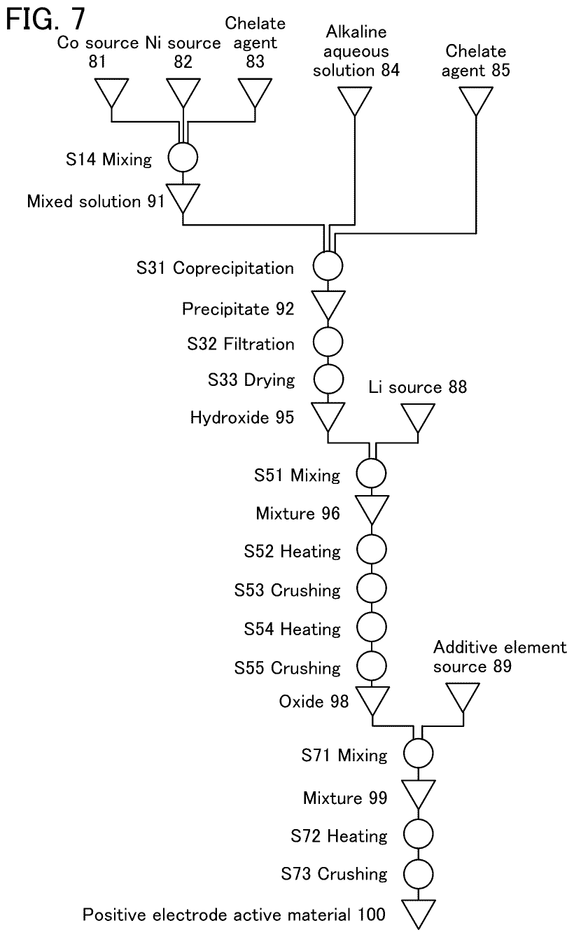

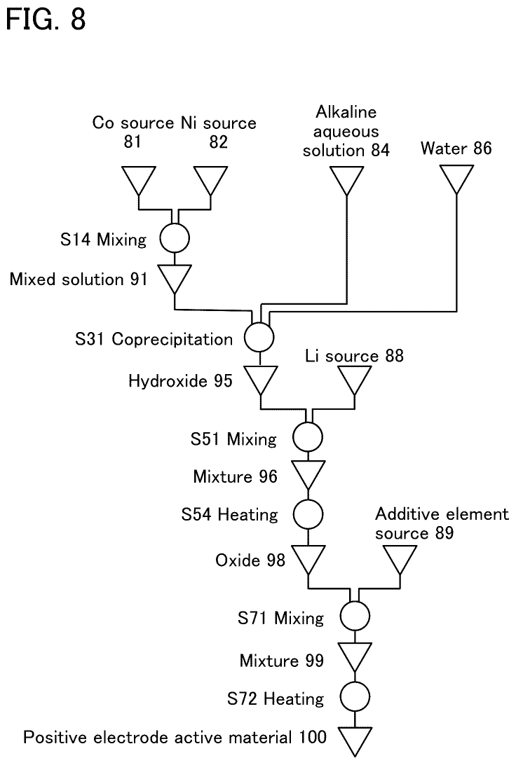

In this embodiment, a method for manufacturing the positive electrode active material 100 of one embodiment of the present invention is described with reference to flow charts shown in FIG. 7 and FIG. 8 and the like. FIG. 8 is a flowchart in which some steps in FIG. 7 are omitted, and is an example of a process with high productivity. The manufacturing methods shown in FIG. 7 and FIG. 8 each include a coprecipitation method, and thus are suitable for mass production. The coprecipitation method is a method in which a hardly-soluble salt is precipitated from an aqueous solution containing two or more metal ions when the ion concentration is in the oversaturated state. The coprecipitation method is preferable because a metal salt may be mixed highly uniformly in a precipitate as compared with the case of mixing solid materials.

### <Cobalt Source>

A cobalt source 81 (denoted as Co source in the drawings) is prepared as shown in FIG. 7 and FIG. 8. The cobalt source 81 is one of starting materials of the positive electrode active material. As the cobalt source 81, a compound containing cobalt (referred to as a cobalt compound) is used. As the cobalt compound, cobalt sulfate, cobalt chloride, cobalt nitrate, or a hydrate thereof can be used, for example. Alternatively, cobalt alkoxide or an organic cobalt complex may be used as the cobalt compound. Further alternatively, organic acid of cobalt, such as cobalt acetate, or a hydrate thereof may be used as the cobalt compound. Note that in this specification and the like, the organic acid includes citric acid, oxalic acid, formic acid, butyric acid, and the like, in addition to acetic acid.

In the case where a solution is used as the cobalt source 81, an aqueous solution containing the above cobalt compound (referred to as a cobalt aqueous solution) is prepared.

### <Nickel Source>

A nickel source 82 (denoted as Ni source in the drawings) is prepared as shown in FIG. 7 and FIG. 8. The nickel source 82 is one of starting materials of the positive electrode active material. As the nickel source 82, a compound containing nickel (referred to as a nickel compound) is used. As the nickel compound, nickel sulfate, nickel chloride, nickel nitrate, or a hydrate thereof can be used, for example. Alternatively, nickel alkoxide or an organonickel complex may be used as the nickel compound. Further alternatively, organic acid of nickel such as nickel acetate, or a hydrate thereof may be used as the nickel compound.

In the case where a solution is used as the nickel source 82, an aqueous solution containing the above nickel compound (referred to as a nickel aqueous solution) is prepared.

In the case where lithium cobalt oxide is obtained as the positive electrode active material 100, the proportion of nickel is preferably lower than the proportion of cobalt. For example, the cobalt source and the nickel source are prepared such that y in LiCo_{1-y}Ni_{y}O₂ is greater than 0 and less than or equal to 0.5, preferably greater than 0 and less than or equal to 0.1, further preferably greater than 0 and less than or equal to 0.05, still further preferably greater than 0 and less than or equal to 0.01.

In other words, the atomic ratio of nickel in the sum of the atomic ratio of cobalt and the atomic ratio of nickel is preferably greater than 0 and less than or equal to 0.5, further preferably greater than 0 and less than or equal to 0.1, still further preferably greater than 0 and less than or equal to 0.05, yet further preferably greater than 0 and less than or equal to 0.01, and the cobalt source and the nickel source are prepared such that the relation is satisfied. The atomic ratio of nickel in the sum of the atomic ratio of cobalt and the atomic ratio of nickel may be expressed as Ni/(Ni+Co), and may be rephrased as the proportion of nickel in the sum of cobalt and nickel. Note that the atomic ratios of cobalt and nickel prepared as starting materials as in this paragraph are not necessarily the same as the atomic ratios in the positive electrode active material 100.

Lithium may be excessively mixed in the positive electrode active material 100. In view of this, the ratio of lithium is not limited at all in the present invention. In other words, the composition in the case where the transition metal such as cobalt or nickel is M is not strictly limited to Li:M:O=1:1:2.

The positive electrode active material of the present invention may contain manganese, but it is further preferable that manganese be not substantially contained. The positive electrode active material not substantially containing manganese has many advantages such as relatively easy synthesis, easy handling, and excellent cycle performance. “Not substantially containing manganese” may be considered that the content is low in the positive electrode active material. Specifically, the manganese weight in the positive electrode active material is less than or equal to 600 ppm, further preferably less than or equal to 100 ppm.

### <Chelate Agent>

As shown in FIG. 7, a chelate agent 83 is prepared. Alternatively, the chelate agent 83 can be omitted, and FIG. 8 shows a flow chart in which the chelate agent 83 is not prepared, for example.

The chelate agent 83 is an aqueous solution in which a compound is dissolved, and the aqueous solution is referred to as a chelate aqueous solution. An aqueous solution in which glycine, oxine, 1-nitroso-2-naphthol, 2-mercaptobenzothiazole, or EDTA (ethylenediaminetetraacetic acid) as the above compound is dissolved, for example, and the aqueous solution is referred to as a chelate aqueous solution. Note that two or more kinds selected from glycine, oxine, 1-nitroso-2-naphthol, and 2-mercaptobenzothiazole may be used. As the solvent, water, preferably pure water, is used.

The chelate agent is preferred to a general complexing agent in terms of being a complexing agent to form a chelate compound. Needless to say, ammonia water or the like, which is a general complexing agent, may be used instead of the chelate agent.

The chelate agent is preferably used, in which case generation of unnecessary crystal nuclei is suppressed to promote crystal growth. Since generation of unnecessary crystal nuclei is suppressed to inhibit generation of fine particles, a hydroxide with good particle size distribution (this is referred to as a precursor in some cases) can be obtained. Furthermore, the use of the chelate agent can slow an acid-base reaction, so that the reaction gradually proceeds to form a nearly spherical hydroxide.

Using a glycine aqueous solution is preferable, which facilitates control of the pH of a solution in a reaction container in a coprecipitation reaction in Step S31 in FIG. 7 and FIG. 8. Furthermore, the concentration of glycine in the glycine aqueous solution is preferably greater than or equal to 0.05 mol/L and less than or equal to 0.5 mol/L, further preferably greater than or equal to 0.1 mol/L and less than or equal to 0.2 mol/L.

### <Pure Water>

The pure water used for the chelate aqueous solution is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities, and thus is preferably used for an acid-base reaction.

### <Step S14>

Next, Step S14 shown in FIG. 7 and FIG. 8 is described. In Step S14, the cobalt source 81 and the nickel source 82 are mixed. By the mixing in this step, a mixed solution 91 of the cobalt compound and the nickel compound is obtained. The cobalt compound and the nickel compound are dissolved in the mixed solution. As water in this step, the above-described pure water is preferably used. The mixed solution 91 is a solution showing acidity and can be referred to as an acidic solution.

### <Alkaline Aqueous Solution>

Next, an alkaline aqueous solution 84 shown in FIG. 7 and FIG. 8 is described.

For example, an aqueous solution containing sodium hydroxide, potassium hydroxide, lithium hydroxide, or ammonia is used as the alkaline aqueous solution 84, and the alkaline aqueous solution 84 is not limited to the aqueous solution as long as it functions as a pH adjuster. An aqueous solution in which two or more kinds selected from sodium hydroxide, potassium hydroxide, and lithium hydroxide are dissolved in water may be used, for example. The above pure water is preferably used as the water.

### <Chelate Agent (Filling Liquid)>

As shown in FIG. 7, a chelate agent 85 is prepared. For the chelate agent 85, a material similar to that for the above-described chelate agent 83 is used. Alternatively, the chelate agent 85 can be omitted, and FIG. 8 shows a flow chart in which the chelate agent 85 is not prepared, for example. Note that in the case of FIG. 8, it is preferable to put water 86, preferably pure water in the reaction container as a filling liquid.

A supplementary explanation of the chelate agent 85 shown in FIG. 7 is provided. The chelate agent 85 is preferably put in a reaction container used in Step S31 described later and may be referred to as a filling liquid or an adjustment liquid. In other words, the chelate agent 85 refers to an aqueous solution in an initial reaction state. When the chelate agent 85 is used here, as described above, generation of unnecessary crystal nuclei is suppressed to promote crystal growth; since generation of unnecessary crystal nuclei is suppressed to inhibit generation of fine particles, the effect is exhibited that a hydroxide with good particle size distribution can be obtained, or an acid-base reaction can be slowed and thus the reaction gradually proceeds to form a nearly spherical hydroxide.

### <Step S31>

Step S31 shown in FIG. 7 and FIG. 8 is described. In Step S31, the mixed solution 91 and the alkaline aqueous solution 84 are mixed in the reaction container. By the mixing in Step S31, the mixed solution 91 reacts with the alkaline aqueous solution 84 to form a hydroxide 95 as a precursor. The chemical reaction in Step S31 can be referred to as a neutralization reaction, an acid-base reaction, or a coprecipitation reaction. Through the above-described coprecipitation reaction, the composite hydroxide 95 containing cobalt and nickel as the transition metals M (simply referred to as the hydroxide 95) is precipitated. The hydroxide 95 can be referred to as the precursor of the positive electrode active material 100. The hydroxide 95 can also be referred to as a compound of cobalt and nickel, and thus is referred to as a cobalt-nickel compound in some cases.

In Step S31, a solution in the reaction container is preferably stirred with a stirring means. The stirring means includes a stirrer, an agitator blade, or the like. When the solution is stirred, the stirring is preferably performed at a rotational speed higher than or equal to 500 rpm and lower than or equal to 1500 rpm, preferably higher than or equal to 800 rpm and lower than or equal to 1200 rpm. Two to six agitator blades can be provided; for example, in the case where four agitator blades are provided, they may be placed in a cross shape seen from above.

Through the coprecipitation reaction in Step 31, nickel and cobalt can be uniformly mixed. That is, the hydroxide 95 in which nickel exists in the inner portion 100c can be obtained. The positive electrode active material 100 formed through such a hydroxide 95 can benefit from the effect of nickel.

Note that in the case where nickel is less likely to form a solid solution with cobalt or the case where later-described heat treatment or the like is performed, nickel may be unevenly distributed more likely in the surface portion 100a than in the inner portion 100c in the positive electrode active material 100. Even in the case where nickel exists in the surface portion 100a, the positive electrode active material 100 can benefit from the effect of nickel.

### <Reaction Conditions>

In the case where the mixed solution 91 and the alkaline aqueous solution 84 are made to react by the coprecipitation reaction, the pH of a solution in a reaction container is set to greater than or equal to 9 and less than or equal to 13, preferably greater than or equal to 9.8 and less than or equal to 12.5. The above range is preferable because a particle diameter of the hydroxide 95 can be large. When the pH is outside the above range, the productivity becomes low, and the obtained hydroxide 95 is likely to contain an impurity in some cases.

In the case where the mixed solution 91 is put into the reaction container and the alkaline aqueous solution 84 is dropped into the reaction container, the pH of the solution in the reaction container is preferably kept in the above range. Also in the case where the alkaline aqueous solution 84 is put into the reaction container and the mixed solution 91 is dropped thereinto, the pH of the solution in the reaction container is preferably kept in the above range.

The liquid delivery rate (also referred to as the dropping rate) of the mixed solution 91 or the alkaline aqueous solution 84 is preferably greater than or equal to 0.01 mL/min and less than or equal to 1 mL/min, further preferably greater than or equal to 0.1 mL/min and less than or equal to 0.8 mL/min in the case where 200 mL to 350 mL of the solution is in the reaction container. A tank for storing the mixed solution 91, the alkaline aqueous solution 84, or the like is equipped with a pump, and the dropping rate can be controlled with the pump. The dropping amount can also be controlled with the pump. The dropping rate may be changed in multiple stages; specifically, the dropping rate may be gradually increased.

The solution temperature in the reaction container is adjusted to be higher than or equal to 50° C. and lower than or equal to 90° C. It is preferable to start dropping after the solution temperature is checked. The above range is preferable because a particle diameter of the obtained hydroxide 95 can be large.

The reaction container preferably has an inert atmosphere. For example, in the case of a nitrogen atmosphere, a nitrogen gas is preferably introduced at a flow rate of 0.5 L/min or more and 1.2 L/min or less. Furthermore, a nitrogen gas may be introduced by bubbling into the liquid in the reaction container.

In the reaction container, a reflux condenser is preferably placed. The nitrogen gas can be released from the reaction container and water can be returned to the reaction container with use of the reflux condenser.

Through the above reaction, a precipitate 92 is obtained in the reaction container as a reaction product.

### <Step S32 and Step S33>

Filtration in Step S32 and a drying step in Step S33 shown in FIG. 7 are described. The precipitate 92 contains an impurity in addition to the hydroxide 95. Therefore, in order to collect the hydroxide 95, the filtration in Step S32 is preferably performed. Suction filtration or low-pressure filtration can be employed for the filtration. Other than filtration, centrifugation may be employed. In the case of using suction filtration, a reaction product precipitated in the reaction container is preferably washed with water (e.g., pure water) and then washed with an organic solvent with a low boiling point (e.g., acetone). The suction filtration is preferably performed a plurality of times. Note that as shown in FIG. 8, Step S32 is not necessarily performed.

It is preferable that the drying in Step S33 be further performed on a product generated after the filtration. For example, the drying is performed at higher than or equal to 60° C. and lower than or equal to 90° C. for longer than or equal to 0.5 hours and shorter than or equal to 20 hours, preferably longer than or equal to 12 hours and shorter than or equal to 20 hours. In this manner, the hydroxide 95 can be obtained. The drying is preferably performed in an atmosphere with little oxygen to achieve adequate drying. The adequate drying reduces impurities such as moisture or a hydroxy group in the hydroxide 95, which is preferable. Note that as shown in FIG. 8, Step S33 is not necessarily performed. For example, the drying is performed at higher than or equal to 60° C. and lower than or equal to 90° C. for longer than or equal to 0.5 hours and shorter than or equal to 20 hours, preferably longer than or equal to 12 hours and shorter than or equal to 20 hours. The drying is preferably performed in an atmosphere with little oxygen. In the case where the drying is performed in a vacuum, for example, a bell jar type vacuum apparatus including a container (referred to as a bell jar) the inside of which can be evacuated to a vacuum and a vacuum pump connected to the bell jar can be used. In the case where the drying is performed in a vacuum atmosphere, a vacuum drying furnace may be used, and the vacuum drying furnace includes a vacuum pump connected to the drying furnace. As the vacuum pump included in the bell jar type vacuum apparatus or the vacuum drying furnace, a dry pump, a turbomolecular pump, an oil rotary pump, a cryopump, or a mechanical booster pump can be used. The vacuum atmosphere in the bell jar type vacuum apparatus or the vacuum drying furnace includes an atmosphere where the pressure is reduced such that a differential pressure gauge of each apparatus becomes higher than or equal to −0.1 MPa and lower than −0.08 MPa. In the case where the drying is performed in a nitrogen atmosphere, a gas containing nitrogen is supplied into the container of the bell jar type vacuum apparatus or the vacuum drying furnace.

Note that heating may be performed instead of or in addition to the drying in Step S33. The heating temperature is preferably higher than or equal to 700° C. and lower than 1200° C., further preferably higher than or equal to 800° C. and lower than 1100° C., still further preferably higher than or equal to 900° C. and lower than 1000° C. The heating time can be longer than or equal to 1 hour and shorter than or equal to 100 hours, for example, and is preferably longer than or equal to 2 hours and shorter than or equal to 20 hours.

The hydroxide 95 obtained through such a process can be represented by Co_{1-y}Ni_{y}(OH)₂ and can also be referred to as nickel cobalt hydroxide. The hydroxide 95 may be a single particle or a secondary particle, and preferably has a large crystallite size.

### <Lithium Source>

Next, a lithium compound is prepared as a lithium source 88 (denoted as Li source in the drawings) shown in FIG. 7 and FIG. 8.

Lithium hydroxide, lithium carbonate, lithium oxide, or lithium nitrate is prepared as the lithium compound. In the positive electrode active material, the atomic ratio (Li) to the atomic ratio of cobalt (Co) (which is referred to as Li/Co) is preferably greater than or equal to 0.9 and less than or equal to 1.2, further preferably greater than or equal to 1.0 and less than or equal to 1.09. The lithium compound is weighed so that the above range is satisfied. It is preferable to use the hydroxide 95 in which moisture or a hydroxy group is reduced, in which case Li/Co is an appropriate value.

The lithium compound is preferably ground. For example, grinding is performed using a mortar for longer than or equal to 5 minutes and shorter than or equal to 15 minutes. The mortar is preferably made of a material that hardly releases an impurity; specifically, a mortar made of aluminum oxide (hereinafter referred to as alumina) with the purity of higher than or equal to 90%, preferably higher than or equal to 99% is preferably used. Alternatively, a wet grinding method using a ball mill or the like may be employed. In the wet grinding method, acetone or dehydrated acetone can be used for a solvent, and grinding is preferably performed at the rotational frequency greater than or equal to 200 rpm and less than or equal to 400 rpm for longer than or equal to 10 hours and shorter than or equal to 15 hours. The lithium compound after being ground may be made to pass through a sieve.

### <Step S51>

Step S51 shown in FIG. 7 and FIG. 8 is described. In Step S51, the hydroxide 95 and the lithium source 88 are mixed. After that, a mixed mixture 96 is obtained. An automatic mortar, a planetary centrifugal mixer, or the like is preferably used as a unit that mixes the hydroxide 95 and the lithium source 88.

When the hydroxide 95 and the lithium source 88 are ground at the same time as the mixing, a ball mill or a bead mill is preferably used as media. Alumina balls or zirconia balls can be used for the ball mill or the bead mill. The centrifugal force is applied to the media in the ball mill or the bead mill, and thus microparticulation becomes possible. Note that in the case where contamination from the media and the like might occur, it is preferable that the zirconia balls be used and a peripheral speed be preferably set to greater than or equal to 100 mm/sec and less than or equal to 2000 mm/sec.

A dry grinding method and a wet grinding method can be employed as a grinding method in which mixing and grinding can be performed at the same time. In a dry grinding method, grinding is performed in an inert gas or in air, and a particle can be ground to a particle diameter less than or equal to 3.5 μm, preferably less than or equal to 3 μm. In a wet grinding method, grinding is performed in a liquid, and a particle can be ground to a particle diameter less than or equal to 1 μm. That is, the wet grinding method is preferably used to obtain a small particle diameter.

In the above manner, the mixture 96 is obtained.

### <Step S52>

Here, a supplementary explanation of a heating step is provided with reference to Step S52 and Step S53 shown in FIG. 7.

Step S52 shown in FIG. 7 is described. The heating step may be performed a plurality of times, and in Step S52, heating is performed at a temperature higher than or equal to 400° C. and lower than or equal to 800° C. before Step S54 described later. The heating in Step S52 is performed at a lower temperature than that in Step S54 and thus referred to as temporary baking in some cases. By Step S52, gas components contained in the hydroxide 95 or the lithium source 88 are released in some cases. With the use of the material in which the gas components are released, an oxide 98 with few impurities can be obtained. However, as in FIG. 8, the oxide 98 can be obtained without the temporary baking in Step S52.

The heating atmosphere in Step S52 is preferably an atmosphere containing oxygen or an oxygen-containing atmosphere that is what is called dry air with little water (e.g., a dew point is lower than or equal to −50° C., and a dew point is preferably lower than or equal to −80° C.).

For example, in the case where the heating is performed at 700° C. for 10 hours, the temperature rising rate is preferably greater than or equal to 100° C./h and less than or equal to 20.0° C./h. The flow rate of dry air that can form a dry atmosphere is preferably greater than or equal to 3 L/min and less than or equal to 10 L/min. The temperature decreasing time from a specified temperature to room temperature is preferably longer than or equal to 10 hours and shorter than or equal to 50 hours. The temperature decreasing rate can be calculated from the temperature decreasing time or the like.

A crucible, a sagger, a setter, or a container used in the heating is preferably made of a material that hardly releases impurities. For example, a crucible made of alumina with a purity of 99.9% is preferably used. In the case of mass production, a sagger made of mullite cordierite (Al₂O₃, SiO₂, and MgO) is preferably used.

### <Step S55>

Step S53 shown in FIG. 7 is described. In Step S53, a crushing step is performed. For example, it is preferable to perform classification using a sieve with an aperture diameter of greater than or equal to 40 μm and less than or equal to 60 μm. However, as in FIG. 8, the oxide 98 can be obtained without performing the crushing step in Step S53.

### <Step S54>

Next, Step S54 shown in FIG. 7 and FIG. 8 is described. In Step S54, the mixture obtained through the crushing step in Step S53 is heated. Step S54 is referred to as main baking in some cases. In consideration of Step S52 and the like, there are a lot of heating steps, and they are sometimes referred to as first baking, second baking, and the like appropriately using ordinal numbers in order to be distinguished from each other.

In Step S54, the heating temperature is preferably higher than or equal to 700° C. and lower than 1200° C., further preferably higher than or equal to 800° C. and lower than 1100° C., still further preferably higher than or equal to 900° C. and lower than 1000° C. When an oxide 98 is formed through this heat treatment, heating is performed at a temperature at which at least interdiffusion between the hydroxide 95 and the lithium source 88 occurs.

The heating time in Step S54 can be longer than or equal to 1 hour and shorter than or equal to 100 hours, for example, and is preferably longer than or equal to 2 hours and shorter than or equal to 20 hours.

The heating atmosphere in Step S54 is preferably an atmosphere containing oxygen or an oxygen-containing atmosphere that is what is called dry air with little water (e.g., a dew point is lower than or equal to −50° C., and a dew point is preferably lower than or equal to −80° C.).

For example, in the case where the heating is performed at 750° C. for 10 hours, the temperature rising rate is preferably greater than or equal to 150° C./h and less than or equal to 250° C./h. The flow rate of dry air that can form a dry atmosphere is preferably greater than or equal to 3 L/min and less than or equal to 10 L/min. The temperature decreasing time from a specified temperature to room temperature is preferably longer than or equal to 10 hours and shorter than or equal to 50 hours. The temperature decreasing rate can be calculated from the temperature decreasing time or the like.

A crucible, a sagger, a setter, or a container used in the heating is preferably made of a material that hardly releases impurities. For example, a crucible made of alumina with a purity of 99.9% is preferably used. In the case of mass production, a sagger made of mullite cordierite (Al₂O₃, SiO₂, and MgO) is preferably used.

It is preferable to collect the heated materials after the materials are transferred from the crucible to a mortar in order to prevent impurities from entering the materials. The mortar is preferably made of a material that hardly releases impurities; specifically, a mortar made of alumina or zirconia with the purity of higher than or equal to 90%, preferably higher than or equal to 99% is preferably used.

### <Step S55>

Step S55 shown in FIG. 7 is described. In Step S55, a crushing step is performed. For example, it is preferable to perform classification using a sieve with an aperture diameter of greater than or equal to 40 μm and less than or equal to 60 μm. However, as in FIG. 8, the oxide 98 can be obtained without performing the crushing step in Step S55.

### <Composite Oxide>

The oxide 98 shown in FIG. 7 and FIG. 8 is described. The oxide 98 is formed through at least the heating in Step S54 and sometimes referred to as a composite oxide. The oxide 98 can also be used as the positive electrode active material 100.

### <Additive Element Source>

The additive element source 89 shown in FIG. 7 and FIG. 8 is described. As the additive element source 89, a compound containing one or two or more selected from magnesium, aluminum, calcium, zirconium, fluorine, vanadium, iron, manganese, chromium, niobium, arsenic, zinc, silicon, sulfur, phosphorus, boron, bromine, and beryllium is preferably used.

When the additive element is magnesium, the additive element source 89 can be referred to as a magnesium source. As the magnesium source, a compound containing magnesium is used. As the compound containing magnesium, for example, magnesium fluoride, magnesium oxide, magnesium hydroxide, magnesium carbonate, or the like can be used. Two or more of these magnesium sources may be used.

When the additive element is fluorine, the additive element source 89 can be referred to as a fluorine source. As the fluorine source, a compound containing fluorine is used. As the compound containing fluorine, it is possible to use lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, or sodium aluminum hexafluoride, for example. Among them, lithium fluoride, which has a relatively low melting point of 848° C., is preferable because it is easily melted in a heating step described later.

Magnesium fluoride can be used as both the fluorine source and the magnesium source. Lithium fluoride can be used as both the fluorine source and the lithium source.

The fluorine source may be a gas, and fluorine, carbon fluoride, sulfur fluoride, oxygen fluoride, or the like may be used and mixed in the atmosphere in a heating step described later. Two or more of these fluorine sources may be used.

When the additive element source 89 is prepared, two or more kinds of the additive elements can be used. For example, in the case where both lithium fluoride and magnesium fluoride are used to form the additive element source 89, the molar ratio of the lithium fluoride to the magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 and an approximate value thereof). Note that an approximate value means a value greater than 0.9 times and less than 1.1 times a certain value.

When two or more kinds of the additive element sources 89 are used, those additive element sources 89 are preferably mixed in advance. Mixing is performed by a method in which raw materials are mixed while being ground or a method in which raw materials are mixed without being ground. In the case of mixing the two or more kinds of the additive element sources 89 in advance, mixing while grounding is preferable. Particle diameters in the additive element source 89 can be uniform, and the particle diameters can be small.

Furthermore, when the additive element source 89 is collected after the mixing and the like, classification may be performed using a sieve with an aperture diameter of greater than or equal to 250 μm and less than or equal to 350 μm. The particle diameters can be uniform.

As the method in which mixing is performed while grinding, a dry grinding method or a wet grinding method is given. A wet grinding method is preferable because a particle diameter can be smaller than that in a dry grinding method. When wet grinding is performed, a solvent is prepared. As the solvent, ketone such as acetone, alcohol such as ethanol or isopropanol, ether, dioxane, acetonitrile, N-methyl-2-pyrrolidone (NMP), or the like can be used. Dehydrated acetone with purity higher than or equal to 99.5% is preferably used as the solvent. With the use of dehydrated acetone with the above-described purity, impurities that might be mixed can be reduced.

In the method in which mixing is performed while grinding, a medium of a ball mill, a bead mill, or the like can be used. Alumina balls or zirconia balls can be used as media of the ball mill or the bead mill. The centrifugal force is applied to the media in the ball mill and the bead mill, and thus microparticulation becomes possible. Note that in the case where contamination from the media and the like might occur, it is preferable that the zirconia balls be used and a peripheral speed be preferably set to greater than or equal to 100 mm/sec and less than or equal to 2000 mm/sec.

Although two kinds of the additive element sources 89 are prepared in the above, one kind or three or more kinds of the additive element sources may be mixed.

As the introduction method of the additive element source 89 into the oxide 98, a solid phase method, a liquid phase method such as a sol-gel method, a sputtering method, an evaporation method, a CVD (chemical vapor deposition) method, a PLD (pulsed laser deposition) method, or the like can be employed. This embodiment describes the case where a solid phase method is employed.

### <Step S71>

In Step S71 shown in FIG. 7 and FIG. 8, the additive element source 89 and the oxide 98 are mixed. After that, the mixture 99 is formed. As the mixing, dry mixing or wet mixing can be used. In mixing, the rotational frequency is preferably greater than or equal to 100 rpm and less than or equal to 200 rpm to prevent the oxide 98 from being broken.

### <Step S72>

Step S72 shown in FIG. 7 and FIG. 8 is described. In Step S72, the mixture 99 is heated.

Here, a supplementary explanation of the heating temperature is provided. The heating in Step S72 needs to be performed at a temperature higher than or equal to the temperature at which a reaction between the oxide 98 and the additive element source 89 proceeds. The temperature at which the reaction proceeds is the temperature at which interdiffusion between the oxide 98 and the additive element source 89 occurs, and may be lower than the melting temperatures of these materials. It is known that in the case of an oxide as an example, interdiffusion occurs at a temperature that is 0.757 times the melting temperature Tₘ (Tamman temperature T_{d}). Accordingly, it is only required that the heating temperature in Step S72 be higher than or equal to 500° C.

Needless to say, a temperature higher than or equal to the temperature at which part of the oxide 98 and the additive element source 89 is melted is preferable because the reaction proceeds easily. For example, when LiF and MgF₂ are contained as the additive element source 89, the heating is preferably performed at higher than or equal to 700° C. in Step S72. In particular, the eutectic point of LiF and MgF₂ is around 742° C., and thus the heating is preferably performed at higher than or equal to 742° C. in Step S72.

A higher heating temperature is preferable because it facilitates the reaction, shortens the heating time, and enables high productivity.

Note that the heating temperature is lower than the decomposition temperature of the oxide 98. In other words, the heating in Step S72 is preferably performed at a lower temperature than the heating in Step S52. The heating in Step S72 is preferably performed at a lower temperature than the heating in Step S54. At around the decomposition temperature, a slight amount of the oxide 98 might be decomposed. The melting point of lithium cobalt oxide is 1130° C., and vaporization of lithium, cation mixing of lithium and cobalt, and the like are likely to occur at approximately 1000° C., which is slightly lower than 1130° C.; the heating temperature is preferably lower than or equal to 1000° C., further preferably lower than or equal to 950° C., still further preferably lower than or equal to 900° C.

In view of the above, the heating temperature of the heating in Step S72 is preferably higher than or equal to 500° C. and lower than 1130° C., further preferably higher than or equal to 700° C. and lower than or equal to 1000° C., still further preferably higher than or equal to 700° C. and lower than or equal to 950° C., yet still further preferably higher than or equal to 700° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is higher than or equal to 800° C. and lower than or equal to 1130° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 99, the partial pressure of fluorine or a fluoride originating from the fluorine source or the like is preferably controlled to be within an appropriate range in the heating environment.

In this manufacturing method, LiF, which is the fluorine source, functions as flux in some cases. Owing to this function, the temperature of the heating in Step S72 can be lower than the decomposition temperature of the oxide 98, e.g., a temperature higher than or equal to 742° C. and lower than or equal to 950° C., which allows the additive element source to uniformly spread in the surface portion. As a result, the positive electrode active material 100 containing the additive element in the surface portion can be formed.

However, since LiF in a gas phase has a specific gravity less than that of oxygen, LiF might be sublimated by heating and the sublimation causes a reduction in the amount of LiF in the mixture 99. As a result, the function of flux deteriorates. Thus, heating needs to be performed while the sublimation of LiF is inhibited. Note that even when LiF is not used as the fluorine source or the like, Li at the surface of the oxide 98 and F of the fluorine source other than LiF might react to produce LiF, which might be sublimated. Therefore, the sublimation needs to be inhibited also when a fluoride having a higher melting point than LiF is used as the fluorine source other than LiF.

In order to inhibit the sublimation, there is a method in which the mixture 99 is heated in an atmosphere containing F. In the method, the atmosphere in the heating furnace where the mixture 99 is heated is made in a state where the partial pressure of LiF is high. In another method, a reaction container containing the mixture 99 is covered with a lid. By such a method and the like, the sublimation of LiF, i.e., the reduction of LiF, in the mixture 99 can be inhibited.

The heating in Step S72 can be performed by a roller hearth kiln. In the roller hearth kiln, the mixture 99 can be heated while moving in the kiln in a state where the container containing the mixture 99 is covered with a lid. Covering the container with a lid makes it possible to heat the mixture 99 in an atmosphere containing LiF, and inhibit the sublimation, i.e., the reduction, of LiF in the mixture 99.

Alternatively, the heating in Step S72 can be performed by a rotary kiln. In the rotary kiln, it is preferable that the atmosphere in the kiln contain oxygen, and heating be performed while controlling the flow rate of oxygen. In order to inhibit the sublimation, i.e., the reduction, of LiF in the mixture 99, the flow rate of oxygen is preferably set low. As a method to make the flow rate of oxygen low, there is a method in which oxygen is introduced in the kiln first and held for a certain period, and oxygen is not introduced after that, for example.

Such a process is considered to provide the positive electrode active material 100 with a smooth surface and little unevenness.

### <Step S73>

Next, Step S73 shown in FIG. 7 is described. In Step S73, a crushing step is performed. For example, it is preferable to perform classification using a sieve with an aperture diameter of greater than or equal to 40 μm and less than or equal to 60 μm. Adhesion of the particles can be inhibited. However, as in FIG. 8, the positive electrode active material 100 can be obtained without performing the crushing step in Step S73.

According to the above, the positive electrode active material 100 can be formed. The positive electrode active material 100 can reflect the shape of the hydroxide 95 that is the precursor. According to the above-described manufacturing method, lithium cobalt oxide containing nickel also in the inner portion can be obtained. Nickel that cannot form a solid solution diffuses into the surface portion of the lithium cobalt oxide in some cases. Furthermore, lithium cobalt oxide in which the additive element remains in the surface portion can be obtained. The additive element preferably forms a solid solution in the surface portion of the lithium cobalt oxide.

The lithium cobalt oxide is preferred in containing few impurities. However, sulfur might be detected from the lithium cobalt oxide, when a sulfide is used as a starting material. With use of GD-MS, ICP-MS, or the like, elements in the whole particle of the positive electrode active material can be analyzed to measure the sulfur concentration.

This embodiment can be combined with any of the other embodiments or an example as appropriate.

### Embodiment 3

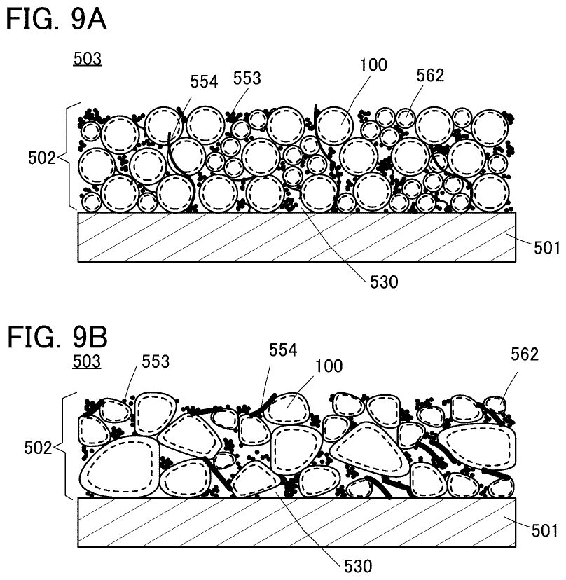

In this embodiment, examples of a secondary battery of one embodiment of the present invention are described with reference to FIG. 9.

### Structure Example 1 of Secondary Battery

Hereinafter, a secondary battery in which a positive electrode, a negative electrode, and an electrolyte solution are stored in an exterior body is described as an example.

### [Positive Electrode]

FIG. 9A shows an example of a cross-sectional view of a positive electrode 503 used for a secondary battery 500 described later, for example. The positive electrode 503 includes a positive electrode active material layer 502 over a positive electrode current collector 501. The positive electrode active material layer 502 includes the positive electrode active material 100, a positive electrode active material 562, a conductive material 553, a conductive material 554, and an electrolyte solution 530. The positive electrode active material layer 502 also includes a binder (not shown). The secondary battery may include either the conductive material 553 or the conductive material 554.

A median diameter (D50) of the positive electrode active material 100 is preferably greater than or equal to 1 μm and less than or equal to 50 μm, preferably greater than or equal to 5 μm and less than or equal to 30 μm. To increase the filling density, the positive electrode active material 562 with a different median diameter (D50) is preferably added. The median diameter (D50) of the positive electrode active material 562 is preferably 1/10 to ⅙ of the median diameter (D50) of the positive electrode active material 100. When particle size distribution measurement is performed on an active material in which the positive electrode active material 100 and the positive electrode active material 562 are mixed, two peaks with different local maximum values are observed. Needless to say, two or more peaks may be observed. Note that the filling density can be increased without the positive electrode active material 562.

Each of the positive electrode active material 100 and the positive electrode active material 562 preferably includes a shell. A positive electrode active material that includes a shell can have a good insulating property and inhibits thermal runaway. Although the boundary between a surface portion and an inner portion is indicated by a dotted line in FIG. 9A, the boundary is not always as clear as that in FIG. 9A.

The active material of the positive electrode active material 100 may be the same as or different from the active material of the positive electrode active material 562. The same active materials contain the same main material but may be different in the presence of an additive element or the like. The different active materials contain different main materials.

As already described above, it is preferable that the positive electrode active material 100 and the positive electrode active material 562 contain an additive element. The additive element may be unevenly distributed or may be distributed in the inner portion to have a low concentration. The uneven distribution means uneven or localized presence of the additive element. Therefore, a state where the concentration of the additive element increases from an inner portion towards a shell is sometimes referred to as uneven distribution of the additive element in the shell. Uneven distribution may be expressed as segregation.

The surface portion may contain the additive element. The additive element concentration in the surface portion is preferably different from the additive element concentration in the inner portion. The additive element concentration in the surface portion is preferably higher than the additive element concentration in the inner portion. This state is sometimes described as uneven distribution of the additive element in the surface portion. Uneven distribution may be expressed as segregation or precipitation.

Although sometimes referred to as positive electrode active material particles, the positive electrode active material 100 and the positive electrode active material 562 are in any of a variety of forms other than a particle form. Unlike FIG. 9A, FIG. 9B illustrates the positive electrode 503 including a positive electrode active material in a form other than a particle form. The positive electrode active material in FIG. 9B is the same as that in FIG. 9A except for its form and thus is not described.

Although the positive electrode active material 100 and the positive electrode active material 562 are illustrated as primary particles in FIG. 9A and FIG. 9B, they may be secondary particles.

The positive electrode includes a positive electrode active material layer and a positive electrode current collector. The positive electrode active material layer includes a positive electrode active material, and may include a conductive material (can be rephrased as a conductive additive) and a binder. As the positive electrode active material, the positive electrode active material formed by the formation method described in the above embodiment can be used, and for example, a mixture of a positive electrode active material having a relatively small median diameter (D50) and a positive electrode active material having a relatively large median diameter (D50) may be used.

The positive electrode active material of one embodiment of the present invention and another positive electrode active material may be mixed to be used.

Examples of the another positive electrode active material include a composite oxide having an olivine crystal structure, a composite oxide having a layered rock-salt crystal structure, and a composite oxide having a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the another positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, further preferably nickel. In the case where the whole lithium-manganese composite oxide particle is measured, it is preferable to satisfy the following at the time of discharging: 0<a/(b+c)<2; c>0; and 0.26≤(b+c)/d<0.5 (note that a, b, c, and dare not 0). Note that the proportions of metals, silicon, phosphorus, and the like in the whole lithium-manganese composite oxide particle can be measured with, for example, an ICP-MS (inductively coupled plasma mass spectrometer). The proportion of oxygen in the whole lithium-manganese composite oxide particle can be measured by, for example, EDX. Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain one or two or more selected from a group consisting of chromium, cobalt, aluminum, nickel, iron, magnesium, molybdenum, zinc, indium, gallium, copper, titanium, niobium, silicon, phosphorus, and the like.

### [Conductive Material]

The conductive material has a function of giving aid to, for example, a current path between the active material and the current collector or a current path between a plurality of active materials. In order to have such a function, the conductive material preferably contains a material having lower resistance than the active material. The conductive material is also referred to as a conductive additive or a conductivity-imparting agent because of its function.

As the conductive material, a carbon material or a metal material is typically used. The conductive material is in a particle form; examples of the particulate conductive material include carbon black (e.g., furnace black, acetylene black, or graphite). Carbon black mostly has a smaller particle diameter than the positive electrode active material. The conductive material is in a fibrous form; examples of the fibrous conductive additive include carbon nanotube (CNT) and VGCF (registered trademark). Other conductive materials are in a sheet form; examples of the sheet-shaped conductive additive include multilayer graphene. The sheet-shaped conductive additive sometimes looks like a thread in observation of a cross section of a positive electrode.

The particulate conductive material can enter a gap of the positive electrode active material or the like and easily aggregates. Thus, the particulate conductive material can give aid to a conductive path between positive electrode active materials provided close to each other. Although having a bent region, the fibrous conductive material is larger than the positive electrode active material. The fibrous conductive material can thus give aid not only to a conductive path between adjacent positive electrode active materials but also to a conductive path between positive electrode active materials located apart from each other. Conductive additives in two or more forms as described above are preferably mixed.

In the case of using multilayer graphene as the sheet-shaped conductive material and carbon black as a particulate conductive material, the weight of the carbon black is preferably 1.5 times to 20 times, further preferably 2 times to 9.5 times the weight of the multilayer graphene in the state of slurry where these are mixed.

When the mixing ratio between multilayer graphene and carbon black is in the above-described range, carbon black does not aggregate and is easily dispersed. When the mixing ratio between multilayer graphene and carbon black is in the above range, the electrode density can be higher than when only carbon black is used as a conductive additive. As the electrode density is higher, the capacity per unit weight can be higher.

Moreover, when the mixing ratio between multilayer graphene and carbon black is in the above-described range, fast charging is possible.

Graphene in this specification and the like refers to multilayer graphene and multi graphene. In other words, graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound also refers to graphene oxide, multilayer graphene oxide, multi graphene oxide, reduced graphene oxide, reduced multilayer graphene oxide, reduced multi graphene oxide, graphene quantum dots, and the like. That is, a graphene compound may include a functional group. Graphene or a graphene compound is preferably bent. Graphene or a graphene compound may be rolled, and rolled graphene is referred to as a carbon nanofiber in some cases.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

As a graphene compound, fluorine-containing graphene may be used. Fluorine in the graphene compound is preferably adsorbed on a surface. Fluorine-containing graphene can be formed by making graphene and a fluorine compound contact with each other (which is called fluorination treatment). For the fluorination treatment, fluorine (F₂) or a fluorine compound is preferably used. The fluorine compound is preferably hydrogen fluoride, halogen fluoride (e.g., ClF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. For the fluorination treatment, a gaseous fluoride is preferably used, and the gaseous fluoride may be diluted with an inert gas. The fluorination treatment is preferably performed at room temperature or in a temperature range higher than or equal to 0° C. and lower than or equal to 250° C., which includes the room temperature. Performing the fluorination treatment at higher than or equal to 0° C. enables adsorption of fluorine onto a surface of graphene.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, by using a graphene compound as the conductive material, the area where the active material and the conductive material are in contact with each other can be increased. The graphene compound preferably covers 80% or more of the area of the active material. Note that the graphene compound preferably clings to at least part of an active material particle. The graphene compound preferably overlays at least part of the active material particle. The shape of the graphene compound preferably conforms to at least part of the shape of the active material particle. The shape of an active material particle means, for example, an uneven surface of a single active material particle or an uneven surface formed by a plurality of active material particles. The graphene compound preferably surrounds at least part of an active material particle. The graphene compound may have a hole.

In the case where active material particles with a small diameter, e.g., active material particles with a diameter of 1 μm or less, are used, the specific surface area of the active material particles is large and thus more conductive paths for connecting the active material particles are needed. In such a case, it is particularly preferable to use a graphene compound that can efficiently form a conductive path even with a small amount.

It is particularly effective to use a graphene compound, which has the above-described properties, as a conductive material of a secondary battery that needs to be rapidly charged and rapidly discharged. For example, a secondary battery for a two-wheeled or four-wheeled vehicle, a secondary battery for a drone, or the like is required to be rapidly charged and rapidly discharged in some cases. In addition, a mobile electronic device or the like is required to have fast charge characteristics in some cases. Fast charging and discharging are referred to as charging and discharging at, for example, 200 mA/g, 400 mA/g, or 1000 mA/g or more.

In the active material layer, sheet-shaped graphene or a graphene compound is preferably dispersed uniformly. A plurality of sheets of graphene or a plurality of graphene compounds are formed to partly cover the plurality of active materials or adhere to the surfaces of the plurality of particulate active materials, so that the plurality of sheets of graphene or the plurality of graphene compounds make surface contact with each other.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and the electrode weight. That is to say, the discharge capacity of the secondary battery can be increased.

Here, it is preferable to perform reduction after the active material layer is formed in such a manner that graphene oxide is used as the graphene or the graphene compound and mixed with an active material. That is, the formed active material layer preferably contains reduced graphene oxide. When graphene oxide with extremely high dispersibility in a polar solvent is used for the formation of the graphene or the graphene compound, the graphene or the graphene compound can be substantially uniformly dispersed in the active material layer. The solvent is removed by volatilization from a dispersion medium in which graphene oxide is uniformly dispersed, and the graphene oxide is reduced; hence, the sheets of graphene or the graphene compounds remaining in the active material layer partly overlap with each other and are dispersed such that surface contact is made, thereby forming a three-dimensional conduction path. Note that graphene oxide can be reduced by heat treatment or with the use of a reducing agent, for example.

Unlike a particulate conductive material, such as acetylene black, which makes point contact with an active material, the graphene or the graphene compound is capable of making low-resistance surface contact; accordingly, the electrical conduction between the positive electrode active material with a small amount compared with a normal conductive material and the graphene or the graphene compound can be improved.

It is possible to form, with a spray dry apparatus, a graphene compound serving as a conductive material as a coating portion to cover the entire surface of the active material in advance and to form a conductive path between the active materials using the graphene compound.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

As the conductive material, acetylene black (referred to as AB) can be used instead of graphene. Fluorine-containing acetylene black may be used. Fluorine in the fluorine-containing acetylene black is preferably adsorbed on a surface. Fluorine-containing acetylene black can be formed by making acetylene black and a fluorine compound contact with each other (which is called fluorination treatment). For the fluorination treatment, the contents of the description on graphene can be referred to for acetylene black.

As the conductive material, a carbon fiber material (referred to as carbon nanotube or CNT) can be used instead of graphene and acetylene black. A fluorine-containing carbon nanotube may be used. Fluorine in the fluorine-containing carbon nanotube is preferably adsorbed on a surface. A fluorine-containing carbon nanotube can be formed by making a carbon nanotube and a fluorine compound contact with each other (which is called fluorination treatment). For the fluorination treatment, the contents of the description on graphene can be referred to for carbon nanotube.

### [Binder]

The binder, which does not cover the entire surface of the active material, is necessary for enhancing adhesion of the active material in powder form. The binder needs to have a property of adhering to the current collector. In other words, the binder preferably contains a material containing an adhering component. Furthermore, it is preferable that the binder be sufficiently flexible and resilient to a change in the state of the active material, in view of expansion of the active material. The binder also needs to be compatible with the electrolyte solution. Moreover, since a secondary battery involves an extremely strong oxidation reaction and an extremely strong reduction reaction, it is desirable that the binder do not deteriorate due to the reactions or be less reactive to the reactions.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers the active material surface or is in contact with the surface forms a film, the film is expected to serve also as a passivation film to suppress the decomposition of the electrolyte solution. Here, a passivation film refers to a film without electrical conductivity or a film with extremely low electrical conductivity, and can inhibit the decomposition of an electrolyte solution at a potential at which a battery reaction occurs when the passivation film is formed on the active material surface, for example. It is desirable that the passivation film can conduct lithium ions while suppressing electrical conduction.

### [Positive Electrode Current Collector]

For the positive electrode current collector, a material that has high conductivity, such as a metal like stainless steel, gold, platinum, aluminum, or titanium, or an alloy thereof can be used. It is preferable that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may also be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements enable higher charge and discharge capacity than carbon; in particular, silicon has a high theoretical capacity of 4200 mAh/g per weight of the active material. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N enables high charge and discharge capacity (900 mAh/g per weight of the active material), and thus is preferable.

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorine compounds such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte Solution]

The electrolyte solution contains a solvent and a lithium salt. As the solvent of the electrolyte solution, an aprotic organic solvent is preferable. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these can be used in an appropriate combination at an appropriate ratio.

When ethylene carbonate (EC) and diethyl carbonate (DEC) are contained as the electrolyte solution, it is possible to use a mixed organic solvent in which the volume ratio between EC and DEC is x:100-x (where 20≤x≤40) on the assumption that the total content of EC and DEC is 100 vol %. More specifically, a mixed organic solvent containing EC and DEC at EC:DEC=30:70 (volume ratio) can be used.

In the case where ethylene carbonate (EC), ethyl methyl carbonate (EMC), and dimethyl carbonate (DMC) are contained in the electrolyte solution, it is possible to use a mixed organic solvent in which the volume ratio between ethylene carbonate, ethyl methyl carbonate, and dimethyl carbonate is x:y:100-x-y (where 5×35 and 0<y<65) on the assumption that the total content of ethylene carbonate, ethyl methyl carbonate, and dimethyl carbonate is 100 vol %. More specifically, a mixed solvent containing EC, EMC, and DMC at EC:EMC:DMC=30:35:35 (volume ratio) can be used.

Furthermore, as the electrolyte solution, a mixed organic solvent containing a fluorinated cyclic carbonate or a fluorinated linear carbonate can be used. The above mixed organic solvent further preferably contains both a fluorinated cyclic carbonate and a fluorinated chain carbonate. A fluorinated cyclic carbonate and a fluorinated chain carbonate are preferable because they each include a substituent with an electron-withdrawing property and have a low solvation energy of a lithium ion. Accordingly, a fluorinated cyclic carbonate and a fluorinated chain carbonate are each suitable for the electrolyte solution, and a mixed organic solvent containing either of them is suitable.

As a fluorinated cyclic carbonate, fluorinated ethylene carbonate (also referred to as fluoroethylene carbonate, FEC, or F1EC in some cases), difluoroethylene carbonate (also referred to as DFEC or F2EC in some cases), trifluoroethylene carbonate (also referred to as F3EC in some cases), or tetrafluoroethylene carbonate (also referred to as F4EC in some cases) or the like can be used. Note that DFEC has isomers such as a cis-4,5 isomer and a trans-4,5 isomer. Each of these fluorinated cyclic carbonates includes a substituent with an electron-withdrawing property and thus is presumed to have a low solvation energy of a lithium ion. The substituent with an electron-withdrawing property in FEC is an F group.

An example of the fluorinated chain carbonate is methyl 3,3,3-trifluoropropionate. An abbreviation of methyl 3,3,3-trifluoropropionate is “MTFP”. The substituent with an electron-withdrawing property in MTFP is a CF₃ group.

FEC, which is a cyclic carbonate, has a high dielectric constant and thus has an effect of promoting dissociation of a lithium salt when used in an organic solvent. Furthermore, it can be said that since FEC includes a substituent having an electron-withdrawing property, a lithium ion is desolvated with FEC more easily than with ethylene carbonate (EC), which does not include a substituent having an electron-withdrawing property. Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. Meanwhile, FEC disadvantageously has high viscosity. In view of this, a mixed organic solvent containing not only FEC but also MTFP is preferably used for the electrolyte solution. MTFP, which is a linear carbonate, can have an effect of reducing the viscosity of the electrolyte solution or maintaining the viscosity at room temperature (typically, 25° C.) even at low temperatures (typically, 0° C.). Moreover, MTFP has a lower solvation energy than methyl propionate (abbreviated as “MP”), which does not include a substituent with an electron-withdrawing property, but may solvate a lithium ion when used for the electrolyte solution.

FEC and MTFP having the above-described physical properties may be mixed in the ratio of x:100-x (where 5≤x≤30, preferably 10≤x≤20) on the assumption that a mixed organic solvent containing FEC and MTFP accounts for 100 vol %. In other words, MTFP and FEC are preferably mixed such that the amount of MTFP is larger than that of FEC in the mixed organic solvent.

The use of one or more kinds of ionic liquids (room temperature molten salts) which have features of non-flammability and non-volatility as the solvent of the electrolyte solution can prevent a secondary battery from exploding and/or igniting, for example, even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### [Lithium Salt]

As a lithium salt (also referred to as an electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more kinds of these can be used in an appropriate combination in an appropriate ratio. The lithium salt is preferably greater than or equal to 0.5 mol/L and less than or equal to 3.0 mol/L with respect to the solvent. Using a fluoride such as LiPF₆ or LiBF₄ enables a lithium-ion secondary battery to have improved safety.

As the above-described electrolyte solution, it is preferable to use a highly purified electrolyte solution containing small contents of dust particles or elements other than the constituent elements of the electrolyte solution (hereinafter, also simply referred to as “impurities”). Specifically, the weight ratio of impurities to the electrolyte solution is preferably less than or equal to 1 wt %, further preferably less than or equal to 0.1 wt %, still further preferably less than or equal to 0.01 wt %.

### [Additive Agent]

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC or LiBOB is particularly preferable because it facilitates formation of a favorable coating portion.

### [Gel Electrolyte]

A polymer gel obtained in a manner in which a polymer is swelled with an electrolyte solution may be used as a gel electrolyte. When a polymer gel electrolyte is used, a semisolid electrolyte layer can be provided, so that safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator during charging with a high voltage and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. An aluminum-containing film having a three-layer structure is sometimes referred to as an aluminum laminate film.

### Structure example 2 of Secondary Battery

### [Solid Electrolyte]

Instead of the electrolyte solution, a solid electrolyte including an inorganic material such as a sulfide-based or oxide-based inorganic material, a solid electrolyte including a high-molecular material such as a PEO (polyethylene oxide)-based high-molecular material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

A structure of a secondary battery including a solid electrolyte layer is described below as another structure example of a secondary battery.

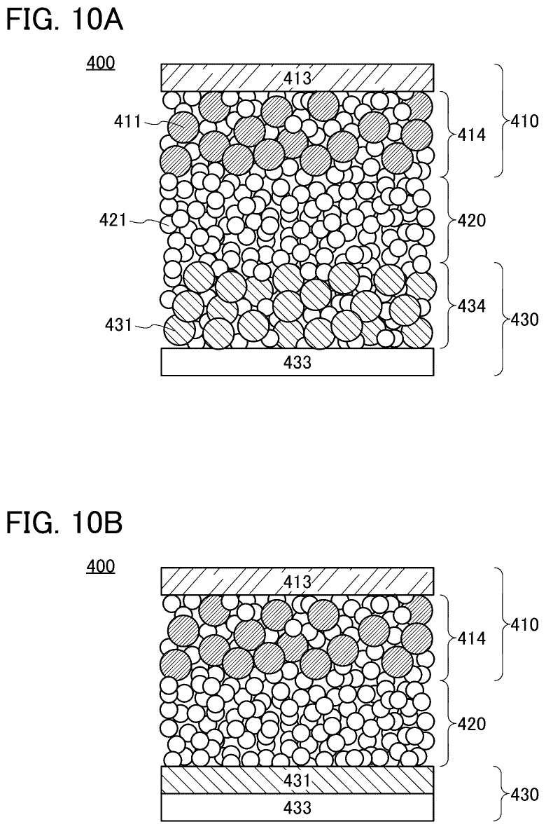

As illustrated in FIG. 10A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material manufactured by the manufacturing method described in the above embodiment is used. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used for the negative electrode 430, it is possible that the negative electrode 430 does not include the solid electrolyte 421 as illustrated in FIG. 10B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1+X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

This embodiment can be used in combination with any of the other embodiments or an example as appropriate.

### Embodiment 4

In this embodiment, examples of the shape of a secondary battery including the positive electrode formed by the formation method described in the above embodiment will be described.

### [Coin-Type Secondary Battery]

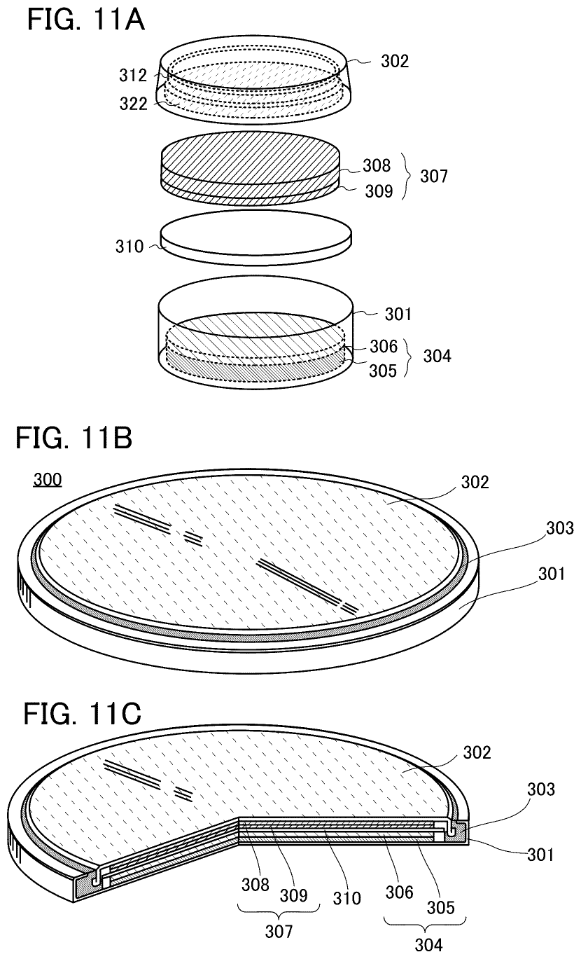

An example of a coin-type secondary battery is described. FIG. 11A is an exploded perspective view of a coin-type (single-layer flat type) secondary battery, FIG. 11B is an external view thereof, and FIG. 11C is a cross-sectional view thereof. Coin-type secondary batteries are mainly used in small electronic devices.

For easy understanding, FIG. 11A is a schematic view illustrating overlap (a vertical relation and a positional relation) between components. Thus, FIG. 11A and FIG. 11B do not completely correspond with each other.

In FIG. 11A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 11A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 11B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 11C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high discharge capacity and excellent cycle performance.

### [Cylindrical Secondary Battery]

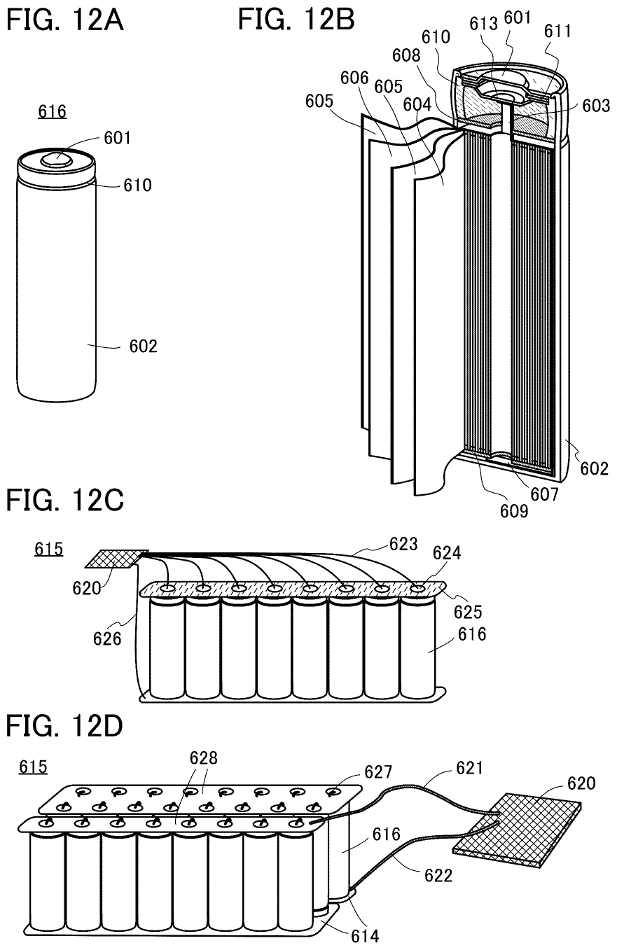

An example of a cylindrical secondary battery is described with reference to FIG. 12A. As illustrated in FIG. 12A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 12B is a diagram schematically illustrating a cross section of a cylindrical secondary battery. The cylindrical secondary battery illustrated in FIG. 12B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not shown) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

The positive electrode active material 100 of one embodiment of the present invention is used for the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. For the positive electrode terminal 603, a metal material such as aluminum can be used. For the negative electrode terminal 607, a metal material such as copper can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element 611.

FIG. 12C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 12D shows an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 12D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

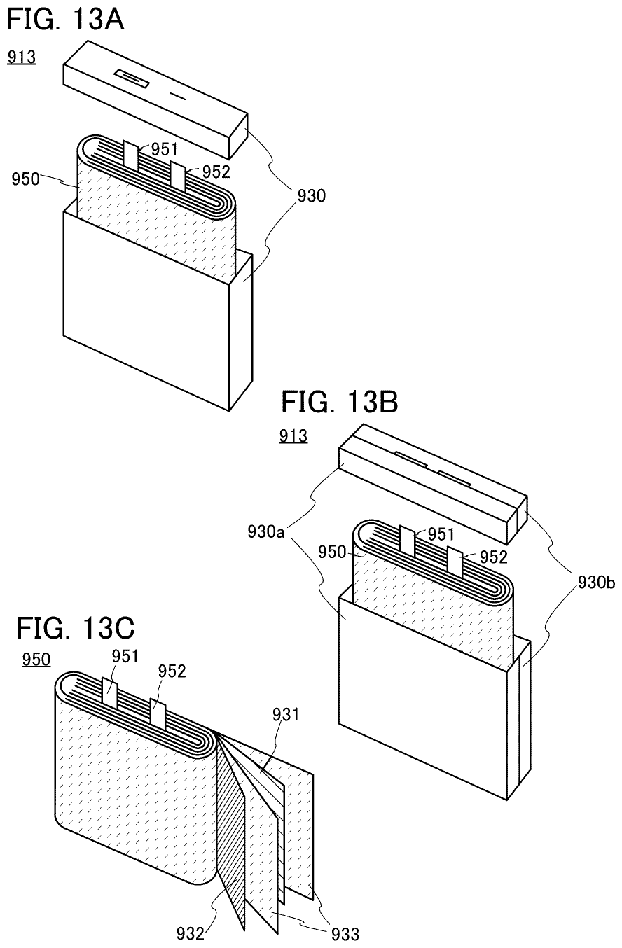

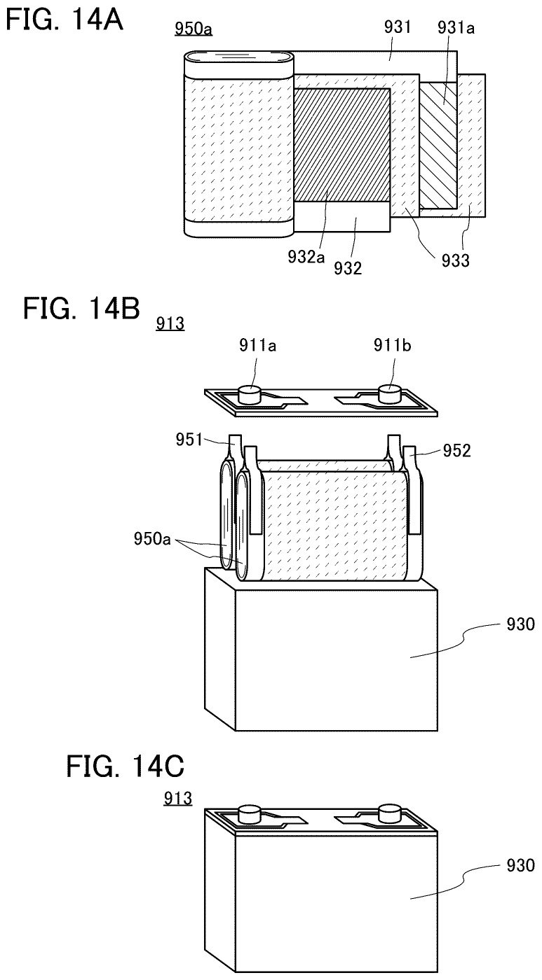

Other structure examples of secondary batteries are described with reference to FIG. 13 and FIG. 14.

A secondary battery 913 illustrated in FIG. 13A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 13A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 13B, the housing 930 illustrated in FIG. 13A may be formed using a plurality of materials. For example, in the secondary battery 913 illustrated in FIG. 13B, a housing 930a and a housing 930b are attached to each other, and the wound body 950 is provided in a region surrounded by the housing 930a and the housing 930b.

For the housing 930a, a metal material (e.g., aluminum) or a stack of a metal material and a resin material can be used. In particular, when an insulating material such as an organic resin is placed on the side on which an antenna is formed, blocking of an electric field by the secondary battery 913 can be inhibited. When an electric field is not significantly blocked by the housing 930a, an antenna may be provided inside the housing 930a. For the housing 930b, a metal material (e.g., aluminum) or a stack of a metal material and a resin material can be used.

FIG. 13C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 14, the secondary battery 913 may include a wound body 950a. The wound body 950a illustrated in FIG. 14A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 of one embodiment of the present invention is used for the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 14B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 14C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 14B, the secondary battery 913 may include a plurality of wound bodies 950a. The use of the plurality of wound bodies 950a enables the secondary battery 913 to have higher discharge capacity. The description of the secondary battery 913 illustrated in FIG. 13A and FIG. 13B can be referred to for the other components of the secondary battery 913 illustrated in FIG. 14B and FIG. 14C.

### <Laminated Secondary Battery>

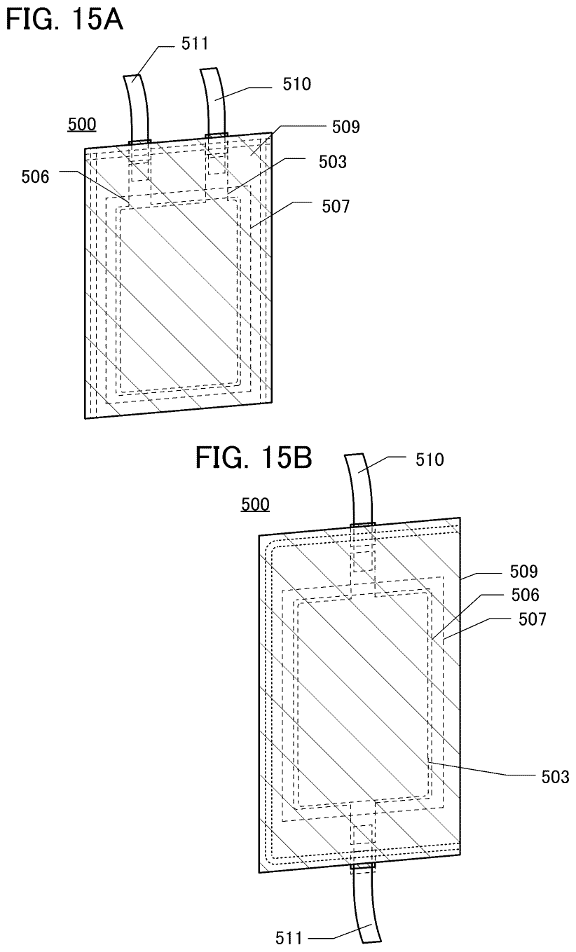

Next, examples of the appearance of a laminated secondary battery are shown in FIG. 15A and FIG. 15B. As illustrated in FIG. 15A and FIG. 15B, a laminated secondary battery 500 includes a positive electrode 503, a negative electrode 506, a separator 507, an exterior body 509, a positive electrode lead electrode 510, and a negative electrode lead electrode 511.

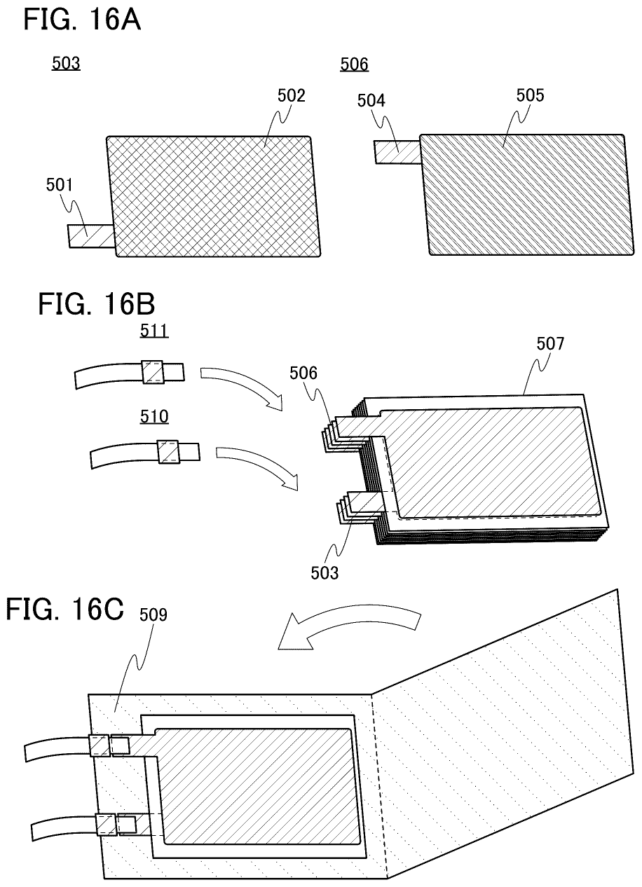

FIG. 16A illustrates the appearance of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode 503 and the negative electrode 506 are not limited to the examples shown in FIG. 15A.

### <Fabrication Method of Laminated Secondary Battery>

An example of a method for fabricating the laminated secondary battery 500 whose external view is illustrated in FIG. 15A is described with reference to FIG. 16B and FIG. 16C.

First, the negative electrode 506, the separator 507, and the positive electrode 503 are stacked. FIG. 16B illustrates the negative electrodes 506, the separators 507, and the positive electrodes 503 that are stacked. Here, an example in which five negative electrodes 506 and four positive electrodes 503 are used is shown. The stacked negative electrodes 506, separators 507, and positive electrodes 503 can be referred to as a stack. Next, the tab regions of the positive electrodes 503 are bonded to each other, and the positive electrode lead electrode 510 is bonded to the tab region of the positive electrode 503 on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode 506 on the outermost surface.

Next, the above-described stack is placed over the exterior body 509 as illustrated in FIG. 16C.

Subsequently, the exterior body 509 is folded along a portion shown by a dashed line, as illustrated in FIG. 16C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 of one embodiment of the present invention is used for the positive electrode 503, whereby the secondary battery 500 can have high capacity, high discharge capacity, and excellent cycle performance.

This embodiment can be used in combination with any of the other embodiments or an example as appropriate.

### Embodiment 5

In this embodiment, examples of vehicles each including the secondary battery of one embodiment of the present invention will be described.

Mounting the secondary battery of one embodiment of the present invention on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

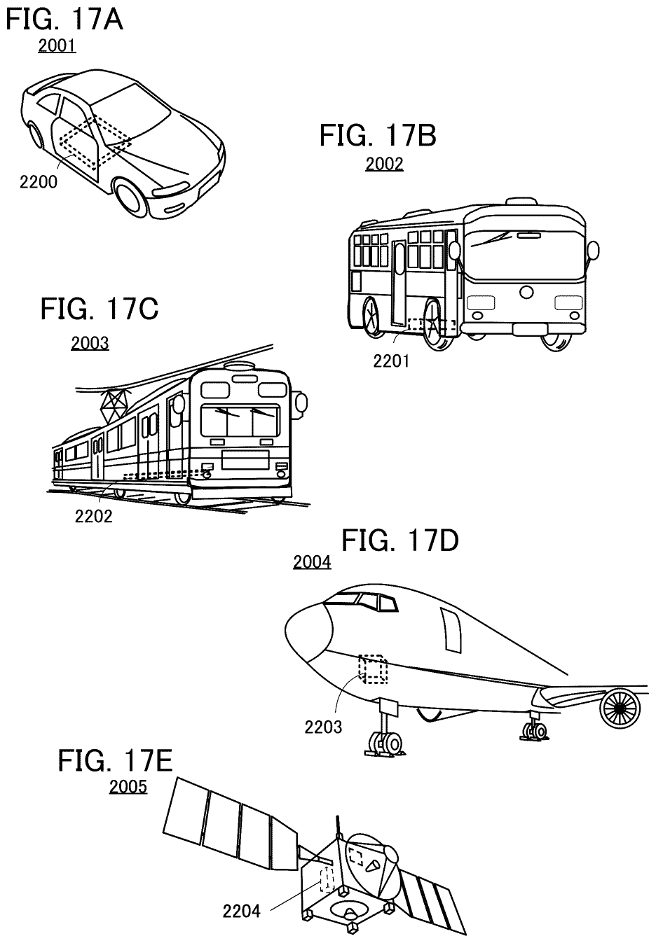

FIG. 17A to FIG. 17D show examples of transport vehicles using one embodiment of the present invention. An automobile 2001 illustrated in FIG. 17A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 4 is provided at one position or several positions. The automobile 2001 illustrated in FIG. 17A includes a battery pack 2200, and the battery pack 2200 includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. Charging equipment may be a charge station provided in a commerce facility or a household power supply. For example, with use of the plug-in system, the power storage device mounted on the automobile 2001 can be charged by being supplied with electric power from the outside. Charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 17B illustrates a large transporter 2002 having a motor controlled by electricity as an example of a transport vehicle. The transporter 2002 includes a battery pack 2201, and the battery pack 2201 includes a secondary battery module in which a plurality of secondary batteries are connected to each other. The secondary battery module of the transporter 2002 has a cell unit of four secondary batteries with a nominal voltage of 3.0 V or higher and 5.0 V or lower, and 48 cells are connected in series to have 170 V as the maximum voltage. The battery pack 2201 has the same function as that in FIG. 17A except for, for example, the number of secondary batteries configuring the secondary battery module; thus, the description is omitted.

FIG. 17C illustrates a large transport vehicle 2003 having a motor controlled by electricity as an example. The transport vehicle 2003 includes a battery pack 2202, and the battery pack 2202 includes a secondary battery module in which a plurality of secondary batteries are connected to each other. The secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1, 2, and the like for the positive electrode, a secondary battery having stable battery characteristics can be manufactured and mass production at low cost is possible in light of the yield.

FIG. 17D illustrates an aircraft 2004 having a combustion engine as an example. The aircraft 2004 illustrated in FIG. 17D can be regarded as a portion of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, and the maximum voltage is 32 V, for example. The battery pack 2203 has the same function as that in FIG. 17A except for, for example, the number of secondary batteries configuring the secondary battery module; thus, the description is omitted.

FIG. 17E illustrates an artificial satellite 2005 including a secondary battery 2204 as an example. Since the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member.

This embodiment can be used in combination with any of the other embodiments or an example as appropriate.

### Embodiment 6

In this embodiment, examples in which the lithium-ion battery of one embodiment of the present invention is mounted on a motorcycle and a bicycle will be described as examples of mounting a secondary battery in a vehicle.

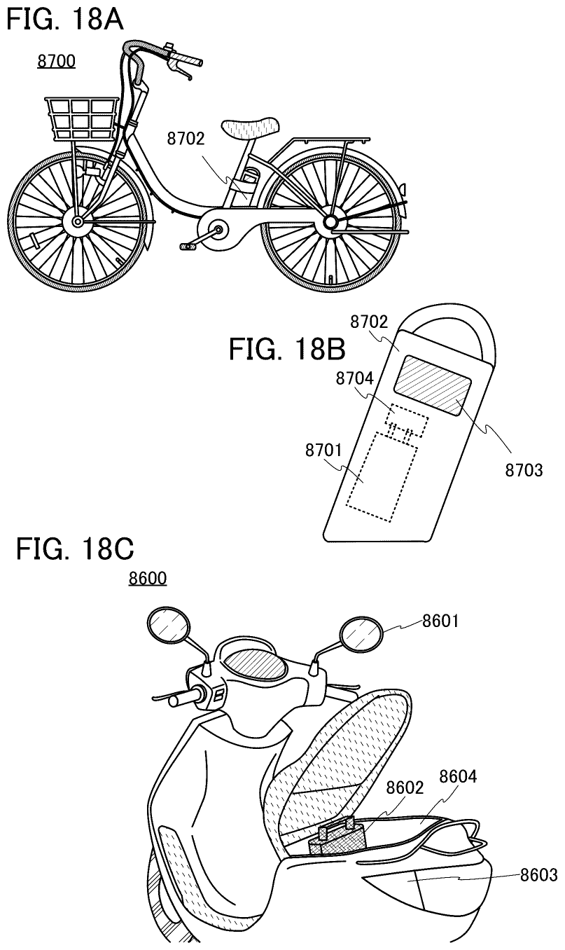

FIG. 18A shows an example of an electric bicycle using the power storage device of one embodiment of the present invention. The power storage device of one embodiment of the present invention can be used for an electric bicycle 8700 illustrated in FIG. 18A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 18B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery. The control circuit 8704 is electrically connected to a positive electrode and a negative electrode of the storage battery 8701. When the control circuit 8704 is used in combination with a secondary battery including a positive electrode using the positive electrode active material 100 of one embodiment of the present invention, the synergy on safety can be obtained. The secondary battery including a positive electrode using the positive electrode active material 100 of one embodiment of the present invention and the control circuit 8704 can contribute greatly to elimination of accidents due to secondary batteries, such as fires.

FIG. 18C shows an example of a motorcycle using the power storage device of one embodiment of the present invention. A motor scooter 8600 illustrated in FIG. 18C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 of one embodiment of the present invention can have high capacity and contribute to a reduction in size.

In the motor scooter 8600 illustrated in FIG. 18C, the power storage device 8602 can be stored in an under-seat storage unit 8604. The power storage device 8602 can be stored in the under-seat storage unit 8604 even when the under-seat storage unit 8604 is small.

This embodiment can be used in combination with any of the other embodiments or an example as appropriate.

### Embodiment 7

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

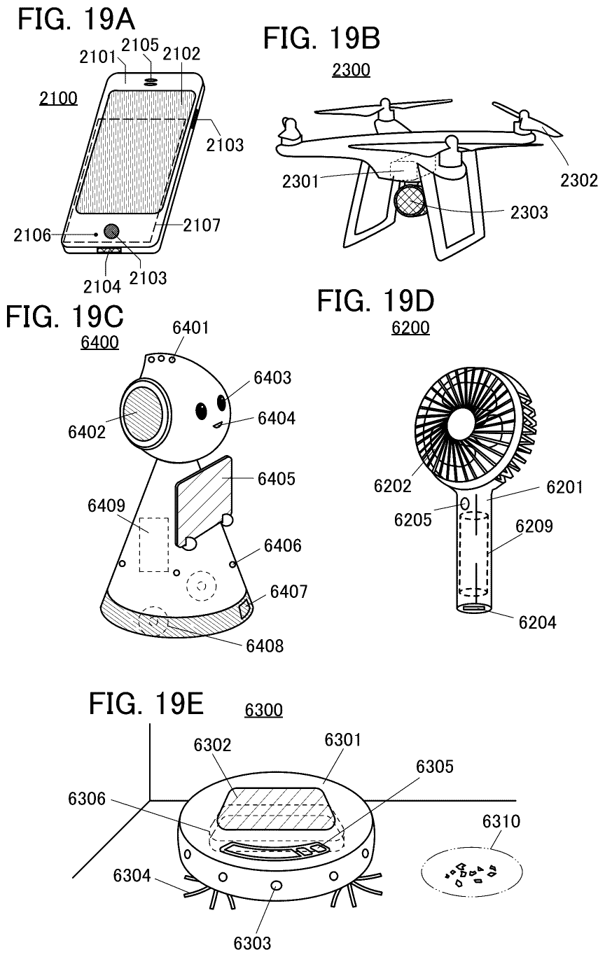

FIG. 19A shows an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The secondary battery 2107 including the positive electrode active material 100 described in Embodiments 1, 2, and the like achieves high capacity and a structure that accommodates space saving due to a reduction in size of the housing 2101.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 19B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 of one embodiment of the present invention has high energy density and a high level of safety, and thus can be used safely for a long time over a long period of time and is preferable as the secondary battery included in the unmanned aircraft 2300.

FIG. 19C shows an example of a robot. A robot 6400 illustrated in FIG. 19C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 of one embodiment of the present invention has high energy density and a high level of safety, and thus can be used safely for a long time over a long period of time and is preferable as the secondary battery 6409 included in the robot 6400.

FIG. 19D shows an example of a portable fan. A portable fan 6200 illustrated in FIG. 19D includes a secondary battery 6209 of one embodiment of the present invention, an operation button 6205, a fan 6202, an external connection port 6204, and the like, and the secondary battery 6209 is held in a housing 6201. The portable fan 6200 can rotate the fan 6202 by driving a motor with electric power supplied from the secondary battery 6209, and the secondary battery 6209 can be charged via the external connection port 6204. Although the secondary battery 6209 is illustrated as a cylindrical secondary battery in this example, the shape is not particularly limited. A secondary battery including the positive electrode active material 100 of one embodiment of the present invention is less likely to ignite owing to a stable crystal structure, and thus is suitable as the secondary battery 6306 mounted on the portable fan 6200.

FIG. 19E shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust 6310 through the inlet provided on the bottom surface of the housing 6301.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 of one embodiment of the present invention has high energy density and a high level of safety, and thus can be used safely for a long time over a long period of time and is preferable as the secondary battery 6306 included in the cleaning robot 6300.

This embodiment can be used in combination with any of the other embodiments or an example as appropriate.

### Example 1

### <Fabrication of Positive Electrode Active Material>

In this example, four kinds of samples (Sample 1 to Sample 4) with some different fabrication conditions were prepared as the positive electrode active material described in the above embodiment. Fabrication process of each sample will be described in detail below. Note that in the fabrication process, many conditions are common among the samples. Thus, fabrication conditions described below are common to all the samples unless otherwise specified; a difference among the samples is described if any.

### <Fabrication of Sample>

As the cobalt source 81, the nickel source 82, and the chelate agent 83 that are shown in FIG. 7 in the above embodiment, cobalt sulfate (CoSO₄), nickel sulfate (NiSO₄), and first glycine were prepared, respectively, and mixing was performed as in Step S14, whereby the mixed solution 91 was obtained. Note that the molar ratio of cobalt sulfate to nickel sulfate was set to 99:1. In the mixed solution 91, the total concentration of cobalt sulfate and nickel sulfate was set to 2 mol/L and the concentration of the first glycine was set to 0.075 mol/L.

Next, as the alkaline aqueous solution 84 shown in FIG. 7, pure water in which sodium hydroxide was dissolved (a sodium hydroxide aqueous solution) was prepared. The concentration of the sodium hydroxide was adjusted to be 5 mol/L.

As the chelate agent 85 shown in FIG. 7, an aqueous solution containing a second glycine was prepared. The concentration of the second glycine was adjusted to be 0.075 mol/L in the aqueous solution containing the second glycine. The aqueous solution containing the second glycine is referred to as a filling liquid.

The filling liquid was put in a reaction container, stirring was performed with a stirrer at a rotational frequency of 1000 rpm, and the temperature was adjusted to be kept at a constant value (50° C. during the fabrication of Sample 1 and during the fabrication of Sample 3 and 70° C. during the fabrication of Sample 2 and during the fabrication of Sample 4). Nitrogen was supplied from above the reaction container at a rate of 1 L/min, and the sodium hydroxide aqueous solution was dropped so that the pH was kept at 10.3. The dropping rate was changed in multiple stages, specifically gradually increased from 0.4 mL/min to 0.93 mL/min, whereby the mixed solution 91 was dropped (the above is Step S31 illustrated in FIG. 7). The sodium hydroxide aqueous solution was supplied in a state where a tube of the sodium hydroxide aqueous solution was immersed in the filling liquid; thus, the dropping rate may be referred to as a liquid delivery rate. As an apparatus for such coprecipitation, OptiMax (produced by Mettler-Toledo. K. K.) was used.

In accordance with Step S32 shown in FIG. 7, a suspension generated in a coprecipitation reaction was suction-filtered with pure water and then suction-filtered with acetone, whereby a precipitate was obtained. After that, in accordance with Step 33 shown in FIG. 7, the precipitate was dried at 80° C. (for 1 hour during the fabrication of Sample 1 and during the fabrication of Sample 3 and for 17 hours in during the fabrication of Sample 2 and during the fabrication of Sample 4) in a vacuum drying furnace, whereby the hydroxide 95 was obtained. This drying is considered to be able to give the hydroxide 95 from which impurities are removed. The hydroxide 95 can be represented by Co_{(1-y)}Ni_{y}(OH)₂ and these samples were fabricated so that y was 0.01. Note that as described above, the hydroxide 95 is referred to as a precursor in some cases.

As the lithium source 88 in FIG. 7, lithium hydroxide was prepared. Lithium hydroxide was crushed in dehydrated acetone using a ball mill and then made to pass through a sieve with an aperture size of 300 μm.

Next, in accordance with Step S51 in FIG. 7, the precursor (hydroxide 95) obtained above was mixed with lithium hydroxide using a ball mill. With a 1-mmϕ zirconia ball being put, the ball mill performs mixing for one hour. Then, the mixture was made to pass through a sieve with an aperture size of 300 μm, whereby the mixture 96 was obtained. The mixing ratio of the precursor to the lithium source 88 was set such that the molar ratio of lithium hydroxide to the precursor (referred to as Li/Co) was set to 1.03. Note that the molar ratio is not necessarily satisfied in the positive electrode active material 100.

Next, heating (temporary baking) of the mixture 96 of each of Sample 3 and Sample 4 was performed in accordance with Step S52 in FIG. 7. The heating conditions for each of Sample 3 and Sample 4 were 800° C. and 10 hours. During the heating, oxygen was made to flow into the furnace at a flow rate of 5 L/min. Note that the heating in Step S52 was performed on neither Sample 1 nor Sample 2.

In accordance with Step S54 in FIG. 7, heating (main baking) of the mixture 96 was performed. The heating conditions were 950° C. and 10 hours. During the heating, oxygen was made to flow into the furnace at a flow rate of 5 L/min. After that, the temperature was cooled down to room temperature, whereby the oxide 98 was obtained. Note that the oxide 98 is referred to as a composite oxide and can function as a positive electrode active material at this stage.

In this example, neither the crushing in Step S53 nor the crushing in Step S55 in FIG. 7 was performed.

As the additive element source 89 in FIG. 7, a mixture with LiF:MgF₂=1:3 (molar ratio) was used. First, LiF and MgF₂ were mixed in dehydrated acetone using a ball mill in which a 1-mmϕ zirconia ball was put, and then acetone was evaporated by drying at 55° C. for 2 hours. Then, the mixture was made to pass through a sieve with an aperture size of 300 μm, whereby the additive element source 89 was obtained.

Next, in accordance with Step S71 in FIG. 7, the oxide 98 was mixed with the mixture containing LiF and MgF₂ (the additive element source 89) using a ball mill, whereby the mixture 99 was obtained.

In accordance with Step 72 in FIG. 7, the mixture 99 was heated. The heating was performed at 900° C. for 20 hours. Oxygen was made to flow into the furnace at a flow rate of 5 L/min. After that, the temperature was cooled down to room temperature, whereby the positive electrode active material 100 was obtained.

In this example, the crushing in Step S73 in FIG. 7 was not performed.

The following table shows the main fabrication conditions of Sample 1 to Sample 4.

TABLE 1

| | Sample 1 | | Sample 2 | | Sample 3 | | Sample 4 | |
|---|---|---|---|---|---|---|---|---|
| Temperature during | 50° | C. | 70° | C. | 50° | C. | 70° | C. |
| coprecipitation (Step | | | | | | | | |
| S31) | | | | | | | | |
| Time for drying (Step | 1 | hour | 17 | hours | 1 | hour | 17 | hours |
| S33) | | | | | | | | |

| | | | | |
|---|---|---|---|---|
| Conditions for heating | — | — | 800° C. | 800° C. |
| (Step S52) | | | 10 hours | 10 hours |

### <SEM Image>

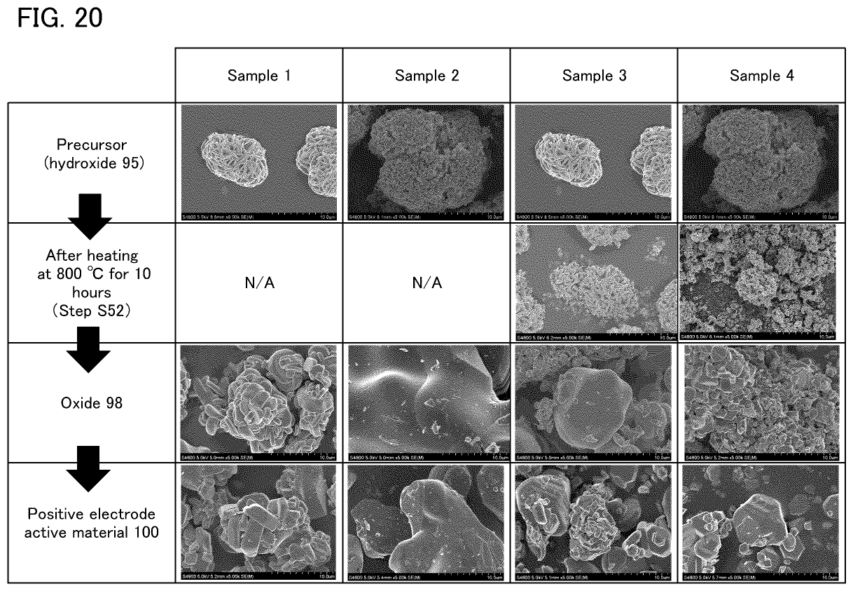

FIG. 20 shows plan SEM images of the samples each corresponding to the precursor (hydroxide 95), the state after the heating at 800° C. for 10 hours in Step 52 in FIG. 7, the oxide 98, and the positive electrode active material 100, in accordance with the fabrication steps of Sample 1 to Sample 4. The SEM images were obtained with use of S4800 produced by Hitachi High-Technologies Corporation, the accelerating voltage was fixed to 5 kV, and the magnification was 5000 times. It was found that the particle diameter in each sample tends to increase during the process from the precursor to the oxide 98. This tendency was particularly evident in Sample 2. Note that a difference between the samples was observed; for example, the particle diameter in Sample 4 was slightly smaller than those in the other three samples. After the formation of the positive electrode active material 100, the particle diameter in Sample 4 also grew to substantially the same level as those in the other three samples, so that there were almost no difference in particle diameter between the samples.

### <XRD Measurement>

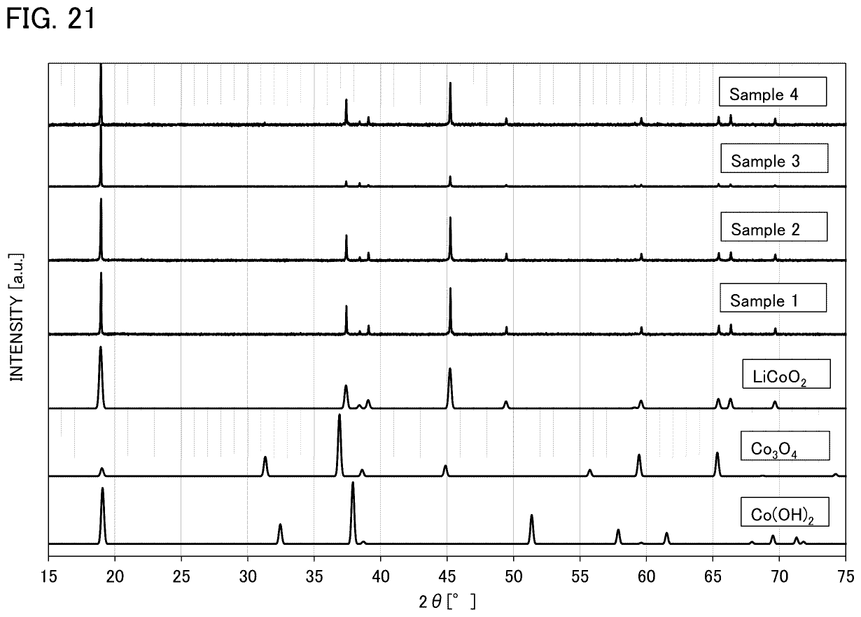

FIG. 21 shows the powder XRD measurement results after the formation of the mixture 99 corresponding to the fabrication steps of Sample 1 to Sample 4. FIG. 21 also shows data on LCO, Co₃O₄, and Co(OH)₂ (obtained from ICSD (Non-Patent Document 2)) for comparison. The XRD measurement conditions were as follows.
XRD apparatus: D8 ADVANCE produced by Bruker AXS
X-ray source: CuKα source (K_{α1} is extracted by EVA)
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (increment) of 2θ: 0.01°
Counting time: 1 second/step
Rotation of sample stage: 15 rpm

In each of the samples, the position of the diffraction peak by the XRD measurement overlaps with the position of the diffraction peak of lithium cobalt oxide (LCO) obtained from ICSD (see Non-Patent Document 2), which indicates that pure lithium cobalt oxide was fabricated. Furthermore, it was found that 2θ of each sample overlaps with neither cobalt carbonate (Co₃O₄) nor cobalt hydroxide (Co(OH)₂), which is considered to be a reaction residue.

### <Fabrication of Positive Electrode>

Sample 1 to Sample 4 described above were prepared as positive electrode active materials, acetylene black (AB) was prepared as a conductive material, and poly(vinylidene fluoride) (PVDF) was prepared as a binding agent. The PVDF prepared was one dissolved in N-methyl-2-pyrrolidone (NMP) with a weight ratio of 5%. A slurry was formed by mixing the positive electrode active material, AB, and PVDF at 95:3:2 (weight ratio), and the slurry was applied to a positive electrode current collector of aluminum. As a solvent of the slurry, NMP was used. After the slurry was applied to the positive electrode current collector, the solvent was volatilized.

After that, pressing treatment was performed with a roller press machine to increase the density of the positive electrode active material layer over the positive electrode current collector. The pressing treatment was performed with a linear pressure of 210 kN/m. Note that the temperature of each of an upper roll and a lower roll of the roller press machine was 120° C. The carried amount of each sample was approximately 7 mg/cm².

Through the above process, the positive electrodes including Sample 1 to Sample 4 were obtained.

### <Fabrication of Test Battery>

Test batteries (CR2032 type coin-type cells, diameter: 20 mm, height: 3.2 mm) were fabricated using the above-described positive electrodes and using lithium metals for counter electrodes. A battery using a lithium metal for a counter electrode is referred to as a half cell.

As an electrolyte solution of the half cell, an organic electrolyte solution was prepared by dissolving lithium hexafluorophosphate (LiPF₆) at 1 mol/L in a mixed organic solvent containing EC (ethylene carbonate) and DEC (diethyl carbonate) at EC:DEC=30:70 (volume ratio). Note that VC (vinylene carbonate) was added as an additive at 2 wt % to the organic electrolyte solution.

As a separator of the half cell, a 25-μm-thick porous polypropylene film was used.

The above were held with a positive electrode can and a negative electrode can, whereby the half cells including Sample 1 to Sample 4 were fabricated. To clarify the correspondence with the positive electrode active materials, the fabricated half cells were referred to as Sample 1 to Sample 4. A positive electrode can and a negative electrode can that were formed of stainless steel (SUS) were used.

### <Charge and Discharge Cycle Test>

The half cells were subjected to the charge and discharge cycle tests in which measurement was performed with a charge-discharge measuring system (TOSCAT-3100) produced by TOYO SYSTEM Co., LTD. as a charge-discharge measuring instrument. The performance of the positive electrode itself can be clarified by the charge and discharge cycle tests using the half cells.

Rates of the charge and discharge cycle test conditions are described. The rate at discharging is referred to as discharge rate, and the discharge rate refers to the relative ratio of a current in discharging to the battery capacity and is expressed in a unit C. A current corresponding to 1 C in a battery with a rated capacity X (Ah) is X (A). The case where discharging is performed at a current of 2X (A) is rephrased as follows: discharging is performed at 2 C. The case where discharging is performed at a current of X/2 (A) is rephrased as follows: discharging is performed at 0.5 C. The rate at charging is referred to as charge rate and similarly, for the charge rate, the case where charging is performed at a current of 2X (A) is rephrased as follows: charging is performed at 2 C, and the case where charging is performed at a current of X/2 (A) is rephrased as follows: charging is performed at 0.5 C. The charge rate and the discharge rate are collectively referred to as a charge and discharge rate.

In the charge and discharge cycle test, a cycle of the above-described charging and discharging was repeated 50 times, and the value calculated by (the discharge capacity in the 50th cycle/the maximum value of the discharge capacity in the 50 cycles)×100 was referred to as a discharge capacity retention rate (%) in the 50th cycle. In other words, in the case where a test of 50 repetitions of a cycle of charging and discharging was conducted and the discharge capacity in each cycle was measured, the proportion of the value of the discharge capacity measured in the 50th cycle with respect to the maximum value of the discharge capacity in all the 50 cycles (referred to as the maximum discharge capacity) was calculated. A higher discharge capacity retention rate is desirable as a battery characteristic because a reduction in battery capacity after repeated charging and discharging is inhibited. Note that the above number of the cycles is an example.

In the charge and discharge cycle test, a current is measured. Specifically, a battery voltage and a current flowing in a battery are preferably measured by a four-terminal method. In charging, electrons flow from a positive electrode terminal to a negative electrode terminal through a charge-discharge measuring instrument and thus, a charge current refers to a current that flows from the negative electrode terminal to the positive electrode terminal through the charge-discharge measuring instrument. In discharging, electrons flow from the negative electrode terminal to the positive electrode terminal through the charge-discharge measuring instrument and thus, a discharge current refers to a current that flows from the positive electrode terminal to the negative electrode terminal through the charge-discharge measuring instrument. The charge current and discharge current are measured with an ammeter of the charge-discharge measuring instrument, and the total amount of the current flowing during one charging and the total amount of the current flowing during one discharging respectively correspond to charge capacity and discharge capacity. For example, the total amount of the discharge current flowing during the discharging in the first cycle can be regarded as the discharge capacity in the first cycle, and the total amount of the discharge current flowing during the discharging in the 50th cycle can be regarded as the discharge capacity in the 50th cycle.

The above-described charge and discharge cycle tests were performed on Sample 1 to Sample 4 at the ambient temperatures of 25° C. and 45° C. The ambient temperature refers to the temperature of a thermostatic oven where the samples corresponding to Sample 1 to Sample 4 were placed.

The half cells placed in the thermostatic oven were subjected to constant current charging under the charge condition of 0.5 C rate (in this example, 1 C=200 mA/g (positive electrode active material weight) until the upper limit voltage reached 4.6 V, 4.65 V, or 4.7 V) and were subjected to constant voltage charging until the current amount reached 0.05 C while the upper limit voltage was maintained. Charging in which constant current charging is performed and then constant voltage charging is performed as described above is referred to as CC/CV charging; in some cases, CC/CV charging (each upper limit voltage, 0.5 C rate, 0.05 C cutoff) denotes charge and discharge cycle test conditions. Constant current discharging was performed under the discharge condition of 0.5 C rate until the lower limit voltage reached 2.5 V. As a break period between charging and discharging, a 10-minute break was provided in this example.

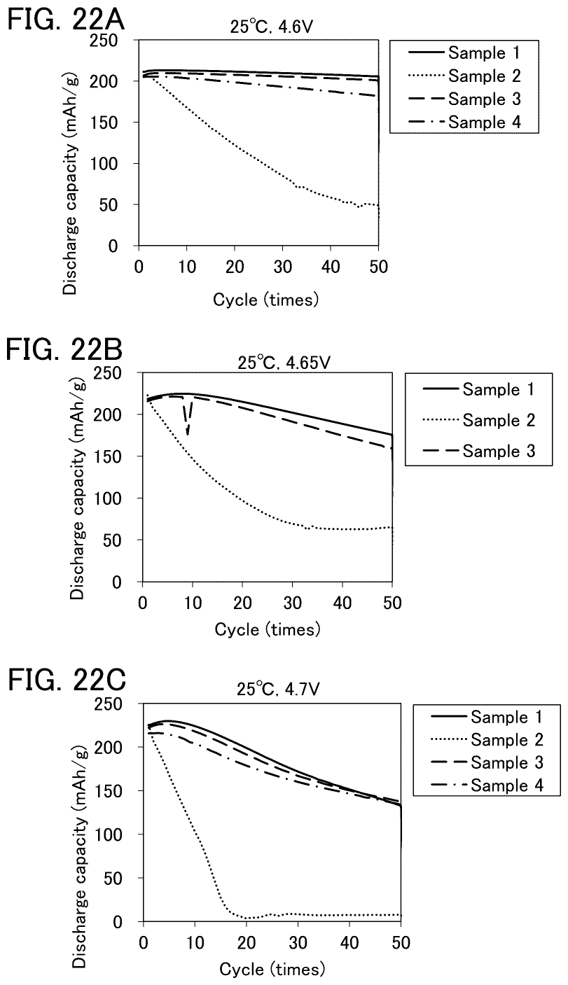

FIG. 22A shows a graph relating to changes in discharge capacity in accordance with the number of cycles in the case where the ambient temperature is 25° C. and the upper limit voltage is 4.6 V. FIG. 22B shows a graph relating to changes in discharge capacity in accordance with the number of cycles in the case where the ambient temperature is 25° C. and the upper limit voltage is 4.65 V. FIG. 22C shows a graph relating to changes in discharge capacity in accordance with the number of cycles in the case where the ambient temperature is 25° C. and the upper limit voltage is 4.7 V. Note that the discharge capacities of the half cells in this example were all calculated to be the value per weight of the positive electrode active material.

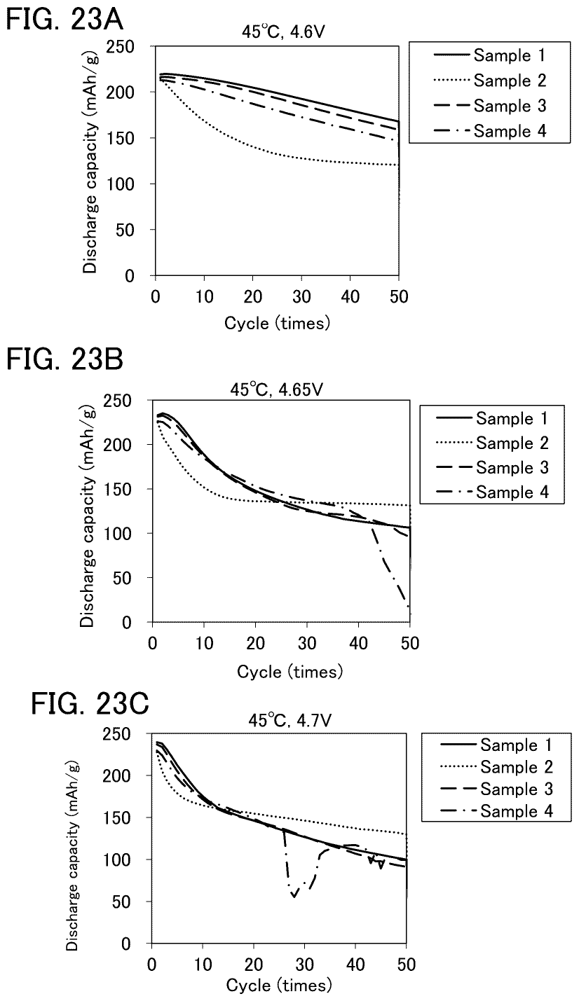

FIG. 23A shows a graph relating to changes in discharge capacity in accordance with the number of cycles in the case where the ambient temperature is 45° C. and the upper limit voltage is 4.6 V. FIG. 23B shows a graph relating to changes in discharge capacity in accordance with the number of cycles in the case where the ambient temperature is 45° C. and the upper limit voltage is 4.65 V. FIG. 23C shows a graph relating to changes in discharge capacity in accordance with the number of cycles in the case where the ambient temperature is 45° C. and the upper limit voltage is 4.7 V.

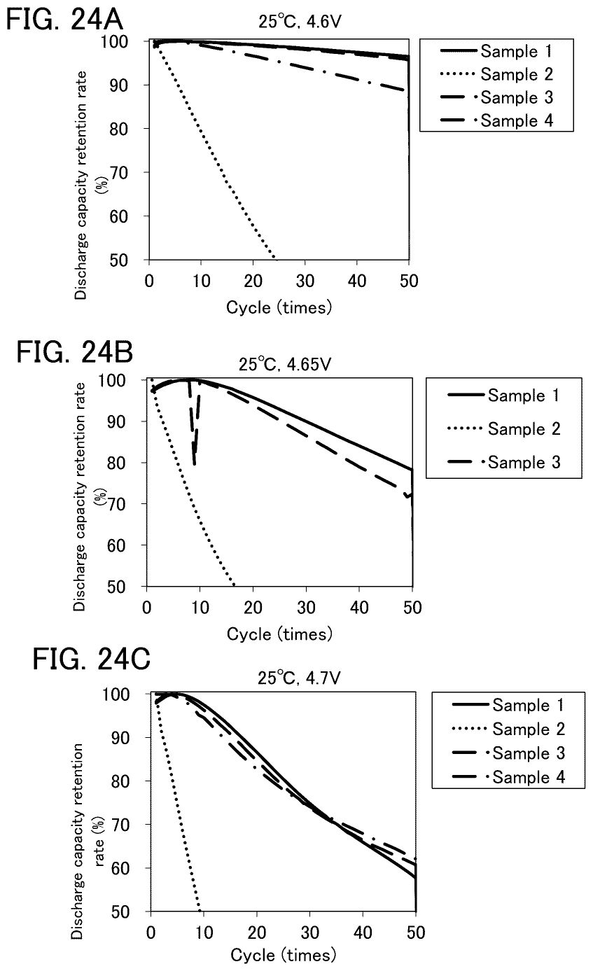

FIG. 24A shows a graph relating to discharge capacity retention rates in the case where the ambient temperature is 25° C. and the upper limit voltage is 4.6 V. FIG. 24B shows a graph relating to discharge capacity retention rates in the case where the ambient temperature is 25° C. and the upper limit voltage is 4.65 V. FIG. 24C shows a graph relating to discharge capacity retention rates in the case where the ambient temperature is 25° C. and the upper limit voltage is 4.7 V.

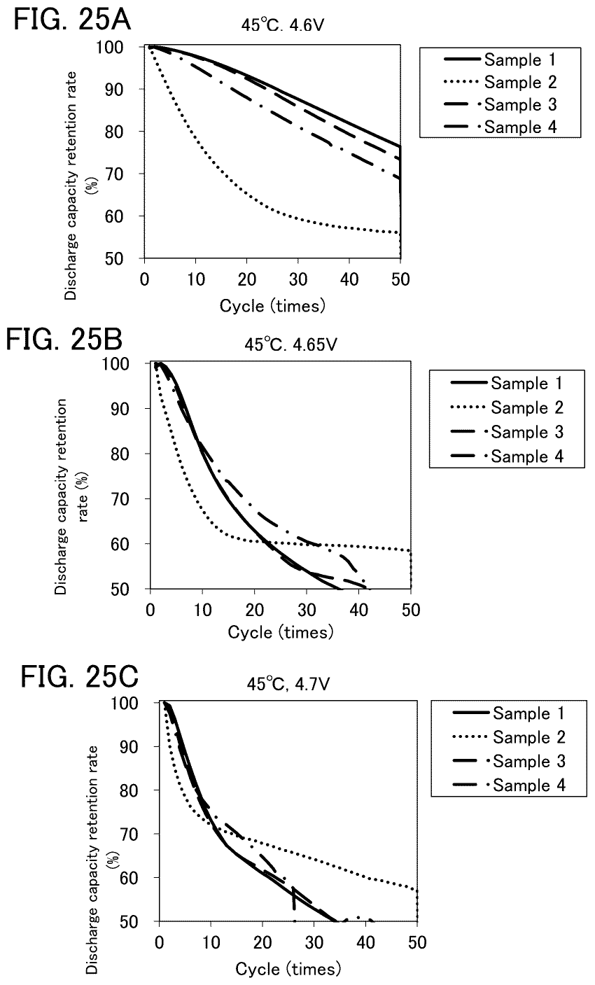

FIG. 25A shows a graph relating to discharge capacity retention rates in the case where the ambient temperature is 45° C. and the upper limit voltage is 4.6 V. FIG. 25B shows a graph relating to discharge capacity retention rates in the case where the ambient temperature is 45° C. and the upper limit voltage is 4.65 V. FIG. 25C shows a graph relating to discharge capacity retention rates in the case where the ambient temperature is 45° C. and the upper limit voltage is 4.7 V.

At an ambient temperature of 25° C., the discharge capacity and the discharge capacity retention rate of Sample 2 tended to significantly decrease with an increase in the number of cycles regardless of the upper limit voltage, whereas large differences in the results of the other three samples depending on the conditions were not confirmed (see FIG. 22A to FIG. 22C and FIG. 24A to FIG. 24C). At an ambient temperature of 45° C., Sample 2 showed a tendency to have slightly larger decreases in discharge capacity and discharge capacity retention rate than the other three samples at the upper limit voltage of 4.6 V (see FIG. 23A and FIG. 25A), whereas significant differences between the samples were not able to be confirmed at the other upper limit voltages (see FIG. 23B, FIG. 23C, FIG. 25B, and FIG. 25C). Sample 1, Sample 3, and Sample 4 showed a tendency to decrease in discharge capacity and discharge capacity retention rate as the upper limit voltage increased; however, Sample 2 had smaller changes in discharge capacity and discharge capacity retention rate depending on the upper limit voltage than those of the other three samples (see FIG. 22A to FIG. 25C).

### <Rate Performance>

In a 25° C. ambient temperature environment, the discharge capacity of each of Sample 1 to Sample 4 were measured while the rate at the time of charging was fixed to 0.5 C until the voltage reached 4.6 V, 4.65 V, or 4.7 V and the rate at the time of discharging was varied to 0.2 C, 0.5 C, 1 C, 2 C, 3 C, 4 C, 5 C, and 0.2 C in this order. This measurement is referred to as rate performance in some cases. Note that the discharge capacity at each rate was measured twice.

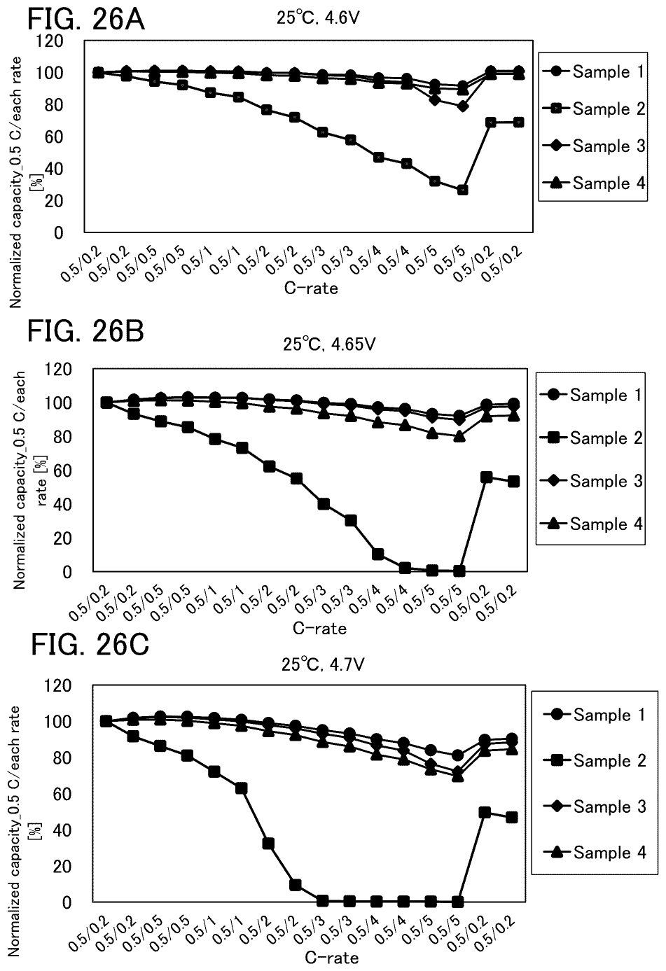

FIG. 26A is a graph showing rate performance at the upper limit voltage of 4.6 V normalized with the initial value at 0.5 C/0.2 C. FIG. 26B is a graph showing rate performance at the upper limit voltage of 4.65 V normalized with the initial value at 0.5 C/0.2 C. FIG. 26C is a graph showing rate performance at the upper limit voltage of 4.7 V normalized with the initial value at 0.5 C/0.2 C.

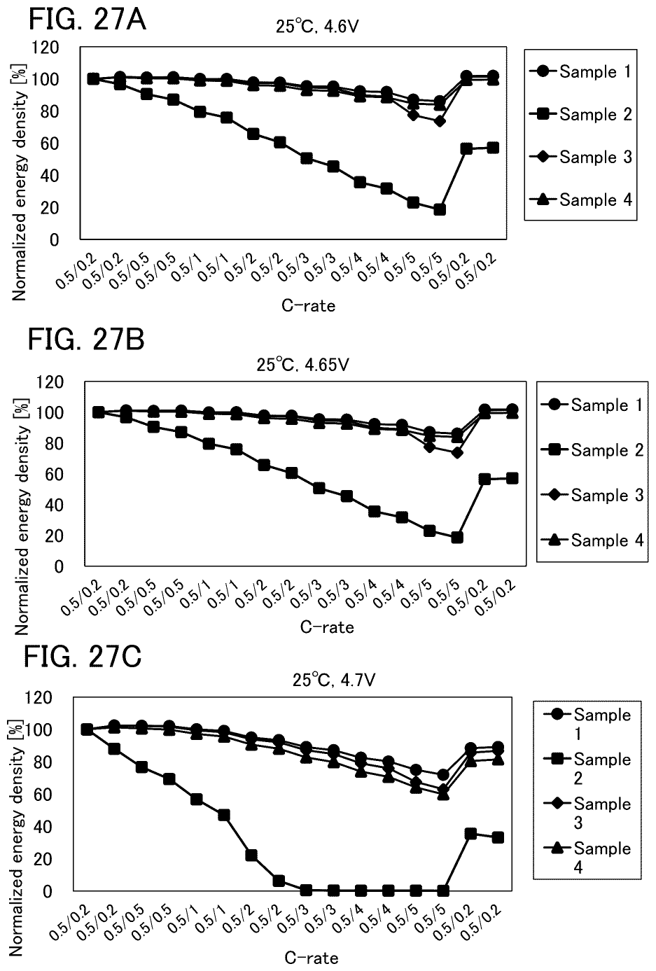

FIG. 27A is a graph showing rate performance at the upper limit voltage of 4.6 V normalized with the initial energy density at 0.5 C/0.2 C. FIG. 27B is a graph showing rate performance at the upper limit voltage of 4.65 V normalized with the initial energy density at 0.5 C/0.2 C. FIG. 27C is a graph showing rate performance at the upper limit voltage of 4.7 V normalized with the initial energy density at 0.5 C/0.2 C.

Although the rate performance of Sample 2 tended to be poor regardless of the upper limit voltage, a clear difference in the results of the other three samples depending on the conditions was not able to be confirmed. The three samples other than Sample 2 each exhibited substantially the same discharge capacity and energy density as the initial ones even when the rate at the time of discharging was increased; the three samples were found to be excellent in rate performance at a high rate, for example, higher than or equal to 2 C and lower than or equal to 5 C (see FIG. 26A to FIG. 26C and FIG. 27A to FIG. 27C).

### Example 2

In this example, samples of positive electrode active materials were prepared again, and measurements were performed. The samples were fabricated in accordance with the above embodiment. The fabrication processes of the samples and the like in this example will be described in detail below.

### <Fabrication of Sample>

As the cobalt source 81, the nickel source 82, and the chelate agent 83 that are shown in FIG. 7 in the above embodiment, cobalt sulfate (CoSO₄), nickel sulfate (NiSO₄), and the first glycine were prepared, respectively, and mixing was performed as in Step S14, whereby the mixed solution 91 in which cobalt sulfate and nickel sulfate were dissolved was obtained. Note that in Sample 1, the molar ratio of cobalt sulfate to nickel sulfate was set to 99:1. In the mixed solution 91 of Sample 1, the total concentration of cobalt sulfate and nickel sulfate was set to 2 mol/L and the concentration of the first glycine was set to 0.075 mol/L.

Next, as the alkaline aqueous solution 84 shown in FIG. 7, pure water in which sodium hydroxide was dissolved (a sodium hydroxide aqueous solution) was prepared. The concentration of the sodium hydroxide was adjusted to be 5 mol/L.

As the chelate agent 85 shown in FIG. 7, an aqueous solution containing a second glycine was prepared. The concentration of the second glycine was adjusted to be 0.075 mol/L in the aqueous solution containing the second glycine. The aqueous solution containing the second glycine is referred to as a filling liquid.

The filling liquid was put in a reaction container of the coprecipitation apparatus, and stirring was performed with a stirrer at a rotational frequency of 1000 rpm, and the temperature was adjusted to be kept at 70° C. Nitrogen was supplied from above the reaction container at a rate of 1 L/min, and the sodium hydroxide aqueous solution was dropped so that the pH was kept at 10.3. The dropping rate was gradually increased from 0.4 mL/min to 0.93 mL/min, whereby the mixed solution 91 was dropped into the reaction container. The sodium hydroxide aqueous solution was supplied in a state where a tube of the sodium hydroxide aqueous solution was immersed in the filling liquid; thus, the dropping rate may be referred to as a liquid delivery rate. For the coprecipitation apparatus, OptiMax (produced by Mettler-Toledo. K. K.) was used.

In accordance with Step S32 shown in FIG. 7, a suspension generated in the coprecipitation reaction was suction-filtered with pure water and then suction-filtered with acetone, whereby a precipitate was obtained. After that, the precipitate was dried at 80° C. for 17 hours in a vacuum drying furnace in accordance with Step 33 shown in FIG. 7, whereby the hydroxide 95 was obtained (Sample 1). It is considered that the hydroxide 95 from which impurities are removed can be obtained when drying is performed sufficiently as in Sample 1. The hydroxide 95 is a cobalt nickel hydroxide and can be represented by Co_{(1-y)}Ni_{y}(OH)₂, and Sample 1 was obtained by adjusting the molar ratio of raw materials so that y was 0.01. Note that the atomic ratio in the hydroxide obtained through the process of coprecipitation reaction and/or suction filtration is not equal to the adjusted molar ratio in some cases. Note that the hydroxide 95 is referred to as a precursor in some cases.

As the lithium source 88 in FIG. 7, lithium hydroxide was prepared. The lithium hydroxide was put into dehydrated acetone and crushed using a ball mill in which a 1-mmϕ zirconia ball was put, acetone was vaporized by drying at 55° C. for 2 hours, and the mixture was made to pass through a sieve with an aperture size of 300 μm, whereby the zirconia ball and the lithium hydroxide were separated. In Step S42, the molar ratio of the lithium hydroxide to the above precursor (this is referred to as Li/Co) was adjusted to 1.00, 1.03, 1.06, 1.09, 1.15, and 1.20 (denoted as 1.2). The above samples each including Li/Co are referred to as Sample 5-1, Sample 5-2, Sample 5-3, Sample 5-4, Sample 5-5, and Sample 5-6. The table below presents the Li/Co of the samples. Note that the molar ratio is not necessarily satisfied in the positive electrode active material 100.

TABLE 2

| | Li/Co (molar ratio) |
|---|---|
| Sample 5-1 | 1.00 |
| Sample 5-2 | 1.03 |
| Sample 5-3 | 1.06 |
| Sample 5-4 | 1.09 |
| Sample 5-5 | 1.15 |
| Sample 5-6 | 1.20 |

Next, in accordance with Step S51 and Step S54 in FIG. 7, the precursor and the lithium hydroxide were mixed with an automatic mortar for one hour to give the mixture 96, and then the mixture 96 was heated. The heating was performed at 950° C. for 10 hours. Oxygen was made to flow to the heating furnace at a flow rate of 5 L/min. After that, the temperature was cooled down to room temperature, whereby the oxide 98 was obtained. Note that the oxide 98 is referred to as a composite oxide and can function as a positive electrode active material even at this stage. The atomic ratio of the positive electrode active material is sometimes not equal to the molar ratio adjusted as in the above table.

In this example, neither the heating in Step S52 nor the crushing in Step S53 in FIG. 7 was performed.

As the additive element source 89 in FIG. 7, a compound containing additive elements was prepared. Specifically, a mixture with LiF:MgF₂=1:3 (molar ratio) was prepared. The additive element source 89 was obtained in the following manner: LiF and MgF₂ adjusted to have the above-described molar ratio were mixed in dehydrated acetone and then the mixture was made to pass through a sieve with an aperture size of 300 μm. In accordance with Step S71 in FIG. 7, the oxide 98 and the mixture containing LiF and MgF₂ were mixed with an automatic mortar for one hour to give the mixture 99.

In accordance with Step 72 in FIG. 7, the mixture 99 was heated. The heating was performed at 900° C. for 20 hours. Oxygen was made to flow into the furnace at a flow rate of 5 L/min. After that, the temperature was cooled down to room temperature, whereby the positive electrode active material 100 was obtained.

In this example, the crushing in Step S73 in FIG. 7 was not performed. In this manner, the positive electrode active materials corresponding to Sample 5-1 to Sample 5-6 were obtained.

### <SEM Image 1>

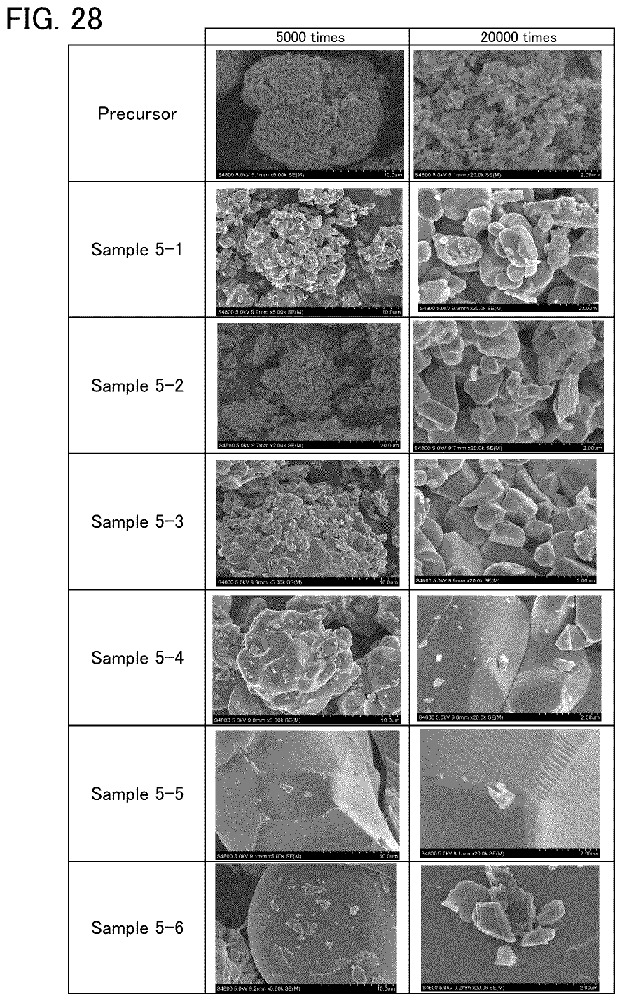

FIG. 28 shows plan SEM images of the precursors corresponding to Sample 5-1 to Sample 5-6 with different adjusted Li/Co as shown in the above table. FIG. 28 also shows plan SEM images of composite oxides corresponding to Sample 5-1 to Sample 5-6, to which the additive element source has not been added yet and which have already been subjected to heat treatment at 950° C. for 10 hours. The SEM images were obtained with use of S4800 produced by Hitachi High-Technologies Corporation, the accelerating voltage was fixed to 15 kV, and the magnifications were 5000 times and 20000 times.

It was found that all of Sample 5-1 to Sample 5-6 had larger particle diameters than the precursors. It was further confirmed that, in Sample 5-1 to Sample 5-6, the particle diameter increased as the Li/Co ratio increased. Sample 5-5 and Sample 5-6 each had an appearance like a single particle.

### <SEM Image 2>

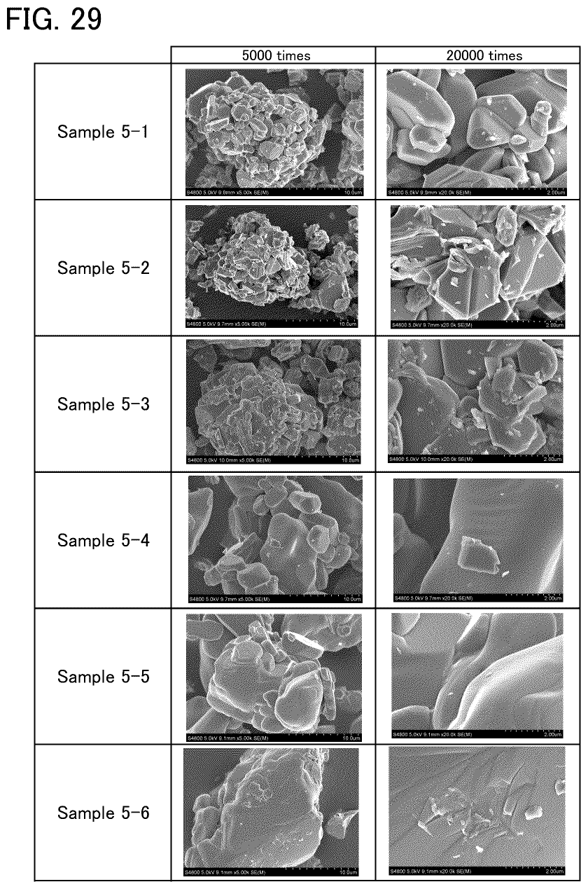

FIG. 29 shows plan SEM images of composite oxides corresponding to Sample 5-1 to Sample 5-6, to which the additive element source has been added and which have already been subjected to heat treatment at 900° C. for 20 hours. The SEM images were obtained with use of S4800 produced by Hitachi High-Technologies Corporation, the accelerating voltage was fixed to 15 kV, and the magnifications were 5000 times and 20000 times.

It was confirmed that all of Sample 5-1 to Sample 5-6 had larger particle diameters than the precursors in FIG. 28. Furthermore, some of Sample 5-1 to Sample 5-6 were slightly pulverized while maintaining the appearance illustrated in FIG. 28 to some extent. It was also confirmed that the particle surfaces of Sample 5-1 to Sample 5-6 were smoother than those in FIG. 28. The smooth surface may be caused by fluorine being contained in the additive element source. Alternatively, the smooth surface may be caused by the heat treatment.

### <SEM Image, EDX Area Analysis, and Point Analysis Measurement>

A positive electrode active material 5-6A and a positive electrode active material 5-6B manufactured in a manner similar to that of Sample 5-6 were subjected to point analysis by a scanning electron microscope-energy dispersive X-ray spectroscopy (SEM-EDX) method on the surface. An energy dispersive X-ray spectrometer JED-2300T produced by JEOL Ltd. was used as an EDX measurement apparatus, the accelerating voltage ranged from 3 kV to 30 kV, and a Si drift detector was used to detect an X-ray. In the EDX element analysis, the detection depth ranges from several nanometers to several micrometers in accordance with the acceleration voltage, the energy resolution ranges from 130 eV to 140 eV, and the lower detection limit of each element is approximately 1 atomic %.

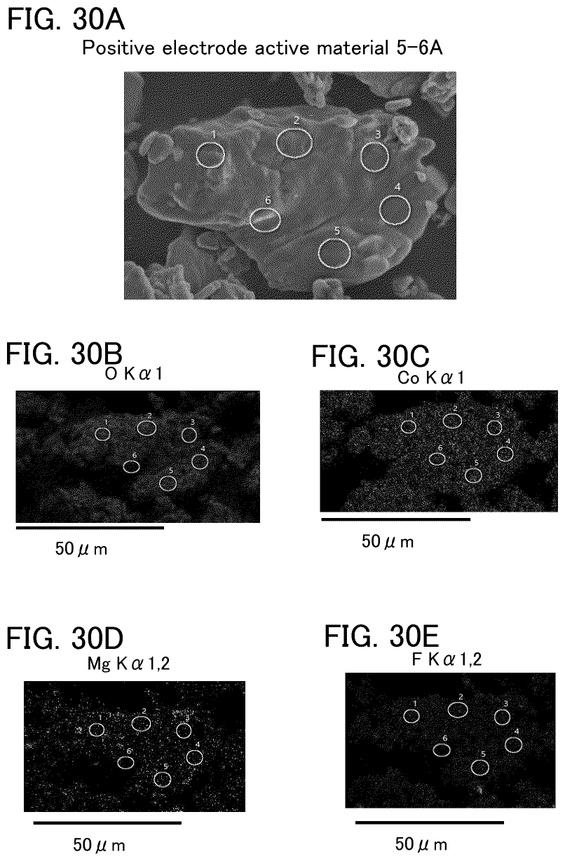

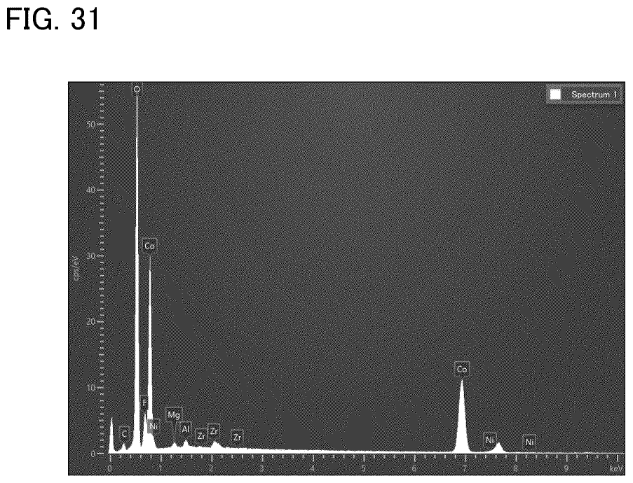

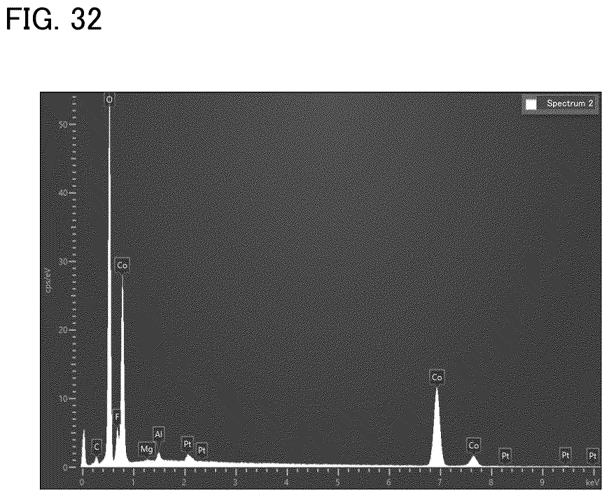

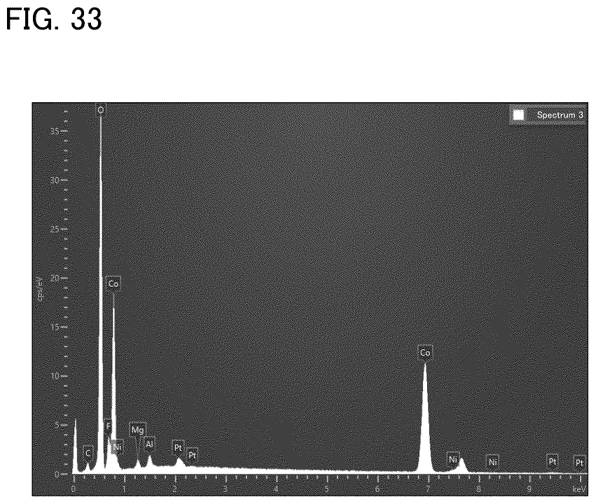

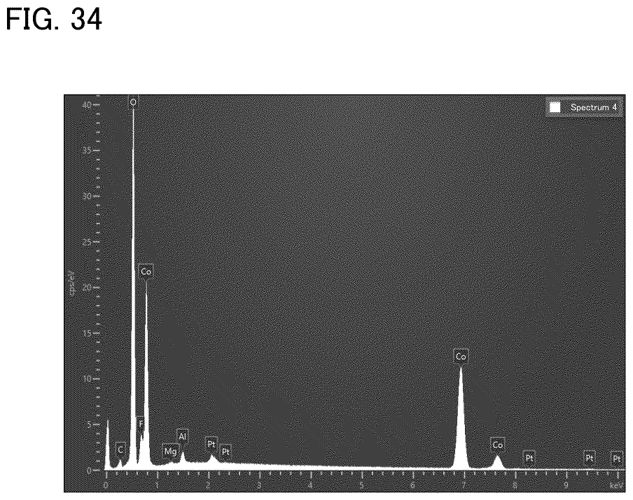

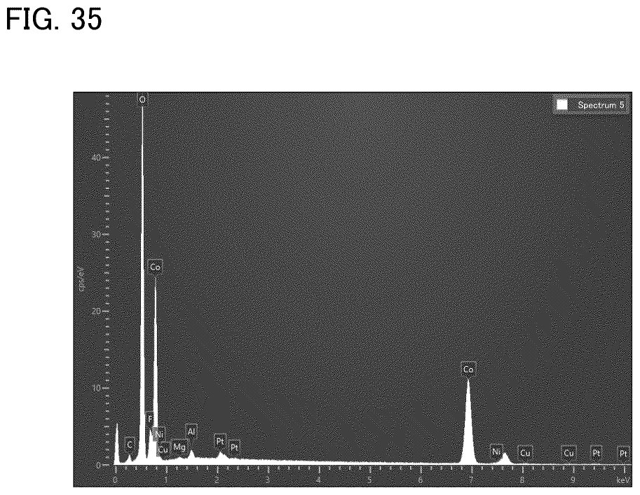

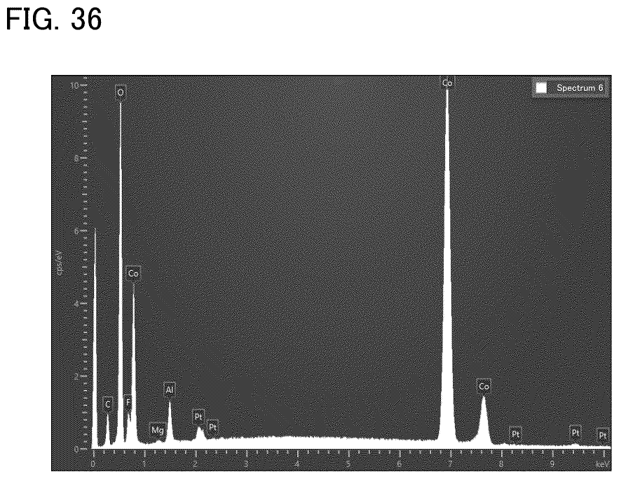

FIG. 30A is a SEM image (referred to as a surface SEM image) of the surface of the positive electrode active material 5-6A, in which a spectrum 1 to a spectrum 6 are shown in regions subjected to the EDX point analysis. In the image, 1 to 6 denote the spectrum 1 to the spectrum 6, respectively. FIG. 31, FIG. 32, FIG. 33, FIG. 34, FIG. 35, and FIG. 36 show energy spectra of the regions (the spectrum 1 to the spectrum 6), respectively. In each energy spectrum, the horizontal axis of the represents X-ray energy and the vertical axis represents X-ray intensity. The unit of X-ray intensity is cps (Count Per Second).

Since energy positions of cobalt, fluorine, and nickel are close to each other in the energy spectra, their spectra are sometimes detected to be close to each other. In other words, the spectra of cobalt, fluorine, and nickel may overlap with each other. The spectrum of fluorine can be confirmed in the energy spectra of the positive electrode active material 5-6A in FIG. 31 to FIG. 36; thus, fluorine probably exists on the surface or the like of the positive electrode active material 5-6A. Meanwhile, depending on the region, nickel might be absent on the surface or the like of the positive electrode active material 5-6A. The spectrum of nickel of the positive electrode active material 5-6A can be confirmed in FIG. 31, FIG. 33, and FIG. 35. In the positive electrode active material 5-6A, nickel has been coprecipitated with the cobalt source and nickel and cobalt form a solid solution. Nickel is therefore considered to be present inside the positive electrode active material 5-6A, not on the surface thereof.

On the basis of the spectra shown in FIG. 31 to FIG. 36, waveform separation or the like was performed with the accompanying software to derive the atomic ratio of each element. The following table shows the atomic ratio (the unit is atomic %, denoted as at %) of each element.

TABLE 3

| | Element | | | | | | | | | |
|---|---|---|---|---|---|---|---|---|---|---|
| | C | O | F | Mg | Al | Co | Ni | Zr | Cu | Total |
| Spectrum 1 | 7.9 | 71.7 | 0 | 0.6 | 0.6 | 18.9 | 0.3 | 0 | 0 | 100 |
| Spectrum 2 | 8.0 | 71.5 | 0 | 0.0 | 0.7 | 19.8 | 0 | 0 | 0 | 100 |
| Spectrum 3 | 8.4 | 65.1 | 0 | 1.0 | 0.9 | 24.1 | 0.4 | 0 | 0 | 100 |
| Spectrum 4 | 8.0 | 67.6 | 0 | 0.2 | 0.9 | 23.3 | 0 | 0 | 0 | 100 |
| Spectrum 5 | 7.6 | 70.3 | 0 | 0.2 | 0.7 | 21.0 | 0.2 | 0 | 0 | 100 |
| Spectrum 6 | 20.5 | 37.7 | 0 | 0.1 | 1.8 | 39.9 | 0 | 0 | 0 | 100 |

[Unit at %]

The atomic ratio of each element can be read from the above table. Note that depending on the accuracy of the accompanying software, the waveform separation for the energy spectra might be unsuccessful and lead to incorrect detection of an energy spectrum in fitting. In that case, the atomic ratio is sometimes output as 0 at %; however, the presence of elements can be discussed in accordance with the energy spectra. For example, although fluorine is 0 at % in Table 3, the spectrum of fluorine can be confirmed in each of the energy spectra in FIG. 31 to FIG. 36 and thus fluorine can be considered to be present on the surface or the like of the positive electrode active material 5-6A.

The values of cobalt, fluorine, magnesium, and nickel are extracted and listed in following table to show the atomic ratio of the transition metal to the additive element, for example, on the surface or the like of the positive electrode active material 5-6A.

TABLE 4

Element

| | F | Mg | Co | Ni | Total |
|---|---|---|---|---|---|
| Spectrum 1 | 0 | 2.9 | 95.8 | 1.3 | 100 |
| Spectrum 2 | 0 | 0 | 100 | 0 | 100 |
| Spectrum 3 | 0 | 3.8 | 94.5 | 1.7 | 100 |
| Spectrum 4 | 0 | 0.8 | 99.2 | 0 | 100 |
| Spectrum 5 | 0 | 1.0 | 98.1 | 1.0 | 100 |
| Spectrum 6 | 0 | 0.3 | 99.7 | 0 | 100 |

[Unit at %]

The atomic ratio of each element can be read from the above table.

Next, mapping images obtained by a scanning electron microscope-energy dispersive X-ray spectroscopy (SEM-EDX) method are shown. FIG. 30B is an oxygen mapping image, FIG. 30C is a cobalt mapping image, FIG. 30D is a magnesium mapping image, and FIG. 30E is a fluorine mapping image. In the mapping images, the intensity of a target element is converted into luminance by scanning (operating) while a given region of 192 pixels×256 pixels, for example, is irradiated with X-rays. Such analysis is referred to as area analysis in some cases. The mapping images visualize the presence of the target element in the target region, and bright spots in FIG. 30B to FIG. 30E are considered to indicate the presence of each element. However, the mapping image alone cannot determine the presence of an element; therefore, the energy spectra shown in FIG. 31 to FIG. 36 are used to determine the presence of the element.

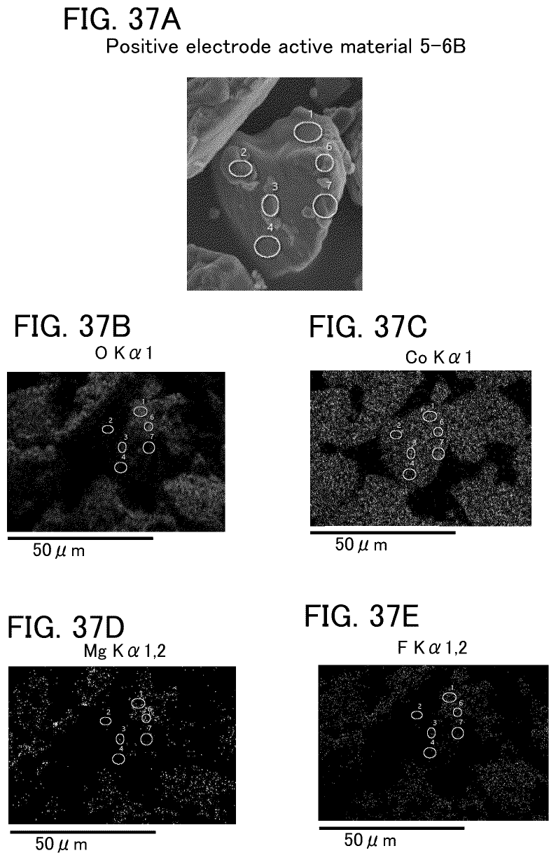

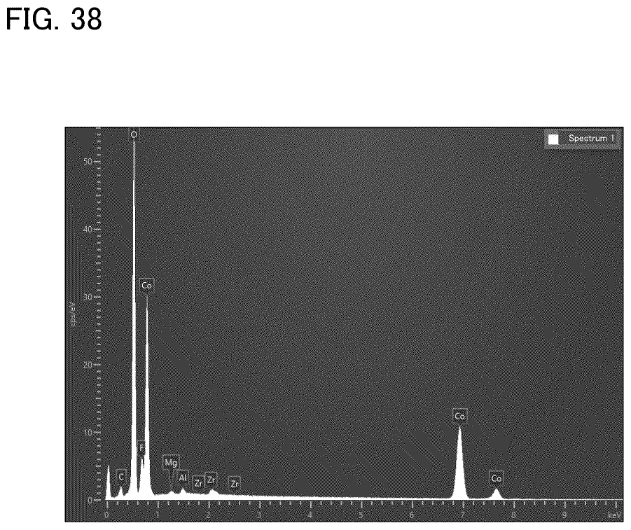

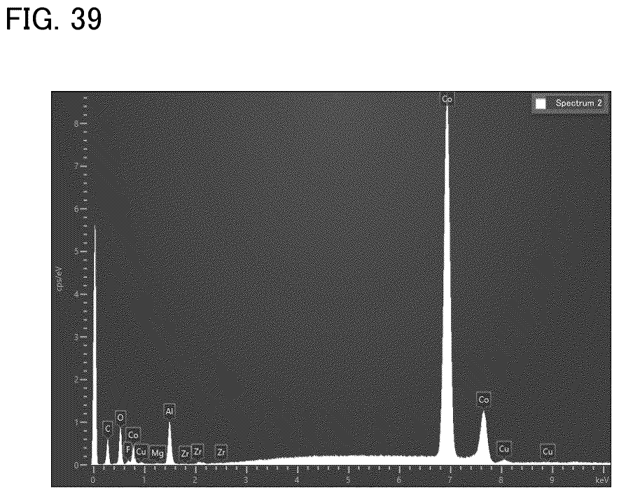

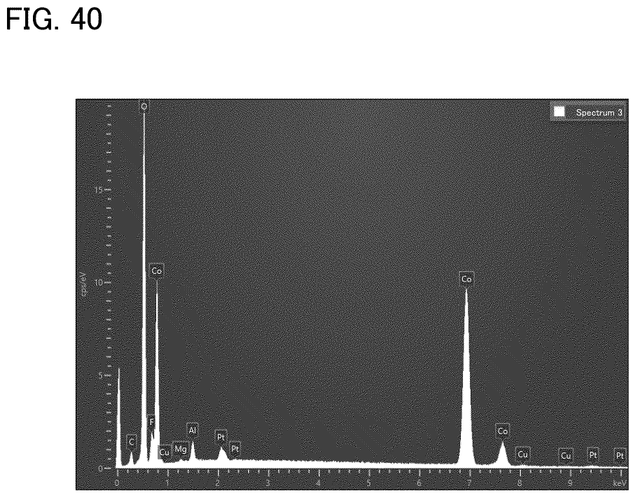

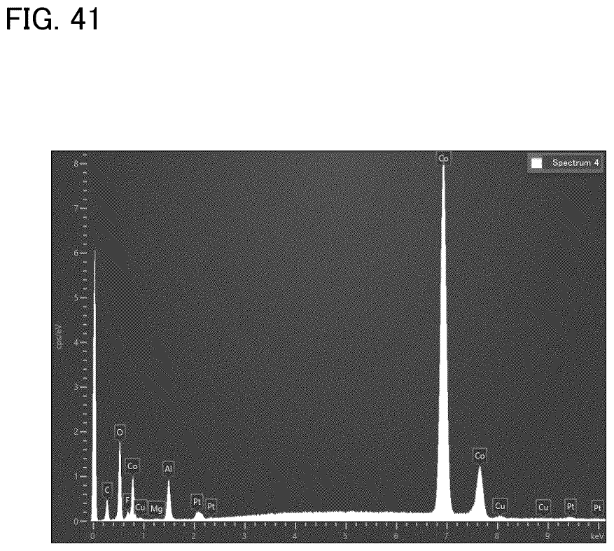

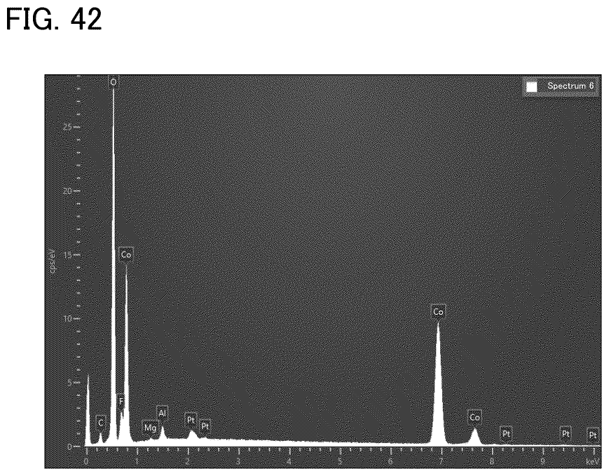

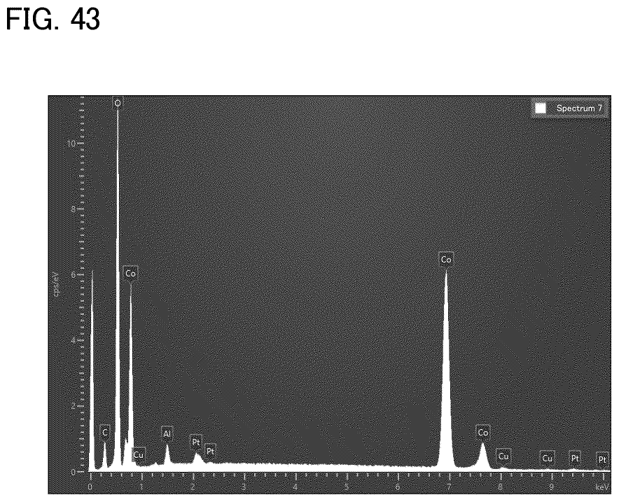

Next, energy spectra of the other of the samples fabricated under the same conditions were obtained. Specifically, a surface SEM image of the positive electrode active material 5-6B (a particle different from the positive electrode active material 5-6A, such a condition is sometimes referred to as n=2) is shown in FIG. 37A, and a spectrum 1 to a spectrum 4, a spectrum 6, and a spectrum 7 are shown in the regions subjected to the EDX point analysis. In the image, 1 to 6 denote the spectrum 1 to the spectrum 6, respectively. FIG. 38, FIG. 39, FIG. 40, FIG. 41, FIG. 42, and FIG. 43 show energy spectra of the regions (the spectrum 1, the spectrum 2, the spectrum 3, the spectrum 4, the spectrum 6, and the spectrum 7), respectively.

Since energy positions of cobalt and fluorine are close to each other in energy spectra, their spectra are sometimes detected to be close to each other. In other words, the spectra of cobalt and nickel may overlap with each other. The spectrum of fluorine can be confirmed in the energy spectra of the positive electrode active material 5-6B in FIG. 38 to FIG. 43; thus, fluorine probably exists on the surface or the like of the positive electrode active material 5-6B. Meanwhile, the spectrum of nickel cannot be confirmed in the energy spectra shown in FIG. 38 to FIG. 43.

On the basis of the spectra shown in FIG. 38 to FIG. 43, waveform separation or the like was performed with the accompanying software to derive the atomic ratio of each element. The following table shows the atomic ratio of each element.

TABLE 5

| | Element | | | | | | | | |
|---|---|---|---|---|---|---|---|---|---|
| | C | O | F | Mg | Al | Co | Zr | Cu | Total |
| Spectrum 1 | 10.1 | 70.9 | 0 | 0.3 | 0.5 | 18.2 | 0 | 0 | 100 |
| Spectrum 2 | 27.5 | 7.0 | 0 | 0 | 3.2 | 62.1 | 0.2 | 0 | 100 |
| Spectrum 3 | 11.9 | 55.7 | 0 | 0.2 | 1.3 | 30.9 | 0 | 0 | 100 |
| Spectrum 4 | 22.4 | 14.2 | 0 | 0 | 2.9 | 60.2 | 0 | 0.2 | 100 |
| Spectrum 5 | 11.0 | 62.7 | 0 | 0.2 | 1.0 | 25.2 | 0 | 0 | 100 |
| Spectrum 6 | 11.9 | 55.7 | 0 | 0.2 | 1.3 | 30.9 | 0 | 0 | 100 |

[Unit at %]

The atomic ratio of each element can be read from the above table. Note that depending on the accuracy of the accompanying software, the waveform separation for the energy spectra might be unsuccessful and lead to incorrect detection of an energy spectrum in fitting. In that case, the atomic ratio is sometimes output as 0 at %; however, the presence of elements can be discussed in accordance with the energy spectra. For example, although fluorine is 0 at % in Table 5, the spectrum of fluorine can be confirmed in each of the energy spectra in FIG. 38 to FIG. 43 and thus fluorine can be considered to be present on the surface or the like of the positive electrode active material 5-6B.

The values of cobalt, fluorine, and magnesium are extracted and listed in following table to show the atomic ratio of the transition metal to the additive element, for example, on the surface or the like of the positive electrode active material 5-6B.

TABLE 6

Element

| | F | Mg | Co | Total |
|---|---|---|---|---|
| Spectrum 1 | 0 | 1.8 | 98.2 | 100 |
| Spectrum 2 | 0 | 0 | 100 | 100 |
| Spectrum 3 | 0 | 0.6 | 99.4 | 100 |
| Spectrum 4 | 0 | 0 | 100 | 100 |
| Spectrum 5 | 0 | 0.7 | 99.3 | 100 |
| Spectrum 6 | 0 | 0.6 | 99.4 | 100 |

[Unit at %]

The atomic ratio of each element can be read from the above table.

Next, mapping images obtained by a scanning electron microscope-energy dispersive X-ray spectroscopy (SEM-EDX) method are shown. FIG. 37B is an oxygen mapping image, FIG. 37C is a cobalt mapping image, FIG. 37D is a magnesium mapping image, and FIG. 37E is a fluorine mapping image. In the mapping images, the intensity of a target element is converted into luminance by scanning (operating) while a given region of 192 pixels×256 pixels, for example, is irradiated with X-rays. Such analysis is referred to as area analysis in some cases. The mapping images visualize the presence of the target element in the target region, and bright spots in FIG. 37B to FIG. 37E are considered to indicate the presence of each element. However, the mapping image alone cannot determine the presence of an element; therefore, the energy spectra shown in FIG. 38 to FIG. 43 are used to determine the presence of the element.

### <XRD Measurement>

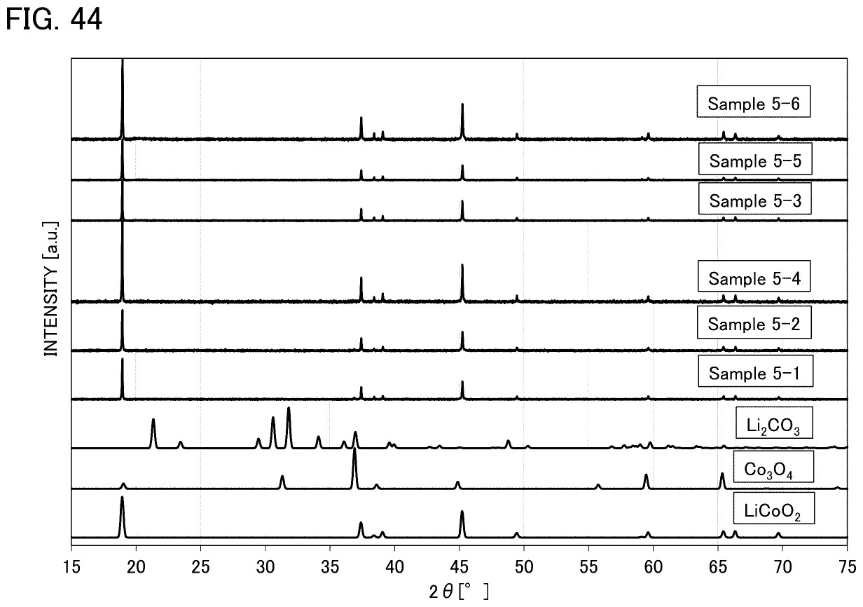

FIG. 44 shows the powder XRD measurement results of the positive electrode active materials corresponding to Sample 5-1 to Sample 5-6. The XRD measurement conditions were as follows.
XRD apparatus: D8 ADVANCE produced by Bruker AXS
X-ray source: CuKα source (K_{α1} is extracted by EVA)
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

The values of 2θ in the positive electrode active materials corresponding to Sample 5-1 to Sample 5-6 each overlap with that of lithium cobalt oxide (LCO), showing that lithium cobalt oxide was manufactured. In other words, an XRD spectrum or a diffraction pattern overlaps with that of lithium cobalt oxide (LCO); thus, the lithium cobalt oxide was found to be manufactured. Furthermore, the values of the above 2θ of the positive electrode active materials corresponding to Sample 5-3 to Sample 5-6 each overlap with that of neither lithium carbonate (Li₂CO₃) nor tricobalt tetraoxide (CO₃O₄), indicating that the positive electrode active materials with few reaction residues were obtained. Each of the positive electrode active materials corresponding to Sample 5-3 to Sample 5-6 substantially contains neither lithium carbonate (Li₂CO₃) nor tricobalt tetroxide (Co₃O₄). Note that peaks of tricobalt tetraoxide were slightly detected in Sample 5-1 and Sample 5-2.

### <Crystallite Size>

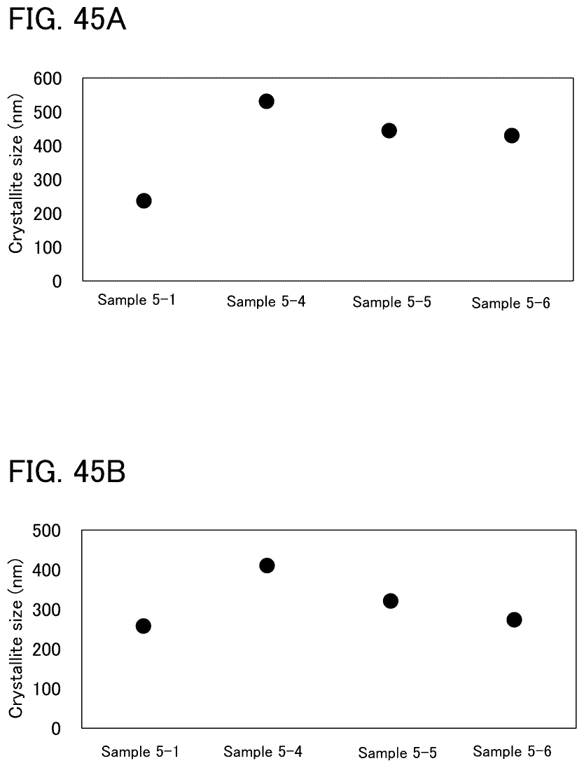

Next, how the crystallite size (also referred to as the size of a crystallite) is changed as Li/Co increases was examined. The crystallite sizes in Sample 5-1 and Sample 5-4, Sample 5-5, and Sample 5-6 each having high Li/Co were measured. The crystallite size refers to the length of a portion in the smallest unit that can be regarded as a single crystal. In this example, how the crystallite sizes in the above-described samples were changed before and after addition of the additive element source was further examined. With use of DIFFRAC.TOPAS ver. 3 as crystal structure analysis software, settings are as follows.
Emission Profile: CuKa5.lam
Background: Chebychev polynomial of degree 20
Instrument
   Primary radius: 250 mm
   Secondary radius: 250 mm
   Receiving slit width: 0.1 mm
   Divergence angle: 0.5
   Full Axial Convolution
   Filament Length: 12 mm
   Sample Length: 15 mm
   Receiving Slit Length: 12 mm
   Primary Sollers: 2.5
   Secondary Sollers: 2.5
Corrections
Specimen displacement: Refine
LP Factor: 0
FIG. 45A shows the results of the crystallite sizes of the composite oxides to which the additive element has not been added yet and which have already been subjected to heat treatment at 950° C. for 10 hours. FIG. 45B shows the results of the crystallite sizes of the positive electrode active materials to which the additive element has been added and which have already been subjected to heat treatment at 900° C. for 20 hours. FIG. 45A and FIG. 45B reveal that Sample 5-4 with a Li/Co ratio of 1.09 has the largest crystallite size. Sample 5-5 with a Li/Co ratio of 1.15 has the second largest crystallite size and Sample 5-6 with a Li/Co ratio of 1.2 has the third largest crystallite size.

FIG. 45A and FIG. 45B reveal that the crystal size increases as the Li/Co ratio increases. When the crystallite size is large, a single particle can be formed. In other words, it was found that the Li/Co ratio is preferably increased to obtain a single particle. It was also found that the crystallite size tends to slightly decrease after addition of the additive element.

Even with cracking in a particle, a large crystallite size as shown in FIG. 45A and FIG. 45B can keep the area of the crack small and inhibit an increase in resistance or an increase in specific surface area in the particle.

### <Particle Size Distribution>

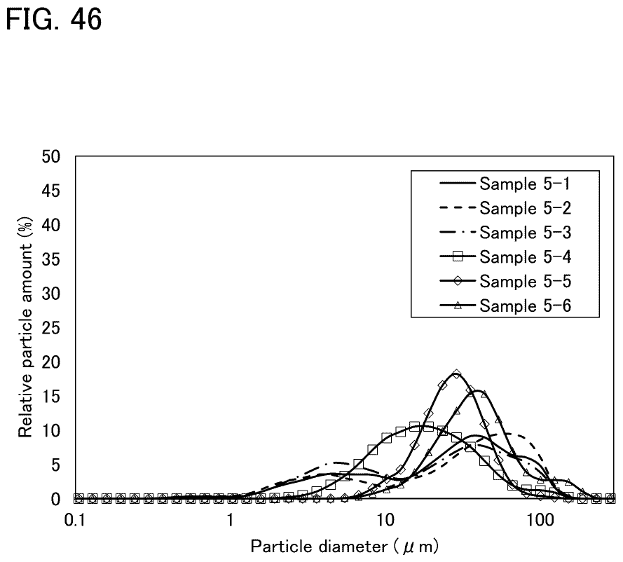

FIG. 46 shows measurement results of particle size distributions of the positive electrode active materials corresponding to Sample 5-1 to Sample 5-6. For the particle size distribution measurement, a laser diffraction distribution measurement apparatus (Shimadzu Corporation, SALD-2200) was used; first, approximately 0.4 g of a sample, a surface active agent, and distilled water with a volume greater than or equal to 1 mL and less than or equal to 2 mL are added to a beaker, and the mixture is sufficiently stirred by ultrasonic treatment. After that, this solution is injected into a stirring tank, and luminous intensity distribution is measured 64 times every two seconds, whereby particle size distribution data is analyzed. The smaller particle diameter and two peaks of the particle size distribution were confirmed for each of Sample 5-1, Sample 5-2, and Sample 5-3 with lower Li/Co ratios; meanwhile, the larger particle diameter and one peak of the particle size distribution were confirmed for each of Sample 5-4, Sample 5-5, and Sample 5-6 with higher Li/Co ratios. It was thus found that the distribution width is narrower as the Li/Co ratio is increased. To have a uniform particle diameter and a narrow distribution width, the positive electrode active material preferably has a Li/Co ratio as high as possible; for example, Sample 5-5 and Sample 5-6 are preferable.

The table below presents D50 and D90 of Sample 5-1 to Sample 5-6 corresponding to FIG. 46. The proportion (%) of D50/D90 is also shown. The table indicates that D50 and D90 tend to increase as the Li/Co ratio increases. The proportion (%) of D50/D90 is preferably higher than or equal to 35%, further preferably higher than or equal to 40%.

TABLE 7

| | D50 (μm) | D90 (μm) | D50/D90 (%) |
|---|---|---|---|
| Sample 5-1 | 25.1 | 72.8 | 34.5 |
| Sample 5-2 | 30.7 | 78.3 | 39.2 |
| Sample 5-3 | 20.7 | 69.9 | 29.6 |
| Sample 5-4 | 16.0 | 42.5 | 37.6 |
| Sample 5-5 | 24.6 | 43.1 | 57.1 |
| Sample 5-6 | 35.3 | 80.9 | 43.6 |

### <Fabrication of Positive Electrode>

Sample 5-1 to Sample 5-6 described above were prepared as positive electrode active materials, acetylene black (AB) was prepared as a conductive material, and poly(vinylidene fluoride) (PVDF) was prepared as a binding agent. The PVDF prepared was one dissolved in N-methyl-2-pyrrolidone (NMP) with a weight ratio of 5%. A slurry was formed by mixing the positive electrode active material, AB, and PVDF at 95:3:2 (weight ratio), and the slurry was applied to a positive electrode current collector of aluminum. As a solvent of the slurry, NMP was used. After the slurry was applied to the positive electrode current collector, the solvent was volatilized.

After that, pressing treatment was performed with a roller press machine to increase the density of the positive electrode active material layer over the positive electrode current collector. The pressing treatment was performed with a linear pressure of 210 kN/m. Note that the temperature of each of an upper roll and a lower roll of the roller press machine was 120° C. The carried amount of each of Sample 5-1 to Sample 5-6 was approximately 7 mg/cm².

Through the above process, the positive electrodes including Sample 5-1 to Sample 5-6 were obtained.

### <Fabrication of Test Battery>

Test batteries (CR2032 type coin-type cells, diameter: 20 mm, height: 3.2 mm) were fabricated using the above-described positive electrodes and using lithium metals for counter electrodes. A battery using a lithium metal for a counter electrode is referred to as a half cell.

As an electrolyte solution of the half cell, an organic electrolyte solution was prepared by dissolving lithium hexafluorophosphate (LiPF₆) at 1 mol/L in a mixed organic solvent containing EC (ethylene carbonate) and DEC (diethyl carbonate) at EC:DEC=30:70 (volume ratio). Note that VC was added as an additive at 2 wt % to the organic electrolyte solution.

As a separator of the half cell, a 25-μm-thick porous polypropylene film was used.

The above were held with a positive electrode can and a negative electrode can, whereby the half cells including Sample 5-1 to Sample 5-6 were fabricated. To clarify the correspondence with the positive electrode active materials, the fabricated half cells were referred to as Sample 5-1 to Sample 5-6. A positive electrode can and a negative electrode can that were formed of stainless steel (SUS) were used.

### <Charge and Discharge Cycle Test>

The half cells were subjected to the charge and discharge cycle tests in which measurement was performed with a charge-discharge measuring system (TOSCAT-3100) produced by TOYO SYSTEM Co., LTD. as a charge-discharge measuring instrument. The performance of the positive electrode itself can be clarified by the charge and discharge cycle tests using the half cells.

The above-described charge and discharge cycle test was performed on Sample 5-1 to Sample 5-6 at the ambient temperatures of 25° C. and 45° C. The ambient temperature refers to the temperature of a thermostatic oven where the half cells corresponding to Sample 5-1 to Sample 5-6 were placed, and “ambient” may be omitted hereinafter.

The half cells placed in the thermostatic oven were subjected to constant current charging under the charge condition of 0.5 C rate (1 C=200 mA/g (positive electrode active material weight) until the upper limit voltage reached 4.6 V, 4.65 V, or 4.7 V) and were subjected to constant voltage charging until the current value reached 0.05 C while the upper limit voltage was maintained. The charge and discharge cycle test conditions are sometimes referred to as CC/CV charging (each upper limit voltage, 0.5 C rate, 0.05 C cutoff). Constant current discharging was performed under the discharge condition of 0.5 C rate until the lower limit voltage reached 2.5 V. A break period was provided between charging and discharging, and the break period was 10 minutes in this example.

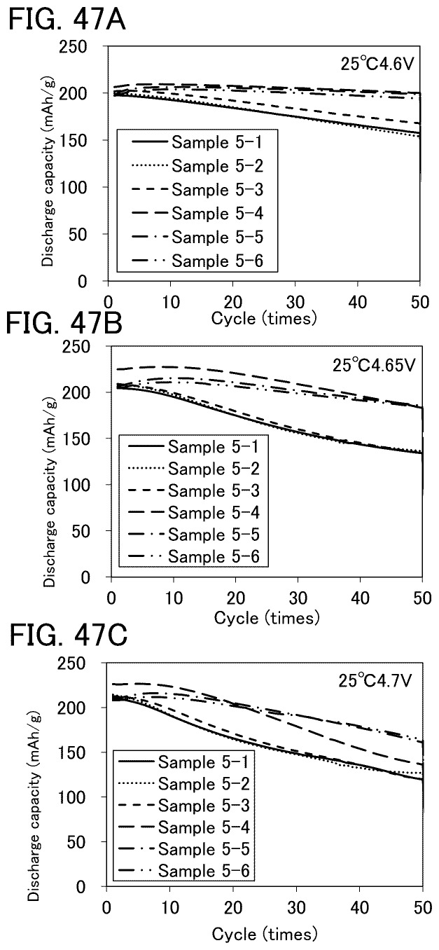

FIG. 47A shows a graph relating to changes in discharge capacity in accordance with the number of cycles in the case where the ambient temperature is 25° C. and the upper limit voltage is 4.6 V. FIG. 47B shows a graph relating to changes in discharge capacity in accordance with the number of cycles in the case where the ambient temperature is 25° C. and the upper limit voltage is 4.65 V. FIG. 47C shows a graph relating to changes in discharge capacity in accordance with the number of cycles in the case where the ambient temperature is 25° C. and the upper limit voltage is 4.7 V. Note that the discharge capacities of the half cells in this example were all calculated to be the value per weight of the positive electrode active material.

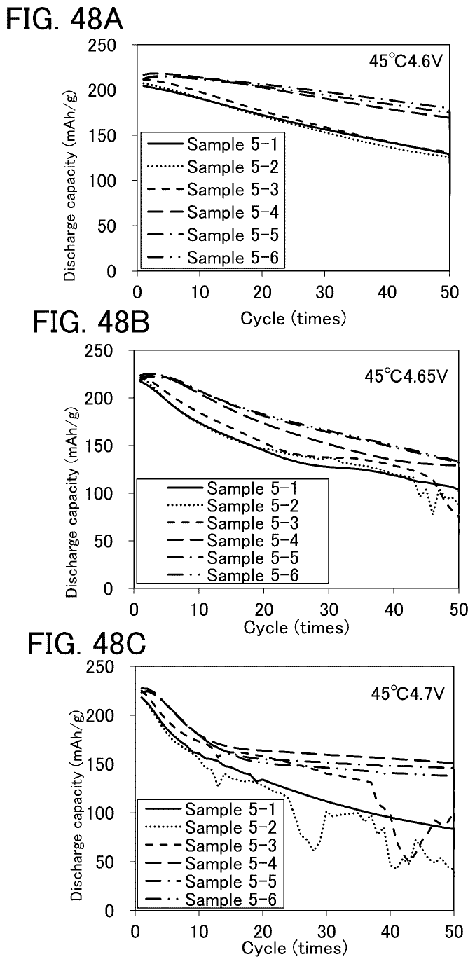

FIG. 48A shows a graph relating to changes in discharge capacity in accordance with the number of cycles in the case where the ambient temperature is 45° C. and the upper limit voltage is 4.6 V. FIG. 48B shows a graph relating to changes in discharge capacity in accordance with the number of cycles in the case where the ambient temperature is 45° C. and the upper limit voltage is 4.65 V. FIG. 48C shows a graph relating to changes in discharge capacity in accordance with the number of cycles in the case where the ambient temperature is 45° C. and the upper limit voltage is 4.7 V.

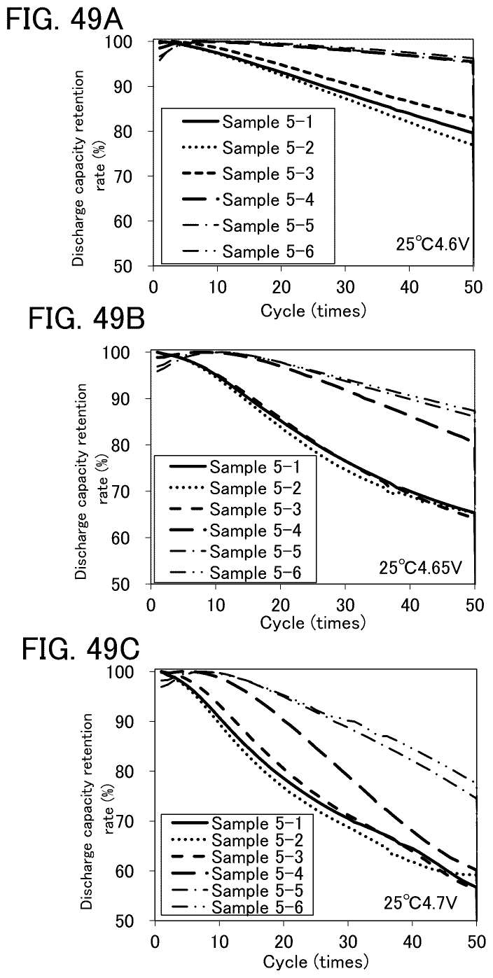

FIG. 49A shows a graph relating to discharge capacity retention rates in the case where the ambient temperature is 25° C. and the upper limit voltage is 4.6 V. FIG. 49B shows a graph relating to discharge capacity retention rates in the case where the ambient temperature is 25° C. and the upper limit voltage is 4.65 V. FIG. 49C shows a graph relating to discharge capacity retention rates in the case where the ambient temperature is 25° C. and the upper limit voltage is 4.7 V.

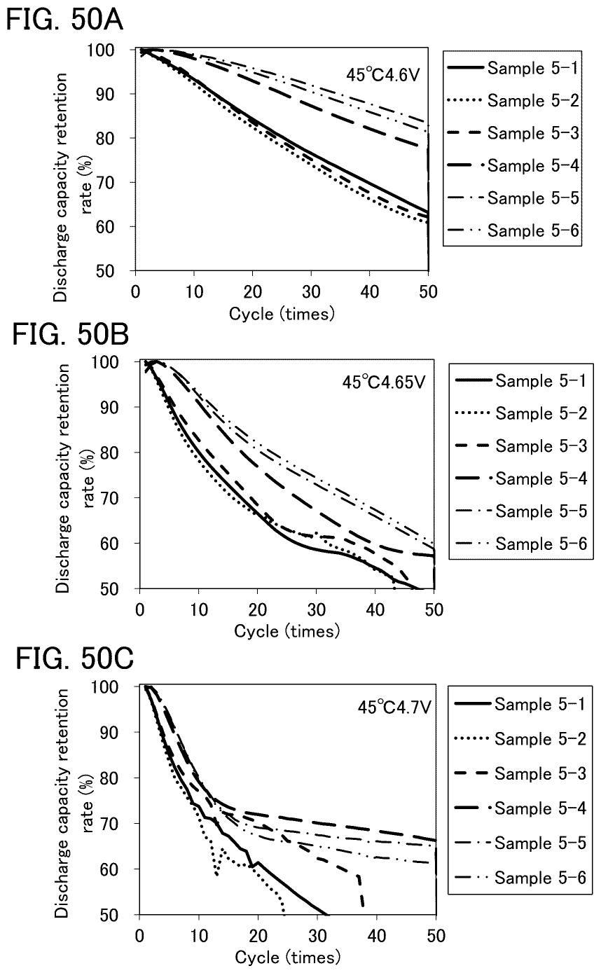

FIG. 50A shows a graph relating to discharge capacity retention rates in the case where the ambient temperature is 45° C. and the upper limit voltage is 4.6 V. FIG. 50B shows a graph relating to discharge capacity retention rates in the case where the ambient temperature is 45° C. and the upper limit voltage is 4.65 V. FIG. 50C shows a graph relating to discharge capacity retention rates in the case where the ambient temperature is 45° C. and the upper limit voltage is 4.7 V.

Sample 5-1 to Sample 5-6, each of which contains nickel in the inner portion of the positive electrode active material, have a high initial capacity. In the charge and discharge cycles at 25° C. and 45° C., Sample 5-4, Sample 5-5, and Sample 5-6 were found to have a higher discharge capacity than Sample 5-1, Sample 5-2, and Sample 5-3. At 25° C. and 45° C., Sample 5-4, Sample 5-5, and Sample 5-6 were found to have a higher discharge capacity retention rate than Sample 5-1, Sample 5-2, and Sample 5-3. It is found that as the Li/Co ratio increases, the discharge capacity and the discharge capacity retention rate in the charge and discharge cycles become higher.

### <Rate Performance>

In a 25° C. ambient temperature environment, the discharge capacity of each of Sample 5-1 to Sample 5-6 were measured while the rate at the time of charging was fixed to 0.5 C until the voltage reached 4.6 V, 4.65 V, or 4.7 V and the rate at the time of discharging was varied to 0.2 C, 0.5 C, 1 C, 2 C, 3 C, 4 C, 5 C, and 0.2 C in this order. This measurement is referred to as rate performance in some cases. Note that the discharge capacity at each rate was measured twice.

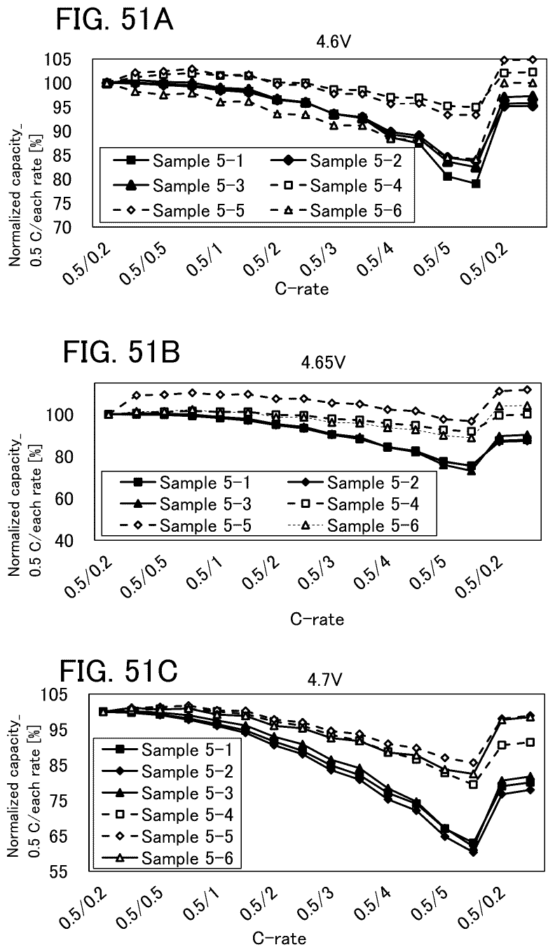

FIG. 51A is a graph showing rate performance at the upper limit voltage of 4.6 V normalized with the initial value at 0.5 C/0.2 C. FIG. 51B is a graph showing rate performance at the upper limit voltage of 4.65 V normalized with the initial value at 0.5 C/0.2 C. FIG. 51C is a graph showing rate performance at the upper limit voltage of 4.7 V normalized with the initial value at 0.5 C/0.2 C. Sample 5-1 to Sample 5-6 exhibited substantially the same discharge capacity as the initial one even when the rate at the time of discharging was increased; these samples were found to be excellent in rate performance at a high rate, for example, higher than or equal to 2 C and lower than or equal to 5 C. In particular, Sample 5-4 to Sample 5-6 were found to be more excellent in rate performance at a high rate than Sample 5-1 to Sample 5-3.

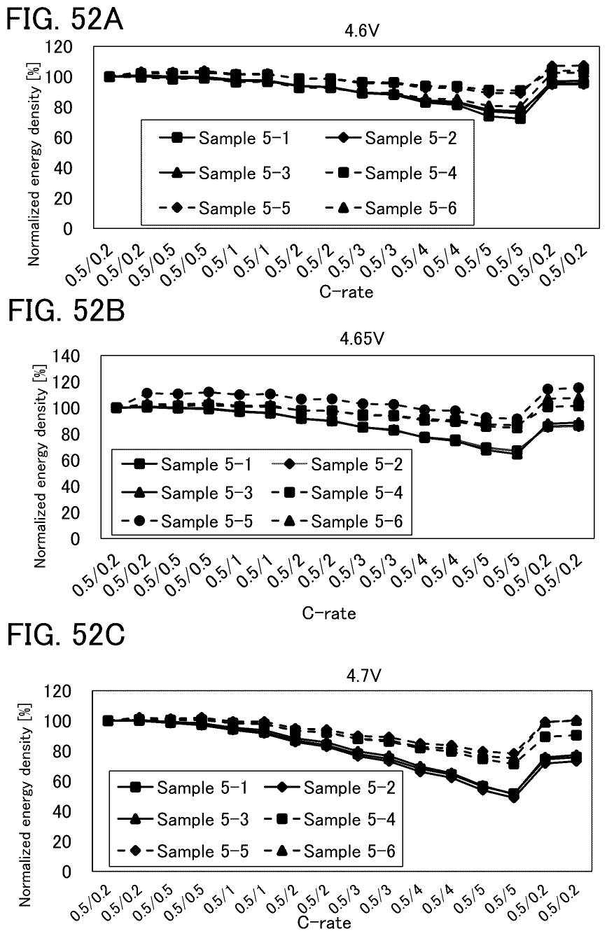

FIG. 52A is a graph showing rate performance at the upper limit voltage of 4.6 V normalized with the initial energy density at 0.5 C/0.2 C. FIG. 52B is a graph showing rate performance at the upper limit voltage of 4.65 V normalized with the initial energy density at 0.5 C/0.2 C. FIG. 52C is a graph showing rate performance at the upper limit voltage of 4.7 V normalized with the initial energy density at 0.5 C/0.2 C. Sample 1-1 to Sample 1-6 exhibited substantially the same discharge capacity as the initial one even when the rate at the time of discharging was increased; these samples were found to be excellent in rate performance at a high rate, for example, higher than or equal to 2 C and lower than or equal to 5 C. In particular, Sample 1-4 to Sample 1-6 were found to be more excellent in rate performance at a high rate than Sample 1-1 to Sample 1-3.

A precipitate was dried at 80° C. for 1 hour in a vacuum drying furnace in accordance with Step 33 shown in FIG. 7, whereby the hydroxide 95 was prepared to form another sample (Sample 6). In Sample 6, lithium hydroxide was prepared as the lithium source in FIG. 7, and the molar ratio of lithium hydroxide to the precursor was set to 1.00, 1.03, 1.06, and 1.09. These samples are referred to as Sample 6-1, Sample 6-2, Sample 6-3, and Sample 6-4. The conditions and the like that are not described were similar to those of Sample 5-1 and the like. The table below presents the Li/Co of the samples.

TABLE 8

| | Li/Co (molar ratio) |
|---|---|
| Sample 6-1 | 1.00 |
| Sample 6-2 | 1.03 |
| Sample 6-3 | 1.06 |
| Sample 6-4 | 1.09 |

### <SEM Image 3>

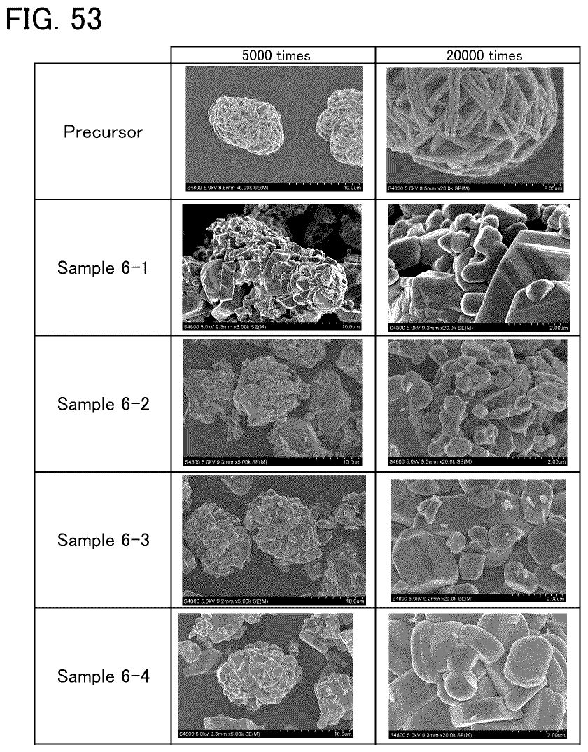

FIG. 53 shows plan SEM images of the precursors corresponding to Sample 6-1 to Sample 6-4 with different adjusted Li/Co as shown in the above table. FIG. 53 also shows plan SEM images of composite oxides corresponding to Sample 6-1 to Sample 6-4, to which the additive element source has not been added yet and which have already been subjected to heat treatment at 950° C. for 10 hours.

It was found that all of Sample 6-1 to Sample 6-4 had slightly larger particle diameters than the precursors. It appeared that, in Sample 6-1 to Sample 6-4, an increase in Li/Co ratio did not change the particle diameter.

### <SEM Image 4>

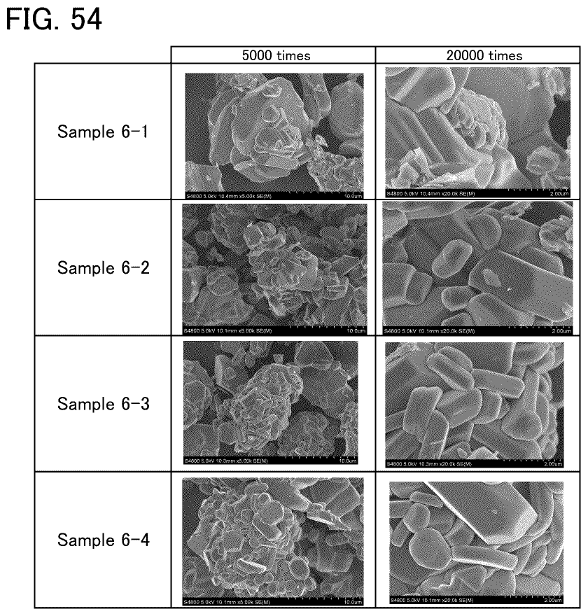

FIG. 54 shows plan SEM images of composite oxides corresponding to Sample 6-1 to Sample 6-4, which have already been subjected to heat treatment at 900° C. for 20 hours. It was confirmed that all of Sample 6-1 to Sample 6-4 had larger particle diameters than the precursors in FIG. 53. It was also confirmed that the particle surfaces of Sample 6-1 to Sample 6-4 were smoother than those in FIG. 53. The smooth surface may be caused by fluorine being contained in the additive element source. Alternatively, the smooth surface may be caused by the heat treatment.

### <XRD Measurement>

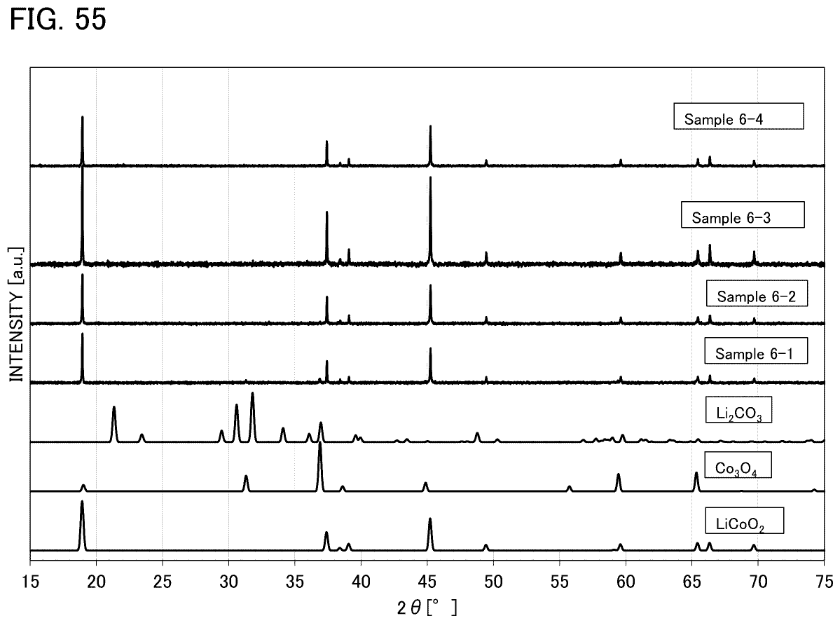

FIG. 55 shows the powder XRD measurement results of the positive electrode active materials corresponding to Sample 6-1 to Sample 6-4. The XRD measurement conditions were the same as those of Sample 1.

The values of 2θ in the positive electrode active materials corresponding to Sample 6-1 to Sample 6-6 each overlap with that of lithium cobalt oxide (LCO), showing that lithium cobalt oxide was manufactured. In other words, an XRD spectrum or a diffraction pattern overlaps with that of lithium cobalt oxide (LCO); thus, the lithium cobalt oxide was found to be manufactured. Furthermore, the values of the above 2θ of the positive electrode active materials corresponding to Sample 6-2 to Sample 6-4 each overlap with that of neither lithium carbonate (Li₂CO₃) nor tricobalt tetraoxide (Co₃O₄), indicating that the positive electrode active materials with few reaction residues were obtained. Note that a peak of tricobalt tetraoxide was slightly detected in Sample 6-1.

### <Crystallite Size>

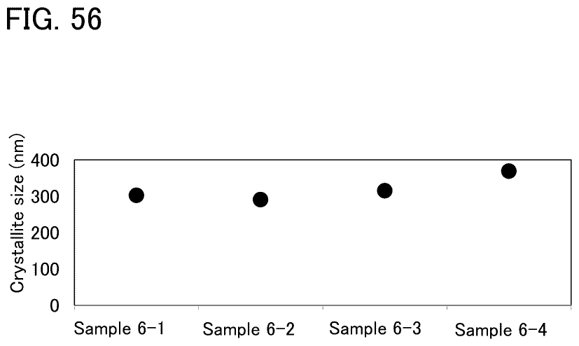

Next, how the crystallite size is changed as Li/Co increases was examined. The conditions of the crystal structure analysis software were the same as those for Sample 5-1. FIG. 56 shows the results of the crystallite sizes of the positive electrode active materials in Sample 6-1 to Sample 6-4 to which the additive element has been added and which have already been subjected to heat treatment at 900° C. for 20 hours. It appeared that, in Sample 6-1 to Sample 6-4, an increase in Li/Co ratio did not change the crystallite size.

### <Particle Size Distribution>

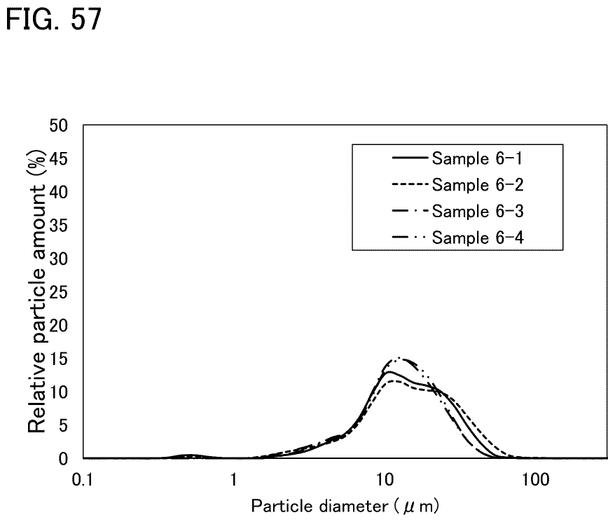

FIG. 57 shows measurement results of particle size distributions of the positive electrode active materials corresponding to Sample 6-1 to Sample 6-4. The conditions of the particle size distribution measurements were the same as those for Sample 5-1 and the like. It was confirmed that Sample 6-1 and Sample 6-2 with lower Li/Co ratios each have two peaks of the particle size distribution and Sample 6-3 and Sample 6-4 with higher Li/Co ratios each have one peak of the particle size distribution.

### <Fabrication of Positive Electrode>

Positive electrodes including Sample 6-1 to Sample 6-4 were fabricated under the same conditions as those for Sample 1.

### <Fabrication of Test Battery>

Test batteries (CR2032 type coin-type cells, diameter: 20 mm, height: 3.2 mm) including the positive electrodes including Sample 6-1 to Sample 6-4 were assembled under the same conditions as Sample 5-1 and the like. To clarify the correspondence with the positive electrode active material, the fabricated half cells are referred to as Sample 6-1 to Sample 6-4 without change.

### <Charge and Discharge Cycle Test>

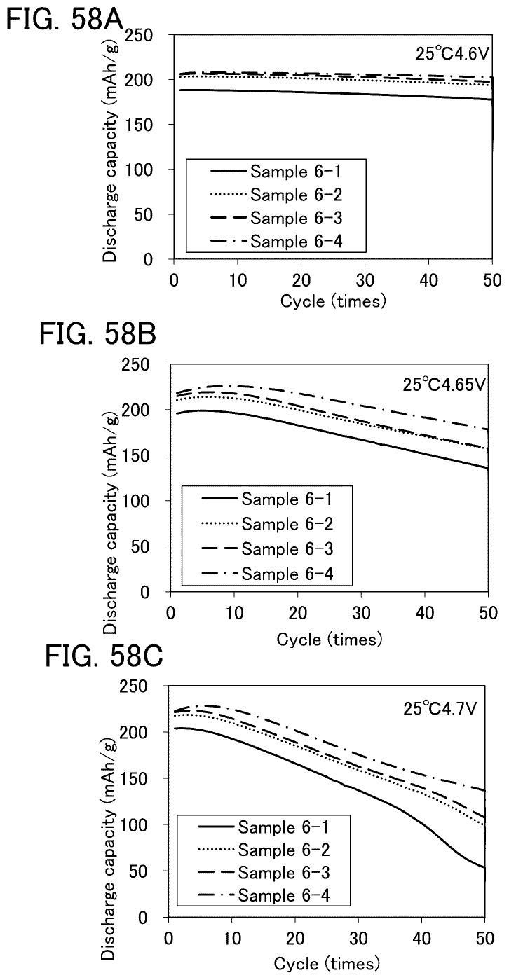

FIG. 58A shows a graph relating to changes in discharge capacity in accordance with the number of cycles in the case where the ambient temperature is 25° C. and the upper limit voltage is 4.6 V. FIG. 58B shows a graph relating to changes in discharge capacity in accordance with the number of cycles in the case where the ambient temperature is 25° C. and the upper limit voltage is 4.65 V. FIG. 58C shows a graph relating to changes in discharge capacity in accordance with the number of cycles in the case where the ambient temperature is 25° C. and the upper limit voltage is 4.7 V.

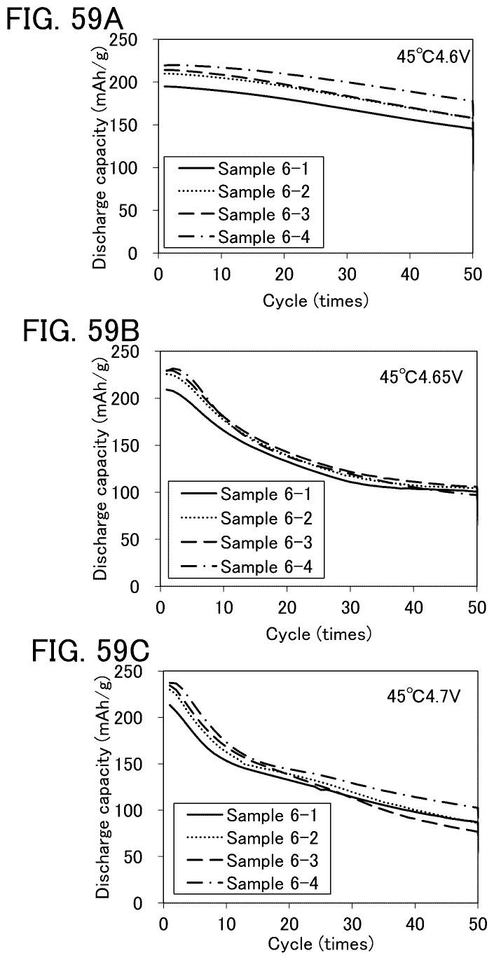

FIG. 59A shows a graph relating to changes in discharge capacity in accordance with the number of cycles in the case where the ambient temperature is 45° C. and the upper limit voltage is 4.6 V. FIG. 59B shows a graph relating to changes in discharge capacity in accordance with the number of cycles in the case where the ambient temperature is 45° C. and the upper limit voltage is 4.65 V. FIG. 59C shows a graph relating to changes in discharge capacity in accordance with the number of cycles in the case where the ambient temperature is 45° C. and the upper limit voltage is 4.7 V.

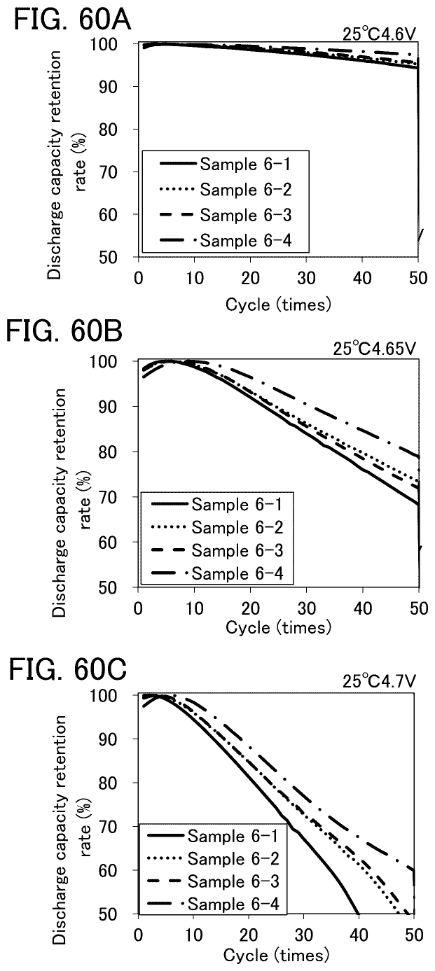

FIG. 60A shows a graph relating to discharge capacity retention rates in the case where the ambient temperature is 25° C. and the upper limit voltage is 4.6 V. FIG. 60B shows a graph relating to discharge capacity retention rates in the case where the ambient temperature is 25° C. and the upper limit voltage is 4.65 V. FIG. 60C shows a graph relating to discharge capacity retention rates in the case where the ambient temperature is 25° C. and the upper limit voltage is 4.7 V.

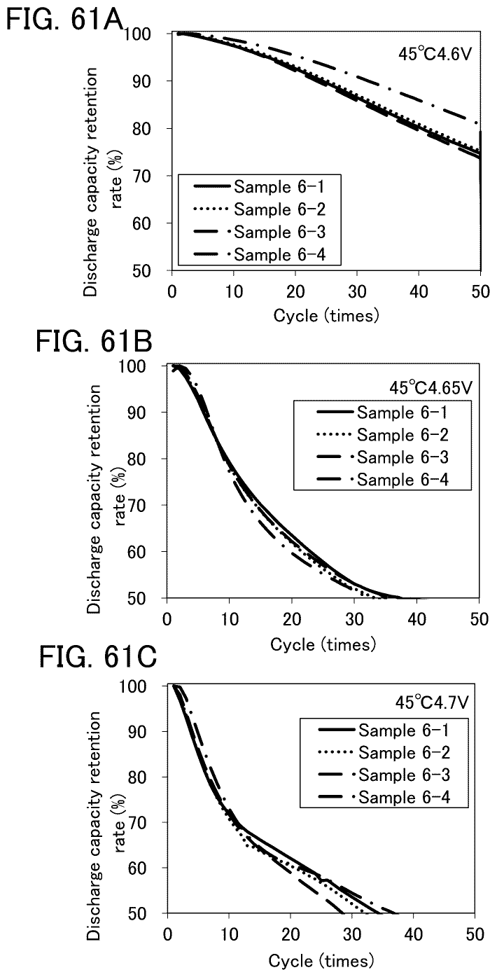

FIG. 61A shows a graph relating to discharge capacity retention rates in the case where the ambient temperature is 45° C. and the upper limit voltage is 4.6 V. FIG. 61B shows a graph relating to discharge capacity retention rates in the case where the ambient temperature is 45° C. and the upper limit voltage is 4.65 V. FIG. 61C shows a graph relating to discharge capacity retention rates in the case where the ambient temperature is 45° C. and the upper limit voltage is 4.7 V.

Sample 6-1 to Sample 6-4, each of which contains nickel in the inner portion of the positive electrode active material, have a high initial capacity. At 25° C. and 45° C., Sample 2-2 to Sample 6-4 were found to have a high discharge capacity and a high discharge capacity retention rate while Sample 6-1 has a low discharge capacity and a low discharge capacity retention rate.

### <Rate Performance>

In a 25° C. ambient temperature environment, the discharge capacity of each of Sample 6-1 to Sample 6-4 were measured while the rate at the time of charging was fixed to 0.5 C until the voltage reached 4.6 V, 4.65 V, or 4.7 V and the rate at the time of discharging was varied to 0.2 C, 0.5 C, 1 C, 2 C, 3 C, 4 C, 5 C, and 0.2 C in this order. This measurement is referred to as rate performance in some cases. Note that the discharge capacity at each rate was measured twice.

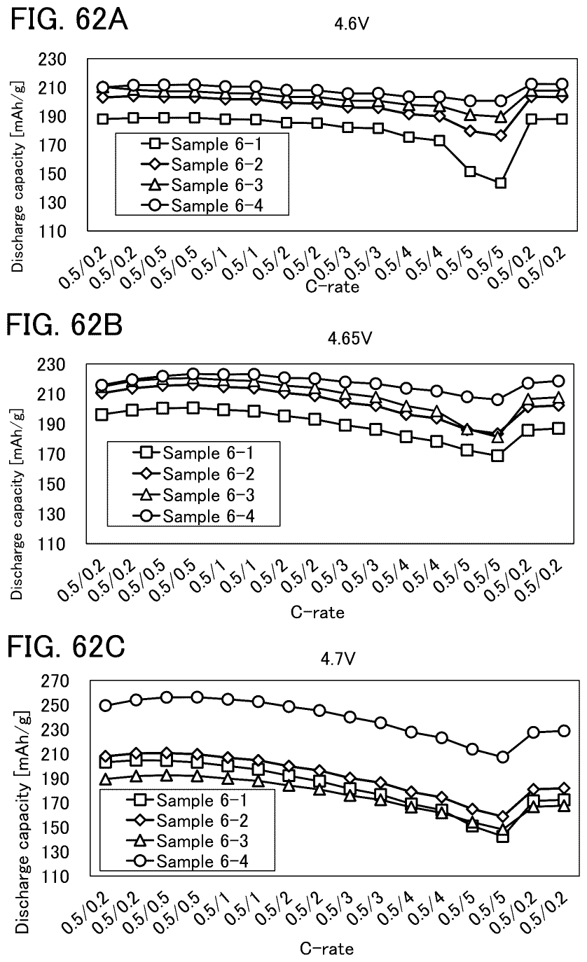

FIG. 62A is a graph showing rate performance at the upper limit voltage of 4.6 V normalized with the initial value at 0.5 C/0.2 C. FIG. 62B is a graph showing rate performance at the upper limit voltage of 4.65 V normalized with the initial value at 0.5 C/0.2 C. FIG. 62C is a graph showing rate performance at the upper limit voltage of 4.7 V normalized with the initial value at 0.5 C/0.2 C. Sample 6-4 was found to have excellent high rate performance.

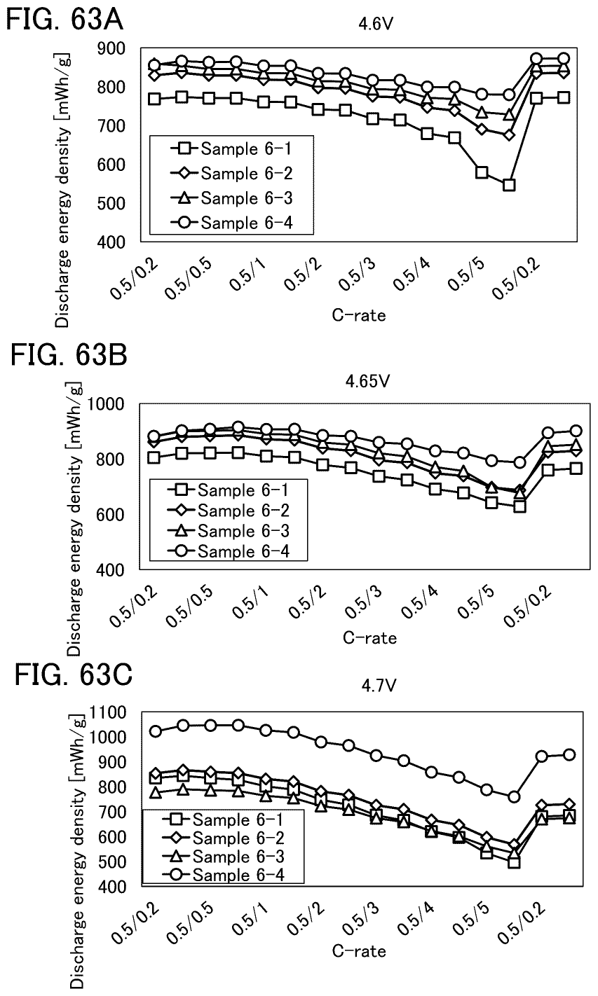

FIG. 63A is a graph showing rate performance at the upper limit voltage of 4.6 V normalized with the initial energy density at 0.5 C/0.2 C. FIG. 63B is a graph showing rate performance at the upper limit voltage of 4.65 V normalized with the initial energy density at 0.5 C/0.2 C. FIG. 63C is a graph showing rate performance at the upper limit voltage of 4.7 V normalized with the initial energy density at 0.5 C/0.2 C. Sample 6-4 was found to have excellent high rate performance.

### <XRD Measurement at the Time of Charging>

Next, XRD measurement of the half cell using Sample 5-4 when it was charged at the upper limit voltage of 4.6 V was performed. The XRD measurement conditions were the same as those of Sample 1. Note that pressure was not applied during the fabrication of the positive electrode including Sample 5-4 in accordance with the above-described method for fabricating a positive electrode. The half cell was fabricated in accordance with the above-described method for fabricating a test battery.

The half cell was subjected to aging treatment. As the charge conditions in the aging treatment, constant current charging was performed at a 0.2 C rate until the upper limit voltage reached 4.5 V and constant voltage charging until the current amount reached 0.02 C. That is, CC/CV charging was performed. As the discharge conditions, constant current discharging was performed at a 0.2 C rate until the lower limit voltage reached 3.0 V. One cycle of the above charging and discharging was performed. After that, CC charging was performed at a 0.2 C rate and an upper limit voltage of 4.6 V, and CV charging was performed until 0.02 C. The charge capacity in this state is approximately 211.2 mAh/g and x in LiₓMO₂ is approximately 0.23, corresponding to the case where x in LiₓMO₂ is small.

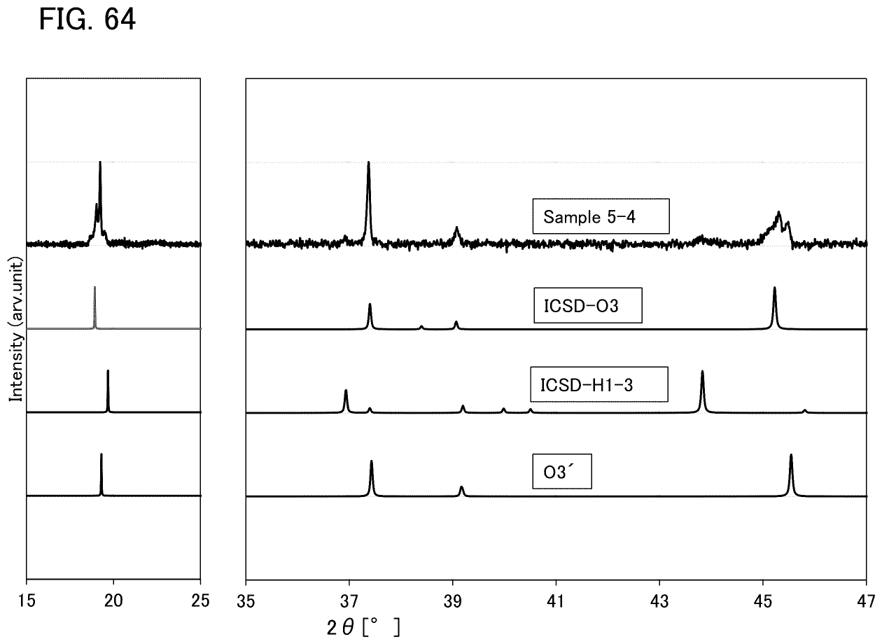

After the charging was completed, the positive electrode was immediately taken out and the XRD measurement was started. The XRD measurement temperature was 25° C. FIG. 64 shows results of the XRD measurement of the positive electrode including Sample 5-4 at the time of charging. FIG. 64 also shows XRD patterns corresponding to the O3 type crystal structure and the H1-3 type crystal structure of LCO, which were obtained from the Inorganic Crystal Structure Database (ICSD). FIG. 64 additionally shows an XRD pattern of the O3′ type crystal structure calculated and output with VESTA.

Sample 5-4 exhibits diffraction peaks overlapping with the XRD pattern corresponding to O3′ of ICSD. Specifically, a diffraction peak of Sample 5-4 appears at 2θ of 19.24°. Another diffraction peak of Sample 5-4 appears at 2θ of 45.34°. There is also a diffraction peak of Sample 5-4 slightly overlapping with the XRD pattern corresponding to H1-3 of ICSD. It can be said that Sample 5-4 having the O3′ structure at the time of charging has a stable crystal structure even in a high-voltage charged state.

### REFERENCE NUMERALS

81: cobalt source, 82: nickel source, 83: chelate agent, 84: alkaline aqueous solution, 85: chelate agent, 86: water, 88: lithium source, 89: additive element source, 91: mixed solution, 92: precipitate, 95: hydroxide, 96: mixture, 98: oxide, 99: mixture, 100: positive electrode active material, 100a: surface portion, 100c: inner portion, 101: grain boundary, 104: coating film

1. A method for manufacturing a positive electrode active material, comprising the steps of:
forming a mixed solution in which a cobalt compound and a nickel compound are dissolved;
making the mixed solution react with an alkaline aqueous solution to obtain a suspension in which a cobalt nickel hydroxide is precipitated;
performing first suction filtration of the suspension with use of water; and
after the first suction filtration, performing second suction filtration with use of an organic solvent,
wherein in the cobalt nickel hydroxide, an atomic ratio of nickel in a sum of an atomic ratio of cobalt and the atomic ratio of nickel is greater than 0 and less than or equal to 0.01.

2. A method for manufacturing a positive electrode active material, comprising the steps of:
forming a mixed solution in which a cobalt compound and a nickel compound are dissolved;
making the mixed solution react with an alkaline aqueous solution to obtain a suspension in which a cobalt nickel hydroxide is precipitated;
performing first suction filtration of the suspension with use of water;
after the first suction filtration, performing second suction filtration with use of an organic solvent to collect the cobalt nickel hydroxide;
after mixing the cobalt nickel hydroxide and a lithium compound, performing first heat treatment to form a first composite oxide; and
after mixing the first composite oxide and a compound comprising an additive element, performing second heat treatment,
wherein in the cobalt nickel hydroxide, an atomic ratio of nickel in a sum of an atomic ratio of cobalt and the atomic ratio of nickel is greater than 0 and less than or equal to 0.01, and
wherein in the first composite oxide, an atomic ratio of lithium to the atomic ratio of cobalt is greater than or equal to 1.0 and less than or equal to 1.2.

3. The method for manufacturing a positive electrode active material, according to claim 2,
wherein the additive element is one or two or more selected from magnesium, fluorine, calcium, aluminum, silicon, vanadium, copper, and gallium.

4. The method for manufacturing a positive electrode active material, according to claim 2,
wherein a temperature of the second heat treatment is lower than a temperature of the first heat treatment.

5. The method for manufacturing a positive electrode active material, according to claim 1, comprising:
subjecting the cobalt nickel hydroxide to a drying step for longer than or equal to 0.5 hours and shorter than or equal to 20 hours.

6. The method for manufacturing a positive electrode active material, according to claim 1, comprising:
subjecting the cobalt nickel hydroxide to a drying step for longer than or equal to 12 hours and shorter than or equal to 20 hours.

7. A positive electrode active material,
wherein an atomic ratio of nickel in a sum of an atomic ratio of cobalt and the atomic ratio of nickel is greater than 0 and less than or equal to 0.01 and an atomic ratio of lithium to the atomic ratio of cobalt is greater than or equal to 1.0 and less than or equal to 1.2, and
wherein a mapping image of the positive electrode active material by a surface SEM-EDX method comprises a region where nickel is not confirmed.

8. The positive electrode active material according to claim 7,
wherein the positive electrode active material comprises a crystallite and a size of the crystallite is greater than or equal to 200 nm and less than or equal to 600 nm.

9. The positive electrode active material according to claim 7,
wherein the atomic ratio of lithium to the atomic ratio of cobalt is greater than or equal to 1.06 and less than or equal to 1.2
